(19) United States
(12) Patent Application Publication
(10) Pub. No.: US 2013/0321723 A1
(43) Pub. Date: Dec. 5, 2013

(54) BARRIER ELEMENT AND 3D DISPLAY APPARATUS

(71) Applicant: FUJIFILM Corporation, Tokyo (JP)

(72) Inventors: Makoto ISHIGURO, Kanagawa (JP); Hiroshi SATO, Kanagawa (JP); Megumi SEKIGUCHI, Kanagawa (JP)

(73) Assignee: FUJIFILM Corporation, Tokyo (JP)

(21) Appl. No.: 13/965,768

(22) Filed: Aug. 13, 2013

Related U.S. Application Data
(63) Continuation of application No. PCT/JP2012/053520, filed on Feb. 15, 2012.

(30) Foreign Application Priority Data
Feb. 15, 2011 (JP) 2011-030227
Mar. 18, 2011 (JP) 2011-060920

(51) Int. Cl. G02F 1/13

(52) U.S. Cl. CPC G02F 1/1313
USPC 349/15

(57) ABSTRACT

Provided are a barrier element and a 3D display apparatus including the element that allows 2D display with high brightness without a change in tint of white portions and allows 3D display with reduced crosstalk. A barrier element to be disposed at the front or the rear of an image display device and capable of forming a barrier pattern including light transmitting portions and light shielding portions, the barrier element including a first polarization controlling element; a liquid crystal cell; and at least one retardation film disposed between the first polarization controlling element and one face of the liquid crystal cell and/or disposed in the other face of the liquid crystal cell and having a retardation in-plane Re(550) of −30 to 100 nm at a wavelength of 550 nm and a retardation in the thickness direction Rth(550) of −15 to 180 nm at a wavelength of 550 nm.

The present application is a continuation of PCT/JP2012/053520 filed on Feb. 15, 2012 and claims priority under 35 U.S.C. §119 of Japanese Patent Application No. 030227/2011, filed on Feb. 15, 2011 and Japanese Patent Application No. 060920/2011, filed on Mar. 18, 2011, the content of which is herein incorporated by reference in their entirety.

### TECHNICAL FIELD

The present invention relates to a barrier element and a 3D display apparatus.

### BACKGROUND ART

Various systems for three-dimensional (3D) display schemes have been proposed. Systems without glasses have been proposed as one for such schemes.

A parallax barrier system is one of the systems without glasses. In this system, a barrier layer having black-and-white stripes corresponding to the position and parallax of a viewer is laminated at the viewing side of a display apparatus for allowing the left eye and the right eye of the viewer to recognize different images and thereby achieve 3D display (e.g., Patent Literature 1).

The 3D display apparatus of this system has an advantage of allowing a viewer to see 3D display with his/her naked eyes. In viewing a 2D display mode by this system, however, the laminated black-and-white stripes reduce the brightness, and it has been desired to solve this problem. In order to solve this problem, a barrier element having a liquid crystal cell was proposed, where a barrier stripe image is displayed through the liquid crystal cells in a 3D display mode whereas no stripe image is displayed in a 2D display mode for achieving a high transmittance (e.g., Patent Literatures 2 and 3).

### CITATION LIST

### Patent Literature

[Patent Literature 1] Japanese Patent Laid-Open No. 2003-295115
[Patent Literature 2] Japanese Patent Laid-Open No. Hei 05-122733
[Patent Literature 3] Japanese Patent Laid-Open No. 2005-91834

### SUMMARY OF INVENTION

### Technical Problem

As described above, a decrease in brightness in a 2D display mode can be solved by incorporating a liquid crystal cell in the barrier element, but achievement of a high-quality 3D display (e.g., with no crosstalk) in the front and oblique directions needs optical compensation of the liquid crystal cell in the barrier element. The results of investigation by the present inventors, however, demonstrate that a retardation film disposed in the barrier element for optical compensation of the liquid crystal cell causes a change in tint of white portions in a 2D display mode.

It is an object of the present invention to solve these problems, specifically, to improve 3D display characteristics without a decrease in brightness and a change in tint of white portions in a 2D display mode.

That is, it is an object of the present invention to provide a barrier element and a 3D display apparatus comprising the element that allows 2D display with high brightness without a change in tint of white portions and allows 3D display with reduced crosstalk.

### Solution to Problem

The present inventors, who have diligently studied to solve the above-mentioned problems, has found that the change in tint of white portions in a 2D display mode can be prevented and the crosstalk in a 3D display mode can be reduced by disposing a retardation film having an Re and an Rth within predetermined ranges in a barrier element having liquid crystal cells. The inventors have continued further investigation based on the findings and has accomplished the present invention. In conventional liquid crystal cells for 2D display, retardation films are disposed mainly for improving the display characteristics in display of black portions. In order to achieve the purpose, optimization of Re and Rth has been investigated. In the present invention, the retardation film is disposed for achieving both a reduction in the change in tint of white portions in a 2D display mode and a reduction in crosstalk in a 3D display mode, and the advantageous effects achieved by disposing the retardation film are absolutely different from those in conventional liquid crystal display apparatuses for 2D display.

The solutions to the problems described above are as follows:

[1] A barrier element to be disposed at the front or the rear of an image display device and capable of forming a barrier pattern including light transmitting portions and light shielding portions, the barrier element comprising:

a first polarization controlling element;

a liquid crystal cell; and at least one retardation film disposed between the first polarization controlling element and one face of the liquid crystal cell and/or disposed in the other face of the liquid crystal cell, and the retardation film having a retardation in-plane Re(550) of −30 to 100 nm at a wavelength of 550 nm and a retardation in the thickness direction Rth(550) of −15 to 180 nm at a wavelength of 550 nm.

[2] The barrier element according to [1], wherein the retardation film has a retardation in the thickness direction Rth(550) of 30 to 180 nm at a wavelength of 550 nm.
[3] The barrier element according to [1], further comprising an optically anisotropic layer in the retardation film, wherein

the retardation film has a retardation in the thickness direction Rth(550) of −15 to 30 nm at a wavelength of 550 nm; and

the optically anisotropic layer composed of a composition containing a liquid crystalline compound and has a retardation in-plane Re(550) of 20 nm or more.

[4] The barrier element according to any one of [1] to [3], wherein

the first polarization controlling element is an absorptive polarizer, and

the absorption axis of the absorptive polarizer is orthogonal or parallel to the in-plane slow axis of the retardation film.

[5] The barrier element according to [4], wherein

the absorptive polarizer has the absorption axis in the direction of 0° or 90° when the horizontal direction of the display face is defined as 0°.

[6] The barrier element according to any one of [1] to [5], wherein the first polarization controlling element is a reflective polarizer or an anisotropic scattering polarizer.
[7] The barrier element according to any one of [1] to [6], further comprising a second polarization controlling element disposed such that the liquid crystal cell is disposed between the first and the second polarization controlling elements, wherein

the combination of the first and second polarization controlling elements is a combination of two absorptive polarizers, a combination of one absorptive polarizer and one reflective polarizer, or a combination of two anisotropic scattering polarizers.

[8] The barrier element according to any one of [1] to [7], wherein

the retardation films each are disposed between the polarization controlling element and one face of the liquid crystal cell and disposed in the other face of the liquid crystal cell.

[9] The barrier element according to [7] or [8], wherein the slow axes of the retardation films are orthogonal to each other.
[10] The barrier element according to any one of [1], [2], and [4] to [9], further comprising an optically anisotropic layer composed of a composition containing a liquid crystalline compound in the retardation film.
[11] The barrier element according to any one of [1] to [10], wherein the optically anisotropic layer disposed in the retardation film has a major axis tilting in the thickness direction.
[12] The barrier element according to any one of [3] to [11], wherein the optically anisotropic layer satisfies a relationship: 3≦R[+40°]/R[−40°] at a wavelength of 550 nm, wherein in the plane (incident plane) containing a normal line orthogonal to the slow axis of the retardation film, R[+40°] represents the retardation measured from a direction tilted by 40° from the normal line to the film plane direction, and R[−40°] represents the retardation measured from a direction tilted by 40° from the normal line to the reverse direction (where R[−40°]<R[+40°]).
[13] The barrier element according to any one of [3] to [12], wherein the optically anisotropic layer has an Re(550) satisfying a relationship: 20 Re(550)<58 nm at a wavelength of 550 nm.
[14] The barrier element according to any one of [3] to [13], wherein the liquid crystalline compound is a discotic liquid crystalline compound.
[15] The barrier element according to any one of [1] to [14], wherein the retardation film is a cellulose acylate film.
[16] The barrier element according to any one of [1] to [15], wherein the retardation film is an optically biaxial polymer film.
[17] The barrier element according to any one of [1] to [16], wherein the liquid crystal cell is in a TN mode.
[18] A 3D display apparatus comprising a barrier element according to any one of [1] to [17] and an image display device.
[19] The 3D display apparatus according to [18], wherein the image display device at least comprises a pair of a third and fourth polarization controlling elements and a liquid crystal cell disposed therebetween.
[20] The 3D display apparatus according to [19], wherein the first polarization controlling element of the barrier element has a higher transmittance than those of the third and fourth polarization controlling elements of the image display device.
[21] The 3D display apparatus according to any one of [18] to [20], wherein the first polarization controlling element of the barrier element is an absorptive polarizer, and the barrier element is disposed at the front of the image display device such that the first polarization controlling element is disposed at the front side.
[22] The 3D display apparatus according to any one of [18] to [21], wherein the first polarization controlling element of the barrier element is an absorptive polarizer, a reflective polarizer, or an anisotropic scattering polarizer, and the barrier element is disposed at the rear of an image display device such that the first polarization controlling element is disposed in the back side.
[23] The 3D display apparatus according to any one of [18] to [22], wherein the liquid crystal cell included in the image display device is of a VA mode or an IPS mode.

### Advantageous Effects of Invention

The present invention can improve 3D display characteristics without causing a reduction in brightness and a change in tint of white portions in a 2D display mode.

That is, the present invention provides a barrier element and a 3D display apparatus comprising the element that allows 2D display with high brightness without a change in tint of white portions and allows 3D display with reduced crosstalk.

### BRIEF DESCRIPTION OF DRAWINGS

FIG. 1 includes schematic cross-sectional views illustrating examples of the 3D display apparatus of the present invention.

FIG. 2 includes schematic views for illustrating an E mode and an O mode.

FIG. 3 is a schematic cross-sectional view illustrating an example of the 3D display apparatus of the present invention.

FIG. 4 is a schematic cross-sectional view illustrating an example of the 3D display apparatus of the present invention.

FIG. 5 is a schematic cross-sectional view illustrating an example of the 3D display apparatus of the present invention.

FIG. 6 is a schematic cross-sectional view illustrating an example of the 3D display apparatus of the present invention.

FIG. 7 includes schematic cross-sectional views illustrating examples of the 3D display apparatus of the present invention.

FIG. 8 includes schematic cross-sectional views illustrating examples of the 3D display apparatus of the present invention.

### DESCRIPTION OF EMBODIMENTS

The invention is described in detail hereinunder. Note that, in this patent specification, any numerical expressions in a style of “ . . . to . . . ” will be used to indicate a range including the lower and upper limits represented by the numerals given before and after “to”, respectively.

In this description, Re(λ) and Rth(λ) are retardation (nm) in plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments). The selection of the measurement wavelength may be conducted according to the manual-exchange of the wavelength-selective-filter or according to the exchange of the measurement value by the program.

When a film to be analyzed is expressed by a monoaxial or biaxial index ellipsoid, Rth(λ) of the film is calculated as follows.

Rth(λ) is calculated by KOBRA 21ADH or WR on the basis of the six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane), a value of hypothetical mean refractive index, and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to formulae (A) and (B):

$$Re ( θ ) = [ nx - \frac{ny \times nz}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}} \qquad ( A )$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

Rth={(nx+ny)/2−nz}×d (B):

In the formula, nx represents a refractive index in the in-plane slow avis direction; ny represents a refractive index in the in-plane direction perpendicular to nx; and nz represents a refractive index in the direction perpendicular to nx and ny. And “d” is a thickness of the film.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59). KOBRA 21ADH or WR calculates nx, ny and nz, upon enter of the hypothetical values of these mean refractive indices and the film thickness. On the basis of thus-calculated nx, ny and nz, Nz=(nx−nz)/(nx−ny) is further calculated.

Throughout the specification, the terms “parallel” and “orthogonal” each refer to a range within ±10° from the angle in the strict definition. This range is preferably within ±5°, more preferably within ±2°, from the angle in the strict definition. The term “slow axis” refers to a direction in which the refractive index is the highest.

The refractive index is a value measured in a visible light region, i.e., at a wavelength λ of 550 nm, unless otherwise specified. The Re and Rth are measured at a wavelength of 550 nm, unless otherwise specified.

Throughout the specification, the term “polarizing film” and the term “polarizing plate” are distinguished from each other, i.e., the term “polarizing plate” is used for a laminate comprising a “polarizing film” and a transparent protective film disposed in at least one face of the polarizing film for protecting it.

### (Barrier Element)

The present invention relates to a barrier element capable of forming a barrier pattern composed of light transmitting portions and light shielding portions. The barrier element comprises a first polarization controlling element, a liquid crystal cell, and at least one retardation film disposed between the first polarization controlling element and the liquid crystal cell and/or disposed in the other face of the liquid crystal cell. The retardation film has a retardation in-plane Re(550) of −30 to 100 nm at a wavelength of 550 nm and a retardation in the thickness direction Rth(550) of −15 to 180 nm at a wavelength of 550 nm. The barrier element of the present invention is disposed at the front or the rear of an image display device and is configured to be capable of switching between 2D display and 3D display modes. In a 3D display mode, the barrier element displays a barrier pattern composed of light transmitting portions and light shielding portions, e.g., a barrier stripe image. In a 3D display mode, the image display device displays an image for the right eye and an image for the left eye; the image for the right eye enters only the right eye of a viewer and the image for the left eye enters only the left eye of the viewer due to the barrier stripe image of the barrier element; hence, the viewer recognizes the images as a stereo image. In a 2D display mode, the barrier pattern of the barrier element disappears to avoid a decrease in brightness of the image displayed by the image display device, resulting in 2D display with high brightness.

In order to enable 3D display without crosstalk by the barrier pattern displayed by a barrier element not only for a viewer viewing from the front direction (the normal direction of the display face) but also for a viewer viewing from a horizontally oblique direction, it is necessary to compensate the birefringence occurring in oblique directions of the liquid crystal cell of the barrier element. However, the retardation film disposed in the barrier element for optical compensation affects the display characteristics in a 2D display mode, in particular, causes a change in tint of white portions in the display. In the present invention, the liquid crystal cell included in the barrier element is optically compensated with a retardation film having an Re(550) of −30 to 100 nm and an Rth(550) of −15 to 180 nm or with a laminate composed of a retardation film having an Rth(550) of −15 to 30 nm and an optically anisotropic layer formed, in the retardation film, of a composition containing a liquid crystalline compound having an Re(550) of 20 nm or more. As a result, an improvement in the quality of 3D display, specifically, 3D display not causing crosstalk even in oblique directions, is achieved without reducing the quality of 2D display, specifically, without a change in tint of white portions in the display.

The barrier element of the present invention comprises a first polarization controlling element. In order to form a barrier pattern image with a liquid crystal cell, in general, a structure is employed in which the liquid crystal cell is disposed between a pair of polarization controlling elements. When the image display device that is used in combination with the barrier element of the present invention is a liquid crystal panel or the like and comprises a polarization controlling element as a component, the barrier element of the present invention may include only the first polarization controlling element, while the other polarization controlling element used in combination may be the polarization controlling element, which is a component of the image display device.

An example of the first polarization controlling element included in the barrier element of the present invention is an absorptive polarizer, and a common linearly polarizing film can be used. In an embodiment in which the barrier element of the present invention is disposed at the front of an image display device such that the first polarization controlling element is disposed at the front side, the first polarization controlling element is preferably a linearly polarizing film. In an embodiment in which the barrier element of the present invention is disposed at the rear side of an image display device and the first polarization controlling element is disposed at the side of the backlight, the first polarization controlling element may be any one of an absorptive polarizer, a reflective polarizer, and an anisotropic scattering polarizer. In particular, the enhanced reflective polarizer described in National Publication of International Patent Application No. Hei 9-506985 is preferred. The reflective polarizer and the anisotropic scattering polarizer do not show absorption and thereby have high transmittance compared to the absorptive polarizer such as a linearly polarizing film and are preferred in the point of further improving the brightness in a 2D display mode. However, some reflective polarizers and anisotropic scattering polarizers show low degrees of polarization compared to absorptive polarizers. Accordingly, from the viewpoint of decreasing crosstalk in a 3D display mode, a liner polarizing film, which is an absorptive polarizer, is preferably employed.

The barrier element of the present invention comprises a retardation film disposed in at least one face of the liquid crystal cell. The retardation film is preferably disposed in both faces of the liquid crystal cell from the viewpoint of improving 3D display characteristics.

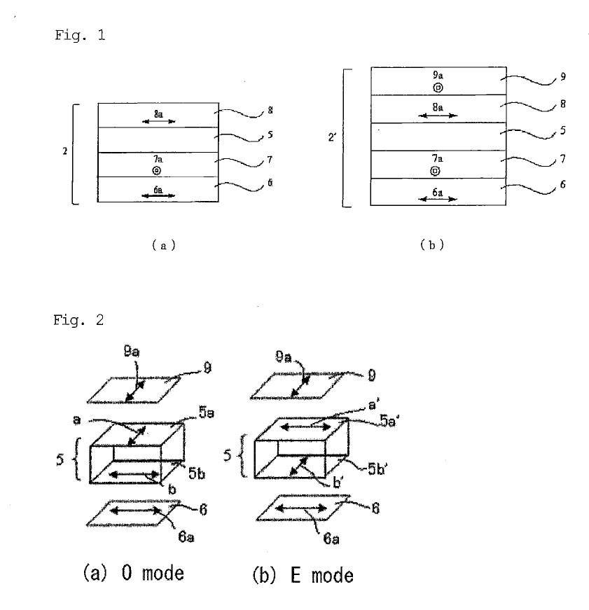

FIG. 1(a) illustrates a schematic cross-sectional view of an example of the barrier element of the present invention. In the drawing, the relative thickness of each layer is not necessarily the same as the actual relative thickness. The same applies to all the other drawings.

FIG. 1(a) illustrates a barrier element 2 comprising a first polarization controlling element 6, a liquid crystal cell 5, and retardation films 7 and 8 respectively disposed between the first polarization controlling element 6 and the liquid crystal cell 5 and in the other face of the liquid crystal cell 5. The barrier element 2 is disposed, for example, at the front of an image display device serving as a liquid crystal panel such that the first polarization controlling element 6 is disposed at the front side. In this embodiment, the first polarization controlling element 6 is preferably a linearly polarizing film. The linearly polarizing film is preferably disposed such that the absorption axis is orthogonal to the absorption axis of the linearly polarizing film disposed at the side of the display face of the liquid crystal panel used in combination.

Alternatively, the barrier element 2 is disposed, for example, at the rear of an image display device serving as a liquid crystal panel, and the first polarization controlling element 6 is disposed at the rear, i.e., at the side of the backlight. In this embodiment, the first polarization controlling element 6 may be any one of an absorptive polarizer (linearly polarizing film), a reflective polarizer, and an anisotropic scattering polarizer. In an embodiment in which the first polarization controlling element 6 is a linearly polarizing film, the linearly polarizing film is preferably disposed such that the absorption axis is orthogonal to the absorption axis of the linearly polarizing film disposed at the rear side of the liquid crystal panel used in combination. In an embodiment in which the first polarization controlling element 6 is a reflective polarizer or an anisotropic scattering polarizer, the reflective polarizer or the anisotropic scattering polarizer enhances the linear polarization of light, which is absorbed by the absorption axis of the linearly polarizing film disposed at the rear side of the liquid crystal panel used in combination, by means of polarized light reflection or anisotropic scattering of polarized light.

FIG. 1(b) illustrates a barrier element 2′ comprising a pair of a first polarization controlling element 6 and a second polarization controlling element 9, a liquid crystal cell 5 disposed therebetween, and retardation film 7 disposed between the first polarization controlling element 6 and the liquid crystal cell 5 and a retardation film 8 disposed between the second polarization controlling element 9 and the liquid crystal cell 5. The barrier element 2′ is disposed at the front or the rear of an image display device, and the first polarization controlling element 6 is disposed at the front side or the back side.

In an embodiment in which the barrier element 2′ is disposed at the front side of an image display device, the first and the second polarization controlling elements 6 and 9 are preferably linearly polarizing films and are preferably disposed such that the absorption axes 6a and 9a thereof are orthogonal to each other. When the image display device is a liquid crystal panel or the like and comprises a linearly polarizing film at the side of the display face as a structural component, the linearly polarizing film disposed at the side of the image display device as the second polarization controlling element 9 is required to be disposed such that its absorption axis is parallel to the absorption axis of the linearly polarizing film at the side of the display face of the image display device.

In an embodiment in which the barrier element 2′ is disposed at the rear side of an image display device, the first polarization controlling element 6 disposed at the rear side and nearer to the backlight may any one of an absorptive polarizer (linearly polarizing film), a reflective polarizer, and an anisotropic scattering polarizer. The second polarization controlling element 9 disposed at the side of the image display device is preferably a linearly polarizing film. In an embodiment in which the first and the second polarization controlling elements 6 and 9 are linearly polarizing films, the linearly polarizing films are preferably disposed such that the absorption axes 6a and 9a thereof are orthogonal to each other. In an embodiment in which the first polarization controlling element 6 is a reflective polarizer or an anisotropic scattering polarizer and the second polarization controlling element 9 is a linearly polarizing film, the reflective polarizer or the anisotropic scattering polarizer used as the first polarization controlling element 6 enhances the linear polarization of light, which is absorbed by the absorption axis of the linearly polarizing film used as the second polarization controlling element 9, by means of polarized light reflection or anisotropic scattering of polarized light.

The liquid crystal cell 5 may have any configuration without particular limitation. In an exemplary configuration, a liquid crystal layer is disposed between a pair of substrates each having an electrode.

The liquid crystal cell 5 may be driven by any driving mode without particular limitation. A single driving mode may be used, or different driving modes may be used in combination. Various modes, such as twisted nematic (TN), super twisted nematic (STN), vertical alignment (VA), in plane switching (IPS), and optically compensated bend cell (OCB) modes, can be used. In particular, the TN mode, which shows high transmittance compared to the VA mode and the IPS mode, is preferred from the viewpoint of improving the brightness in a 2D display mode. From the viewpoint of electric power saving, in particular, the TN mode, which is a normally white mode, is preferred. With the transmittance, the TN mode liquid crystal cell used in the barrier element preferably has a higher Δnd(550) than that of the TN mode liquid crystal cell used in general image display devices. Specifically, the Δnd(550) is, but should not be limited to, preferably 380 to 540 nm.

In an embodiment of a liquid crystal cell 5 in a TN mode, the configuration of the linearly polarizing films disposed in both sides of the liquid crystal cell 5 (the first and the second polarization controlling elements 6 and 9 in FIG. 1(b), and the first polarization controlling element 6 and the linearly polarizing film of the image display device in FIG. 1(a)) can be in an O mode or an E mode. In the present invention, the configuration may be the O mode or the E mode. For example, in the embodiment shown in FIG. 1(b), the linearly polarizing films 6 and 9 disposed in both sides of the liquid crystal cell 5 may be disposed such that, as shown in FIG. 2(a), the absorption axes 6a and 9a of the linearly polarizing films 6 and 9 are parallel to the alignment direction of the liquid crystal molecules of the liquid crystal cell 5 when no voltage is applied, i.e., the direction a of rubbing treatment applied to the inner face of the substrate 5a of the liquid crystal cell 5 or may be disposed such that, as shown in FIG. 2(b), the absorption axes 6a and 9a of the linearly polarizing films 6 and 9 are orthogonal to the alignment direction of the liquid crystal molecules of the liquid crystal cell 5 when no voltage is applied, i.e., the direction a of rubbing treatment applied to the inner face of the substrate 5a of the liquid crystal cell 5. In the TN mode, the inner faces of the opposing substrates 5b and 5b′ of the substrates 5a and 5a′ to the liquid crystal cell 5 are subjected to rubbing treatment in the directions b and b′ respectively orthogonal to the directions a and a′, and the inner faces are distortedly aligned when no voltage is applied.

In general, in an image display apparatus comprising a TN mode liquid crystal cell, from the viewpoint of display characteristics, a pair of linearly polarizing films are disposed such that the angles of the absorption axes of the films are 45° and 135°, respectively, from the display face. When the angles of the absorption axes are 45° and 135°, respectively, however, the barrier pattern of the barrier element does not function for, for example, a viewer wearing sunglasses at outdoors or the like, and the viewer cannot recognize the image as a 3D image. Therefore, considering various manners of use, the absorption axis of the first polarization controlling element (and also the second polarization controlling element in the embodiment shown in FIG. 1(b)) is preferably in the direction of 0° or 90° from the display face.

In both embodiments shown in FIG. 1(a) and FIG. 1(b), the in-plane slow axes 7a and 8a of the retardation films 7 and 8 are preferably orthogonal or parallel to each other and are more preferably orthogonal to each other as shown in FIG. 1(a) and FIG. 1(b). In an embodiment of a liquid crystal cell 5 in a TN mode, as shown in FIG. 1(a) and FIG. 1(b), the retardation films 7 and 8 are preferably disposed in both sides of the liquid crystal cell 5, and the same retardation films are preferably disposed such that their slow axes are orthogonal to each other.

The retardation films 7 and 8 may be each a monolayer structure or a laminate structure composed of two or more layers. Examples thereof include a single polymer film and a laminate composed of two or more polymer films. In an embodiment of a liquid crystal cell 5 in a TN mode, an optically anisotropic layer containing a liquid crystalline compound (preferably a discotic liquid crystalline compound) fixed in an alignment state (preferably hybrid alignment state) or an optically anisotropic layer having a major axis tilted in the thickness direction is preferably disposed between the liquid crystal cell 5 and the retardation film 7 and between the liquid crystal cell 5 and the retardation film 8. Such arrangement of the optically anisotropic layers can further reduce crosstalk. The retardation film and the optically anisotropic layer are described in detail below.

In both embodiments shown in FIG. 1(a) and FIG. 1(b), the in-plane slow axes 7a and 8a of the retardation films 7 and 8 are preferably orthogonal or parallel to the absorption axes 6a and 9a of the first and the second polarization controlling elements 6 and 9. If the axis misalignment is 10° or less, the misalignment would not affect the 3D and 2D display characteristics. That is, the angle defined by each of the in-plane slow axes 7a and 8a of the retardation films 7 and 8 and each of the absorption axes 6a and 9a of the first and the second polarization controlling elements 6 and 9 should preferably be in the range of 90°±10° or 0°±10°.

The barrier element of the present invention may display any barrier pattern composed of light transmitting portions and light shielding portions. An optimum barrier pattern, such as a stripe or grid pattern, is selected depending on the parallax. The contrast ratio of the light transmitting portion to the light shielding portion is preferably 4 or more and more preferably 8 or more.

As described above, the barrier element of the present invention can be controlled to have any barrier pattern. In 3D display apparatuses of conventional parallax barrier systems, an optimum observation range for achieving a 3D display mode is determined in advance. In contrast, in the 3D display apparatus of the present invention, an optimum 3D observation range can be adjusted depending on the position of a viewer.

The barrier element of the present invention may further comprise a protective film disposed at the outer side of the first polarization controlling element.

### (3D Display Apparatus)

An example of the 3D display apparatus having the barrier elements of the present invention in the front (at the side of the display face) of the image display device will now be described with reference to drawings.

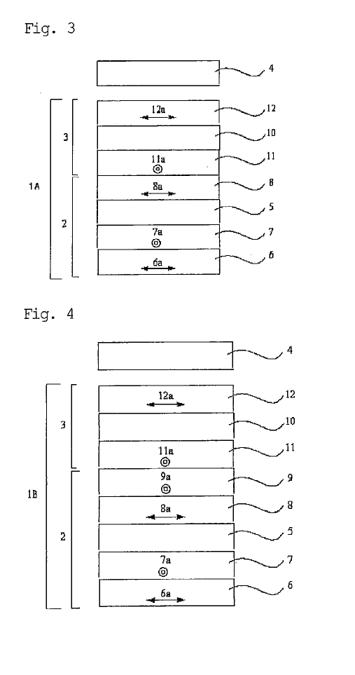

FIG. 3 is a schematic cross-sectional view illustrating an example of the 3D display apparatus of the present invention having the barrier element 2 shown in FIG. 1(a). FIG. 4 is a schematic cross-sectional view illustrating another example of the 3D display apparatus of the present invention having the barrier element 2′ shown in FIG. 1(b). The components common to FIGS. 1 and 2 are denoted by the same reference numerals, and detailed descriptions thereof are omitted.

The 3D display apparatus 1A shown in FIG. 3 comprises a barrier element 2, an image display device 3, and a backlight 4. The 3D display apparatus 1B shown in FIG. 4 comprises a barrier element 2′, an image display device 3, and a backlight 4. The image display device 3 may have any structure without particular limitation. For example, the image display device 3 may be a liquid crystal panel comprising a liquid crystal layer or an organic EL display panel comprising an organic EL layer. These embodiments can include any candidate configuration.

The image display device 3 is a liquid crystal panel comprising a pair of a third linearly polarizing film 11 and a fourth linearly polarizing film 12 and a liquid crystal cell 10 for image display disposed between the pair of films 11 and 12, and a backlight 4 is disposed behind the liquid crystal cell 10 for image display and also behind the fourth linearly polarizing film 12 to construct a transparent mode. The absorption axes of the third and fourth linearly polarizing films 11 and 12 are disposed so as to be orthogonal to each other, i.e., in crossed Nicols arrangement.

The liquid crystal cell 10 for image display is used for displaying images for the left eye and the right eye, and the driving mode is selected from the viewpoint of display characteristics. For example, the VA mode and the IPS mode are excellent in the viewing angle characteristics and are suitable as the mode of the liquid crystal cell 10 for image display. The liquid crystal cell 10 for image display may have any structure without particular limitation, and a common liquid crystal cell structure can be employed. The liquid crystal cell 10 for image display comprises, for example, a pair of substrates facing each other (not shown) and a liquid crystal layer disposed between the pair of substrates and optionally comprises, for example, a color filter layer. Furthermore, an optical film for compensating the viewing angle may be disposed between the fourth polarizing film 12 and the liquid crystal cell 10 for image display or between the third polarizing film 11 and the liquid crystal cell 10 for image display.

The third polarizing film 11 and the fourth polarizing film 12 are disposed such that the absorption axis 11a and the absorption axis 12a thereof are orthogonal to each other. In an embodiment in which the liquid crystal cell 10 for image display is the VA mode or the IPS mode, the third polarizing film 11 and the fourth polarizing film 12 are disposed such that one of the absorption axis 11a and the absorption axis 12a is parallel to the horizontal direction of the display face and that the other is parallel to the vertical direction.

In FIGS. 3 and 4, barrier elements 2 and 2′ are each disposed at the front of the image display device 3 and are each disposed at the side of the display face such that the linearly polarizing film as the first polarization controlling element 6 is disposed at the front side. In the example shown in FIG. 3, the third polarizing film 11 is also used for an image-displaying function of the liquid crystal cell 10 for image display and is also used for a barrier pattern-displaying function of the liquid crystal cell 5 of the barrier element. In the example shown in FIG. 4, the barrier element 2′ comprises a linearly polarizing film 9 as a second polarization controlling element that is used for a barrier pattern-displaying function, separately from the third polarizing film 11. Thus, the functions of these films are separated. In this case, the transmission axis 9a of the second polarizing film 9 is required to be parallel to the transmission axis 11a of the third polarizing film 11. The configuration shown in FIG. 3 is preferred from the viewpoints of a reduction in thickness and front brightness. The configuration shown in FIG. 4 can separate the image-displaying function and the barrier pattern-displaying function from each other and may provide advantages for the production process.

A polymer film may be disposed between the second polarizing film 9 and the third polarizing film 11 for protecting the films. The polymer film is preferably an optically isotropic polymer film having a low Re and a low Rth.

The liquid crystal cell 5 of each of the barrier elements 2 and 2′ is configured such that the 2D display mode and the 3D display mode are mutually switchable. In an embodiment in which the liquid crystal cell 5 is in a normally white mode, the liquid crystal 5 is in the 3D display mode when a voltage is applied, and a barrier pattern composed of light transmitting portions and light shielding portions, e.g., a barrier stripe image, is displayed. The image display device 1 displays images for the right eye and the left eye, and the image for the right eye enters only the right eye of a viewer and the image for the left eye enters only the left eye of the viewer due to the barrier stripe image. As a result, the viewer recognizes the images as a stereo image. The liquid crystal cell 5 is in the 2D display mode when no voltage is applied, and the barrier pattern image disappears, resulting in the entire white display. Therefore, the image display device 1 can display an image without reducing the brightness.

In one of the 3D display modes, a display apparatus and a liquid crystal cell are stacked, images displayed for the right eye and the left eye are superimposed on the display apparatus behind the liquid crystal cell, and the liquid crystal cell in the front controls the polarization of each image for each pixel such that the right and left images are separately recognized using polarized glasses. For example, Japanese Patent Laid-Open No. 2010-134393 describes the system. The 3D display apparatus of the present invention may have a λ/4 film at the viewing side of the first polarization controlling element 6 shown in FIG. 3 or 4. In such a configuration, the liquid crystal cell 5 of the barrier element can also be used as an active retarder. That is, a single cell can be used for both stereoscopic display with naked eyes and stereoscopic display using glasses according to the purpose. In this configuration, the slow axis of the λ/4 film and the absorption axis of the first polarization controlling element 6 preferably define an angle of 45° or 135°.

An example in which the barrier element of the present invention is disposed at the rear side of the image display device will now be described.

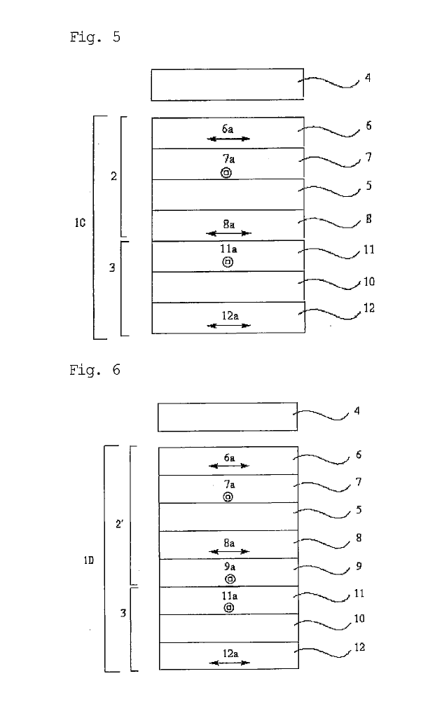

FIG. 5 is a schematic cross-sectional view illustrating an example of the 3D display apparatus of the present invention having the barrier element 2 shown in FIG. 1(a). FIG. 6 is a schematic cross-sectional view illustrating another example of the 3D display apparatus of the present invention having the barrier element 2′ shown in FIG. 1(b). The components common to FIGS. 1 to 4 are denoted by the same reference numerals, and detailed descriptions thereof are omitted.

The 3D display apparatus 10 of the present invention shown in FIG. 5 comprises an image display device 3, a barrier element 2, and a backlight 4 in this order. The 3D display apparatus 10 of the present invention shown in FIG. 6 comprises an image display device 3, a barrier element 2′, and a backlight 4 in this order. In the barrier elements 2 and 2′, the first polarization controlling element 6 is disposed at the rear side, i.e., at the side of the backlight.

In the example shown in FIG. 5, the third polarizing film 11 is also used for an image-displaying function of the liquid crystal cell 10 for image display and is also used for a barrier pattern-displaying function of the liquid crystal cell 5 of the barrier element 2. In the example shown in FIG. 6, the barrier element 2′ comprises a linearly polarizing film 9 as a second polarization controlling element that is used for a barrier pattern-displaying function, separately from the third polarizing film 11. Thus, the functions of these films are separated. In this case, the transmission axis 9a of the second polarizing film 9 is required to be parallel to the transmission axis 11a of the third polarizing film 11. The configuration shown in FIG. 5 is preferred from the viewpoints of a reduction in thickness and front brightness. The configuration shown in FIG. 6 can separate the image-displaying function and the barrier pattern-displaying function from each other and may provide advantages for the production process.

A polymer film may be disposed between the second polarizing film 9 and the third polarizing film 11 for protecting the films. The polymer film is preferably an optically isotropic polymer film having a low Re and a low Rth.

In the structures shown in FIGS. 5 and 6, the first polarization controlling element 6 may be any of an absorptive polarizer (linearly polarizing film), a reflective polarizer, and an anisotropic scattering polarizer. In an embodiment in which the first polarization controlling element 6 is a linearly polarizing film, the linearly polarizing film is disposed such that, in the example shown in FIG. 5, the absorption axis 6a is orthogonal to the absorption axis 11a of the linearly polarizing film 11 at the rear side of the image display device 3 and such that, in the example shown in FIG. 6, the absorption axis 6a is orthogonal to the absorption axis 9a of the linearly polarizing film 9 as the second polarization controlling element of the barrier element 2′. In an embodiment in which the first polarization controlling element 6 is a reflective polarizer or an anisotropic scattering polarizer, in the example shown in FIG. 5, the reflective or anisotropic scattering polarizer enhances the linearly polarizing film that is absorbed by the absorption axis 11a of the linearly polarizing film 11 at the rear side of the image display device 3 by means of polarized light reflection or anisotropic scattering of polarized light; and, in the example shown in FIG. 6, the reflective or anisotropic scattering polarizer enhances the linearly polarizing film that is absorbed by the absorption axis 9a of the linearly polarizing film 9 as the second polarization controlling element of the barrier element 2′ by means of polarized light reflection or anisotropic scattering of polarized light.

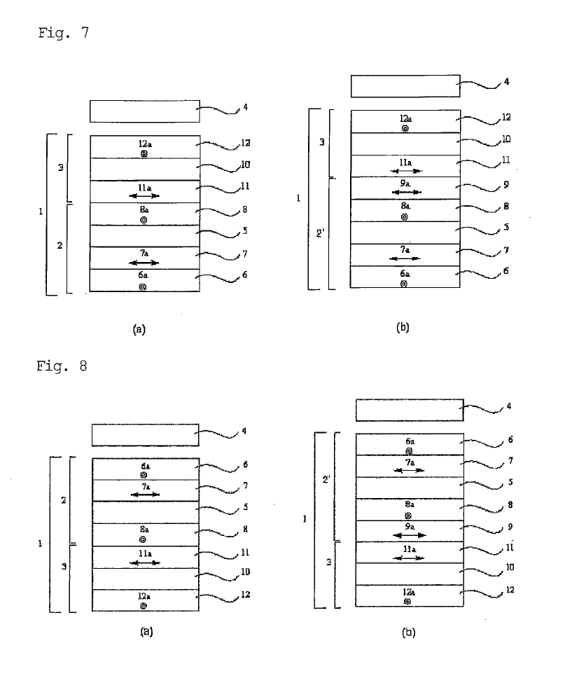

The relationship between the axes of the components shown in FIGS. 3 to 6 is the same when rotated by 90°. That is, the examples shown in FIGS. 3 and 4 respectively are equivalent to those shown in FIG. 7(a) and FIG. 7(b), and the examples shown in FIGS. 5 and 6 respectively are equivalent to those shown in FIG. 8(a) and FIG. 8(b).

The components used in the barrier element and the 3D display apparatus of the present invention will now be described in detail.

### 1. Retardation Film

The barrier element of the present invention comprises a retardation film for optically compensating the liquid crystal cell. The retardation film is disposed between the first polarization controlling element and one face of the liquid crystal cell and/or in the other face of the liquid crystal cell. Two retardation films are preferably disposed at both positions as shown in FIG. 1(a) and FIG. 1(b). In such a case, the retardation films preferably have the same optical characteristics. The retardation films are disposed such that the in-plane slow axes are orthogonal or parallel to the absorption axis of the first polarization controlling element (and also the second polarization controlling element in the configuration shown in FIG. 1(b)). If the axis misalignment is 10° or less, the misalignment would not affect the 3D and 2D display characteristics. That is, the angle defined by the in-plane slow axis of the retardation film and the absorption axis of the first polarization controlling element (and also the second polarization controlling element in the configuration shown in FIG. 1(b)) should preferably be in the range of 90°±10° or 0°±10°.

It is preferred that the retardation film be formed of a polymer film or comprise a polymer film because the retardation film can also functions as a protective film for the linearly polarizing film in an embodiment in which the first polarization controlling element is a linearly polarizing film.

The retardation film has a retardation in plane Re(550) of −30 to 100 nm and an Rth(550) of −15 to 180 nm at a wavelength of 550 nm.

In an embodiment of one retardation film having an Rth(550) of 30 to 180 nm is disposed only in one face of the liquid crystal cell, the retardation film preferably has an Re(550) of −10 to 100 nm and more preferably 10 to 100 nm while the Rth(550) is preferably 40 to 180 nm and more preferably 80 to 160 nm.

The retardation film having an Re(550) within the above-mentioned range can reduce the crosstalk at a front view to an acceptable level, and the retardation film having an Rth(550) within the above-mentioned range can reduce the crosstalk when viewed from horizontally oblique directions to acceptable levels.

In an embodiment of two retardation films each having an Rth(550) of 30 to 180 nm are disposed in both faces of the liquid crystal cell, the retardation films preferably have an Re(550) of −10 to 80 nm and more preferably 10 to 60 nm while the Rth(550) is preferably 60 to 160 nm and more preferably 80 to 140 nm.

The retardation film having an Re(550) within the above-mentioned range can reduce the crosstalk at a front view to an acceptable level, and the retardation film having an Rth(550) within the above-mentioned range can reduce the crosstalk when viewed from horizontally oblique directions to acceptable levels.

In a case of the retardation film having an Rth(550) of −15 to 30 nm, an optically anisotropic layer formed from a composition containing a liquid crystalline compound and having an Re(550) of 20 nm or more may be disposed in the retardation film. In an embodiment in which the retardation film provided with the optically anisotropic layer is disposed only in one face of the liquid crystal cell, the retardation film preferably has an Re(550) of −10 to 100 nm and more preferably 10 to 100 nm; and the Rth(550) is preferably −10 to 30 nm and more preferably −10 to 20 nm.

A retardation film having an Re(550) within the above-mentioned range can reduce the crosstalk at a front view to an acceptable level.

In an embodiment of two retardation films each having an Rth(550) of −15 to 30 nm are provided with optically anisotropic layers are disposed in both faces of the liquid crystal cell, the retardation films preferably have an Re(550) of −10 to 80 nm and more preferably 10 to 60 nm; and the Rth(550) is preferably −10 to 30 nm and more preferably −10 to 20 nm.

The retardation film having an Re(550) within the above-mentioned range can reduce the crosstalk at a front view to an acceptable level.

The retardation film may be formed of a single polymer film or two or more polymer films. The polymer film may be optically uniaxial or biaxial and is preferably biaxial.

Examples of the polymer material used for formation of the retardation film includes, but not limited to, cellulose esters; polycarbonate polymers; polyester polymers such as polyethylene terephthalate and polyethylene naphthalate; acrylic polymers such as polymethyl methacrylate; and styrenic polymers such as polystyrene and acrylonitrile/styrene copolymers (AS resins). In addition, one or more polymers can be selected from polymers including polyolefins such as polyethylene and polypropylene; cyclic polyolefins such as the norbornene; polyolefin-based polymers such as ethylene/propylene copolymers; vinyl chloride polymers; amide polymers such as nylon and aromatic polyamides; imide polymers; sulfone polymers; polyether sulfone polymers; polyether-ether-ketone polymers; polyphenylene sulfide polymers; vinylidene chloride polymers; vinyl alcohol polymers; vinyl butyral polymers; arylate polymers; polyoxymethylene polymers; epoxy polymers; and mixture thereof, and the selected polymer can be used as a main component for producing a polymer film to be used.

An example of the retardation film is a cellulose acylate film. In particular, a film containing cellulose acetate having acetyl groups as a main component is preferred. Especially preferred is a polymer film composed of or comprising a low-degree substitution layer containing, as a main component, a cellulose acylate having a low degree of substitution (preferably cellulose acetate having a low degree of substitution) and satisfying the following Expression (1):

2.0<Z1<2.7 (1)

(in Expression (1), Z1 represents the total degree of substitution of cellulose acylate by acyl (preferably acetyl)).

The method of producing a polymer film containing a cellulose acylate satisfying Expression (1) as a main component is described in detail in Japanese Patent Laid-Open No. 2010-58331, which is incorporated by reference.

Process of Forming Polymer Film

The cellulose acylate film that is used as a part or all of a polymer film can be produced by various processes. Examples of the process include solution casting, melt extrusion, calendering, and compression molding. Among these film-forming processes, solution casting and melt extrusion are preferred, and solution casting is particularly preferred. In the solution casting, a film can be produced using a solution (dope) of a cellulose acylate dissolved in an organic solvent. In a case of using an additive, the additive may be added at any timing during the preparation of the dope. The process of producing a cellulose acylate film that can be used in the present invention is described in paragraphs [0219] to [0224] of Japanese Patent Laid-Open No. 2006-184640, which is incorporated by reference.

The retardation of the cellulose acylate film used in the present invention may be adjusted by stretching. The stretching may be uniaxial stretching or biaxial stretching. The biaxial stretching is preferably performed by simultaneous biaxial stretching or sequential biaxial stretching. In continuous production, the sequential biaxial stretching is suitable. In the sequential biaxial stretching, dope is cast onto a band or a drum, and the resulting film is detached off, stretched in the lateral direction (or the longitudinal direction) and then in the longitudinal direction (or the lateral direction).

The methods for stretching in the lateral direction are described in Japanese Patent Laid-Open Nos. Sho 62-115035, Hei 4-152125, Hei 4-284211, Hei 4-298310, and Hei 11-48271. The film is stretched at ordinary temperature or elevated temperature. The heating temperature is preferably not higher than the glass transition temperature of the film. The a film may be stretched during a drying step. The stretching in a state where the solvent remains may give a specific effect.

In the stretching in the longitudinal direction, the film can be easily stretched by controlling the rotation of the film-conveying rollers such that the take-up rate for the film is higher than the releasing rate of the film.

In the stretching in the lateral direction, the film can be stretched by conveying the film while the width of the film being held by a tenter and gradually stretched.

In an example of the method for producing a cellulose acylate film satisfying the above-described optical characteristics, a film produced through any one of the processes described above (preferably through solution casting) is stretched by a draw ratio (rate of the increased length to the original length) of 0% to 60% (more preferably 0% to 50%).

In the present invention, one or more optically anisotropic layers composed of a composition containing a liquid crystalline compound or one or more laminates comprising an optically anisotropic layer having a major axis tilted in the thickness direction may be disposed in one face or both faces of the liquid crystal cell, in the retardation film. In an embodiment in which the liquid crystal cell of the barrier element is in a TN mode, the laminates are preferably disposed in both faces of the liquid crystal cell. In such a case, the laminates are symmetrically disposed with respect to the liquid crystal cell as the center. In an embodiment of the liquid crystal cell of the barrier element that is in a TN mode, the retardation film constituting the laminate preferably has an Rth(λ) showing forward wavelength dispersibility (the Rth(λ) decreases with an increase in wavelength) to reduce the change in tint of white portions in a 2D display mode.

In a case where the retardation film has an Rth(550) of −15 to 30 nm, the optically anisotropic layer is preferably disposed in the retardation film. In such a case, the Re(550) of the optically anisotropic layer is preferably 20 nm or more.

The Re(550) of the optically anisotropic layer is preferably 20 to 58 nm, more preferably 25 to 52 nm, and most preferably 27 to 40 nm. The optically anisotropic layer having an Re(550) within the above-mentioned range can reduce the crosstalk at a front view to an acceptable level.

With the optically anisotropic layer, in the plane (plane of incidence) containing the normal line orthogonal to the slow axis of the retardation film, the ratio of the retardation R[+40°] measured from the direction tilted by 40° from the normal line to the film plane direction to the retardation R[−40°] measured from the direction tilted by 40° from the normal line to the reverse direction (where R[−40°]<R[+40°]) preferably satisfies 1<R[+40°]/R[−40°], more preferably 3 R[+40°]/R[−40°], and most preferably 4≦R[+40°]/R[−40°] at a wavelength of 550 nm. A ratio, R[+40°]/R[−40°], larger than 1 can reduce a change in tint between a front view and an oblique view in a 2D display mode.

In an embodiment in which the optically anisotropic layer is composed of a composition containing a liquid crystalline compound, the composition is preferably a polymerizable composition containing a liquid crystalline compound. The liquid crystalline compound used for forming the optically anisotropic layer may be a rodlike liquid crystalline compound or a discotic liquid crystalline compound. In an embodiment in which the liquid crystal cell for converting polarization is in a TN mode, a discotic (disc-shaped) liquid crystalline compound is preferred. Examples of the discotic liquid crystalline compound include triphenylene compounds and tri-substituted benzene compounds having substituents at 1, 3, and 5-positions on the benzene ring.

The liquid crystal molecules in the optically anisotropic layer may have any alignment state without restriction. In an embodiment in which the liquid crystal cell for forming a barrier layer is in a TN mode, the liquid crystalline compound molecules in the optically anisotropic layer are preferably fixed in a hybrid alignment state. The term “hybrid alignment” refers to an alignment state where the angle defined by the molecular major axis and the layer face of a rodlike liquid crystalline compound or the angle defined by the discotic plane of the molecules and the layer face in a discotic liquid crystalline compound (hereinafter, each angle referred to as “tilt angle”) varies (increases or decreases) in the layer thickness direction. The optically anisotropic layer is usually formed by aligning a composition containing a discotic liquid crystalline compound in the face of an alignment film. The layer, therefore, includes an alignment film interface and an air interface. The hybrid alignment has two configurations: a configuration where the tilt angle is large at the alignment film interface and is small at the air interface (i.e., a configuration where the tilt angle decreases from the alignment interface toward the air interface, hereinafter, referred to as “reverse hybrid alignment”) and a configuration where the tilt angle is small at the alignment interface and is large at the air interface (i.e., a configuration where the tilt angle increases from the alignment interface toward the air interface, hereinafter, referred to as “normal hybrid alignment”). Both configurations can reduce crosstalk and color shift in white display portions.

Examples of the discotic compound usable in the present invention include benzene derivatives (described in a research report by C. Destrade, et al., Mol. Cryst., vol. 71, p. 111 (1981)), truxene derivatives (described in research reports by C. Destrade, et al., Mol. Cryst., vol. 122, p. 141 (1985) and Physics lett., A, vol. 78, p. 82 (1990)), cyclohexane derivatives (described in a research report by B. Kohne, et al., Angew. Chem., vol. 96, p. 70 (1984)), and aza-crown or phenylacetylene macrocycles (described in a research report by J. M. Lehn, et al., J. Chem. Commun., p. 1794 (1985) and a research report by J. Zhang, et al., J. Am. Chem. Soc., vol. 116, p. 2655 (1994)).

The discotic liquid crystalline compound preferably has a polymerizable group so as to be fixed by polymerization. For example, in a candidate structure, a polymerizable group as a substituent is bonded to the disc-shaped core of the discotic liquid crystalline compound. However, if a polymerizable group is directly bonded to the disc-shaped core, the alignment state is barely maintained during the polymerization reaction. Accordingly, it is preferable to dispose a linking group between the disc-shaped core and the polymerizable group. That is, the discotic liquid crystalline compound having a polymerizable group is preferably a compound represented by the following formula:

D(-L-P)ₙ (III):

where D represents a discoidal core; L represents a divalent linker; P represents a polymerizable group; and n represents an integer of 1 to 12.

In Formula, preferable specific examples of the discoidal core (D), the divalent linker (L), and the polymerizable group (P) include (D1) to (D15), (L1) to (L25), and (P1) to (P18), respectively, described in Japanese Patent Laid-Open No. 2001-4837. The contents relating to the discoidal core (D), the divalent linker (L), and the polymerizable group (P) described in this patent application can be preferably incorporated herein. The transition temperature from the discotic nematic liquid crystal phase to the solid phase of the liquid crystalline compound is preferably 30° C. to 300° C. and more preferably 30° C. to 170° C.

Examples of the tri-substituted benzene discotic liquid crystalline compound include, but not limited to, the compounds described in paragraphs [0052] to [0077] of Japanese Patent Laid-Open No. 2010-244038.

Examples of the triphenylene compound include, but not limited to, the compounds described in paragraphs [0062] to [0067] of Japanese Patent Laid-Open No. 2007-108732.

An example of the composition that can achieve the reverse hybrid alignment state is a composition containing the tri-substituted benzene or triphenylene compound, at least one pyridinium compound represented by Formula (II) below (more preferably Formula (II′)), and at least one compound having a triazine ring group compound represented by Formula (III) below. The amount of the pyridinium compound is preferably 0.5 to 3 parts by mass to 100 parts by mass of the discotic liquid crystalline compound. The amount of the compound having a triazine ring group is preferably 0.2 to 0.4 parts by mass to 100 parts by mass of the discotic liquid crystalline compound.

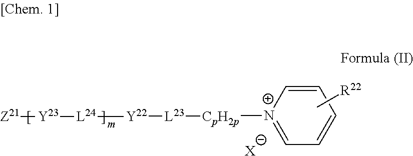

In the formula, L²³ and L²⁴ each represent a divalent linking group; R²² represents a hydrogen atom, an unsubstituted amino group, or a substituted amino group having 1 to 20 carbon atoms; X represents an anion; Y²² and Y²³ each represent a divalent linking group having optionally substituted 5- or 6-membered ring as a partial structure; Z²¹ represents a monovalent group selected from the group consisting of halogen-substituted phenyl, nitro-substituted phenyl, cyano-substituted phenyl, C₁₋₁₀ alkyl-substituted phenyl, C₂₋₁₀ alkoxy-substituted phenyl, alkyl groups having 1 to 12 carbon atoms, alkynyl groups having 2 to 20 carbon atoms, alkoxy groups having 1 to 12 carbon atoms, alkoxycarbonyl groups having 2 to 13 carbon atoms, aryloxycarbonyl groups having 7 to 26 carbon atoms, and arylcarbonyloxy groups having 7 to 26 carbon atoms; p represents an integer number of 1 to 10; and m represents 1 or 2.

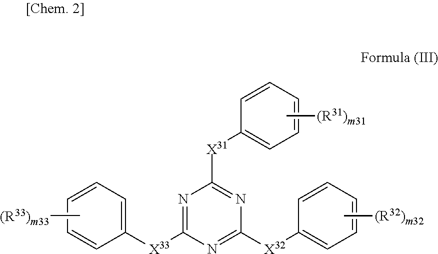

In the formula, R³¹, R³², and R³³ each represent an alkyl group or alkoxy group having a terminal CF₃ group, provided that two or more non-adjacent carbon atoms in the alkyl group (including alkyl group in an alkoxy group) may be replaced by oxygen atoms or sulfur atoms; X³¹, X³², and X³³ each represent an alkylene group, —CO—, —NH—, —O—, —S—, —SO₂—, or a group composed of at least two divalent linking groups selected from the group consisting of alkylene groups, —CO—, —NH—, —O—, —S—, and —SO₂—; m31, m32, and m33 each represent an integer number of 1 to 5. In Formula (III), R³¹, R³², and R³³ are each preferably a group represented by the following formula:

—O(CₙH₂ₙ)ₙ₁O(CₘH₂ₘ)ₘ₁—CₖF₂ₖ₊₁

wherein, n and m each represent an integer number of 1 to 3; n1 and m1 each represent an integer number of 1 to 3; and k represents an integer number of 1 to 10.

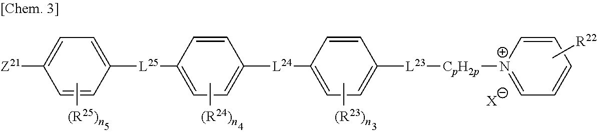

In Formula (II′), the same symbols as those in Formula (II) have the same meanings; L²⁵ is synonymous to L²⁴; R²³, R²⁴, and R²⁵ each represent an alkyl group having 1 to 12 carbon atoms; n3 represents an integer number of 0 to 4; n4 represents an integer number of 1 to 4; and n5 represents an integer number of 0 to 4.

The composition used for forming the optically anisotropic layer contains at least one polymerizable liquid crystalline compound and may further contain one or more additives. Alignment controllers for air interface, repelling inhibitors, polymerization initiators, and polymerizable monomers will be described as usable examples of the additives.

### Alignment-Controller for Air Interface:

The composition is aligned at the air interface with a tilt angle of the air interface. Since the tilt angle varies depending on the types of the liquid crystalline compound and the additives contained in the liquid crystalline composition, the tilt angle of the air interface is required to be appropriately controlled according to the purpose.

The tilt angle can be controlled by, for example, an external field such as an electric field or a magnetic field or with an additive and is preferably controlled with an additive. Such an additive is preferably a compound having at least one substituted or unsubstituted aliphatic group having 6 to 40 carbon atoms or having at least one oligosiloxanoxy group with a substituted or unsubstituted aliphatic group having 6 to 40 carbon atoms in the molecule. The number of aliphatic groups or oligosiloxanoxy groups is more preferably two or more. For example, hydrophobic compounds having excluded volume effect described in Japanese Patent Laid-Open No. 2002-20363 can be used as the alignment controller for the air interface.

The fluoroaliphatic group-containing polymers described in Japanese Patent Laid-Open No. 2009-193046 also have similar effects and can be used as the alignment controller for the air interface.

The amount of the additive as an alignment controller for the air interface is preferably 0.001 to 20% by mass, more preferably 0.01 to 10% by mass, and most preferably 0.1 to 5% by mass based on the total mass of the composition (solid content in the case of a coating solution, hereinafter the same shall apply).

### Repelling Inhibitor:

In general, a polymer compound is preferably used as a material that is added to the composition for inhibiting repelling during coating of the composition.

Any polymer can be used that does not significantly inhibit the change in tilt angle or the alignment of the composition.

Examples of the polymer include those described in Japanese Patent Laid-Open No. Hei 8-95030. Particularly preferred examples of the polymer are cellulose esters. Examples of the cellulose ester include cellulose acetate, cellulose acetate propionate, hydroxypropyl cellulose, and cellulose acetate butylate.

The amount of the polymer that is used for inhibiting repelling without inhibiting the alignment of the composition is usually in a range of 0.1 to 10% by mass, preferably in a range of 0.1 to 8% by mass, and more preferably in a range of 0.1 to 5% by mass, based on the total mass of the composition

### Polymerization Initiator:

The composition preferably contains a polymerization initiator. If the composition contains a polymerization initiator, the optically anisotropic layer can also be produced by heating the composition to a temperature for forming the liquid crystal phase, performing polymerization, and then fixing the liquid crystal alignment state by cooling the composition. The polymerization can be performed by thermal polymerization using a thermal polymerization initiator, photopolymerization using a photopolymerization initiator, or polymerization by irradiation with electron beams. In order to avoid deformation and deterioration of, for example, supporting materials by heat, photopolymerization or polymerization by irradiation with electron beams is preferred.

Examples of the photopolymerization initiator include α-carbonyl compounds (described in U.S. Pat. Nos. 2,367,661 and 2,367,670), acyloin ethers (described in U.S. Pat. No. 2,448,828), α-hydrocarbon-substituted aromatic acyloin compounds (described in U.S. Pat. No. 2,722,512), polynuclear quinone compounds (described in U.S. Pat. Nos. 3,046,127 and 2,951,758), combinations of triaryl imidazole dimers and p-aminophenylketones (described in U.S. Pat. No. 3,549,367), acridine and phenazine compounds (described in Japanese Patent Laid-Open No. Sho 60-105667 and U.S. Pat. No. 4,239,850), and oxadiazole compounds (described in U.S. Pat. No. 4,212,970).

The amount of the photopolymerization initiator is preferably 0.01 to 20% by mass and more preferably 0.5 to 5% by mass based on the total mass of the composition.

### Polymerizable Monomer:

The composition may contain a polymerizable monomer. Any polymerizable monomer that has compatibility with the liquid crystalline compound contained in the composition and does not significantly inhibit the alignment of the liquid crystalline composition can be used in the present invention. In particular, compounds having polymerizable ethylenically unsaturated groups, such as a vinyl group, a vinyloxy group, an acryloyl group, and a methacryloyl group, are preferably used. The amount of the polymerizable monomer is usually in a range of 0.5 to 50% by mass and preferably in a range of 1 to 30% by mass based on the amount of the liquid crystalline compound contained in the composition. A monomer having two or more reactive functional groups is particularly preferred, which is expected to enhance the adhesion with an alignment film.

The composition may be prepared in the form of a coating solution. The solvent used for preparation of the coating solution is preferably a common organic solvent. Examples of the common organic solvent include amide solvents (e.g., N,N-dimethylformamide), sulfoxide solvents (e.g., dimethylsulfoxide), heterocyclic solvents (e.g., pyridine), hydrocarbon solvents (e.g., toluene and hexane), alkyl halide solvents (e.g., chloroform and dichloromethane), ester solvents (e.g., methyl acetate and butyl acetate), ketone solvents (e.g., acetone, methyl ethyl ketone, methyl isobutyl ketone, and cyclohexanone), and ether solvents (e.g., tetrahydrofuran and 1,2-dimethoxyethane). Preferred are ester solvents and ketone solvents, and particularly preferred are ketone solvents. Two or more organic solvents may be used in combination.

The optically anisotropic layer can be produced by aligning the composition and fixing the alignment state. A nonlimiting example of the method of producing the optically anisotropic layer will now be described.

A composition at least containing a polymerizable liquid crystalline compound is applied onto a face of a support (or onto the face of an alignment film if the alignment is provided on the support). The composition is aligned to be an intended alignment state by optionally, for example, heating. Subsequently, the alignment state is fixed by, for example, polymerization to form an optically anisotropic layer. Examples of the additive that can be incorporated to the composition in this method include the above-described alignment controllers for air interface, repelling inhibitors, polymerization initiators, and polymerizable monomers.

The application can be performed by a known process (e.g., wire-bar coating, extrusion coating, direct gravure coating, reverse gravure coating, or die coating).

In order to achieve a homogenously aligned state, an alignment film is preferably used. The alignment film is preferably formed by subjecting the surface of a polymer film (e.g., a polyvinyl alcohol film or an imide film) to rubbing treatment. Examples of the alignment film preferably used in the present invention include alignment films of acrylic acid copolymers and methacrylic acid copolymers described in paragraphs [0130] to [0175] of Japanese Patent Laid-Open No. 2006-276203. The use of such an alignment film is preferred which can reduce the fluctuation of the alignment of the liquid crystalline compound and achieve high contrast.

Subsequently, polymerization is preferably performed for fixing the alignment state. The polymerization is preferably initiated by irradiating the composition containing a photopolymerization initiator with light. The light is preferably ultraviolet rays. The irradiation energy is preferably 10 mJ/cm² to 50 J/cm² and more preferably 50 to 800 mJ/cm². In order to accelerate the photopolymerization, the irradiation with light may be performed with heating. Since the oxygen concentration in the atmosphere affects the degree of polymerization, if an intended degree of polymerization is not achieved in air, the oxygen concentration is preferably reduced by any method such as nitrogen purge. The oxygen concentration is preferably 10% or less, more preferably 7% or less, and further preferably 3% or less.

In the present invention, the fixed alignment state indicates that the alignment is maintained in the most typical and preferable embodiment. The fixed alignment state is not limited to such an embodiment and specifically refers to a state of the fixed composition that does not have fluidity, does not cause a change in the alignment state by any external field or any external force, and can stably maintain the fixed alignment state usually in a temperature range of 0° C. to 50° C., more strictly in a temperature range of −30° C. to 70° C. Note that once the alignment state is finally fixed to form an optically anisotropic layer, the composition does not need to show any liquid crystallinity. For example, the liquid crystalline compound is allowed to lose the liquid crystallinity as a result of an increase in molecular weight through the polymerization or crosslinking by a thermal or photosensitive reaction, for example.

The optically anisotropic layer may have any thickness, which is usually about 0.1 to 10 μm and more preferably about 0.5 to 5 μm.

The optically anisotropic layer may be formed with an alignment film. The alignment film may be a film mainly composed of a polyvinyl alcohol or modified polyvinyl alcohol of which the surface is subjected to rubbing treatment.

In another embodiment of the optically anisotropic layer, the major axis of the optically anisotropic layer tilts in the thickness direction. In this embodiment, the optically anisotropic layer is preferably a film having a major axis tilting in the thickness direction. Here, the term “major axis” of a film refers to an axis indicating a principal refractive index, nz, in the film thickness direction among the principal refractive indices, nx, ny, and nz, of a refractive index ellipsoid calculated by KOBRA 21ADH or WR. The term “tilt in the thickness direction” means that the major axis tilts by an angle θt° (where 0°<θt<90°, hereinafter, θt is referred to as “tilt angle”) from the normal line of the film plane toward the film plane direction in an arbitrary direction in the film plane defined as a tilt azimuth. That is, it means that the ratio of the retardation R[+40°] measured from the direction tilted by 40° from the normal line to the film plane direction to the retardation R[−40°] measured from the direction tilted by 40° from the normal line to the reverse direction (where R[−40°]<R[+40°]) satisfies 1<R[+40°]/R[−40°] at a wavelength of 550 nm and in the plane (incident plane) containing the normal line orthogonal to the slow axis of the retardation film. The optically anisotropic layer preferably has a tilt angle of 47° or less toward the normal line direction of the film plane and a ratio R[+40°]/R[−40°] of 3 or more, more preferably a tilt angle of 9° to 47° and a ratio R[+40°]/R[−40°] of 8 or more, and most preferably a tilt angle of 20° to 47° and a ratio R[+40°]/R[−40°] of 8 to 15. Even in a case where the liquid crystal cell of the barrier element is in any one of TN, ECB, and OCB modes, the optically anisotropic layer preferably has a tilt angle θt of 47° or less, more preferably 9° to 47°, and most preferably 20° to 47°.

The tilt angle from the film plane of the major axis of a film can be measured by the following method. The error range acceptable in the following method should also be acceptable in the tilt angle of the major axis of the film used in the present invention.

The tilt angle of the major axis of a film is measured with KOBRA 21ADH or WR (manufactured by Oji Keisoku Kiki Co., Ltd.) in the lateral direction (TD direction) of the film as a tilt axis based on the retardation at a tilt angle of 40° and the retardation at a tilt angle of −40°. The wavelength is 550 nm.

The variation in tilt angle of a major axis can be measured by the following method.

The variation in the tilt angle of a major axis can be determined by measuring the tilt angles of the major axis, by the above-described method, at ten points in the lateral direction and ten points in the conveying direction at equal intervals, and is defined by the difference between the largest value and the smallest value of the tilt angles.

The slow axis angle can be determined by measuring the Re, and the variation thereof can also be determined from the difference between the largest value and the smallest value of the slow axis angles measured at ten points in the lateral direction and ten points in the conveying direction at equal intervals.

The optically anisotropic layer in the above-described embodiment can be produced by the following method.

The optically anisotropic layer can be produced by a process involving rolling a molten sheet of a composition containing a thermoplastic resin with two rolls rotating at different circumferential velocities and optionally further stretching the film. This process can stably and readily produce a polymer film satisfying intended optical characteristics. More specifically, a polymer film satisfying intended optical characteristics can be stably produced without causing or with reduced variations in optical characteristics and without causing defects such as contact damages by rolling the composition in a molten state with two rolls rotating at different circumferential velocities. In the film produced by the following method, variations in optical characteristics do not occur or are low and the film surface does not have defects such as contact damages. In such points, the film differs from the films described in Japanese Patent Laid-Open Nos. Hei 7-333437 and Hei 6-222213 in which the optical axis is tilted by rolling a film in a non-molten state with two rolls rotating at different circumferential velocities.

The method will now be described in detail.

In the method, a composition containing a thermoplastic resin (also referred to as “thermoplastic resin composition”) is melt extruded. The thermoplastic resin composition is preferably pelletized before the melt extrusion. The pellets can be formed through drying the thermoplastic resin composition, melting the composition at 150° C. to 300° C. with a biaxial kneading extruder, and solidifying and cutting the extruded composition into noodles in air or in water. Alternatively, the pellet can be formed by underwater cutting where a molten composition extruded from an extruder through a mouthpiece into water is directly cut. Examples of the extruder used in the pelletization include single screw extruders, non-intermeshing counter-rotating twin screw extruders, intermeshing counter-rotating twin screw extruders, and intermeshing co-rotating twin screw extruders. The screw speed of the extruder is preferably 10 to 1000 rpm and more preferably 20 to 700 rpm. The extrusion residence time is 10 sec to 10 min and more preferably 20 sec to 5 min.

The pellets may have any size, which is usually about 10 to 1000 mm³ and preferably about 30 to 500 mm³.

The moisture in the pellets is preferably reduced before melt extrusion. The drying temperature is preferably 40° C. to 200° C. and more preferably 60° C. to 150° C. The moisture content is preferably reduced to 1.0% by mass or less and more preferably 0.1% by mass or less. The drying may be performed in air or nitrogen or under vacuum.

Subsequently, the dried pellets are fed into a cylinder through a feed opening of the extruder and are kneaded and molten. The inside of the cylinder consists, for example, of a feeding portion, a compression portion, and a weighing portion in this order from the feed opening. The screw compression ratio of the extruder is preferably 1.5 to 4.5. The ratio (L/D) of the cylinder length to the cylinder inner diameter is preferably 20 to 70. The cylinder inner diameter is preferably 30 to 150 mm. The extrusion temperature is determined depending on the melting temperature of the thermoplastic resin and is preferably about 190° C. to 300° C. Furthermore, in order to prevent oxidation of the molten resin by the residual oxygen, the extrusion is preferably performed in an inert (such as nitrogen) gas flow inside the extruder or under vacuum with an extruder equipped with a vent.

In order to remove foreign substances in the thermoplastic resin composition, the extruder is preferably equipped with a filter device having a breaker plate filter or a leaf disc filter. The filtration may be performed by one stage or multiple stages. The filtration accuracy is preferably 15 to 3 μm and more preferably 10 to 3 μm. The filter medium is preferably stainless steel. The structure of the filter medium is knitted wire or sintered metal fiber or powder (sintered filter medium). Among them, preferred is a sintered filter medium.

In order to reduce the variation in discharge and improve the thickness precision, a gear pump is preferably disposed between the extruder and the die. As a result, the variation in resin pressure in the die can be reduced to ±1% or less. In order to improve the quantitative feeding performance by the gear pump, the pressure before the gear pump may be controlled to be constant by a variable screw speed.

The pellets are molten with the extruder configured as described above, and the molten resin is continuously conveyed to a die optionally through a filter device and a gear pump. The die may be any one of a T-die, a fish tail die, and a coat hanger die. Furthermore, in order to increase the homogeneity of the resin temperature before the die, a static mixer can be preferably used. The clearance at the outlet of the T die is usually 1.0 to 10 times, preferably 1.2 to 5 times the film thickness.

It is preferable that the thickness of the die can be varied at an interval of 5 to 50 mm. A die of which thickness can be automatically controlled by calculating the thickness and its variation of the downstream film and feed backing the results to the control of the die thickness is also effective.

The optically anisotropic layer can also be produced with a multilayer film forming apparatus besides the monolayer film forming apparatus.

The residence time of the resin entering the feed opening of the extruder until being extruded from the die is preferably 3 to 40 min, and more preferably 4 to 30 min.

Subsequently, the molten thermoplastic resin is extruded in a sheet form from the die, passes between two rolls (e.g., a touching roll and a casting roll), and is cooled to be solidified (touch roll method) into a film. In this method, a molten sheet passes between two rolls rotating at different circumferential velocities, and a polymer film (of which major axis is tilted from the normal direction) is produced by the shear force applied to the film. The use of rolls having larger diameter increases the shear force applied to the film, resulting in a tendency of increasing the value of R[+40°]/R[−40°] (an increase in tilt angle of the major axis). It is preferable to use two rolls (e.g., a touching roll and a casting roll) each having a diameter of 350 to 600 nm (more preferably 350 to 500 nm). The use of a roll having a larger diameter increases the contacting area of the molten sheet with the roll, resulting in an increase in time for applying shear force. Consequently, a film having a larger value of R[+40°]/R[−40°] (the major axis is tilted at a larger tilt angle) with a small variation therein can be produced. In the method of the present invention, the diameters of the two rolls may be the same or different. In addition, the bite of a film is increased to allow more stable production. However, a large temperature distribution in the lateral direction of the molten sheet precludes the homogeneity of the film. Accordingly, in the method, the temperature distribution in the lateral direction of the molten sheet is preferably reduced after the melt extrusion through the die and before contact with at least one of the two rolls. Specifically, the temperature distribution in the lateral direction is preferably within 5° C. In order to reduce the temperature distribution, a component having a heat insulating or reflecting function is preferably disposed at at least part of the passage from the die of the molten sheet and the two rolls to shield the molten sheet from the outside air. Thus, the influence of the external environment, e.g., wind, is reduced by disposing a heat insulating component at the passage to shield the outside air, resulting in a reduction in temperature distribution in the lateral direction of a film. The temperature distribution in the lateral direction of a molten sheet is preferably ±3° C. or less and more preferably ±1° C. or less. Thus, homogeneous temperature in the lateral direction of the molten sheet can be maintained immediately before the passing between the rolls, and thereby the deviation can be reduced.

The temperature distribution of the molten sheet can be measured with a contact thermometer or a non-contact thermometer. In particular, a non-contact infrared thermometer can be used.

A method increasing the adhesion of the molten sheet when it comes into contact with a casting roll can further reduce the variation. Specifically, the adhesion can be increased by employing a combination of processes such as an electrostatic coating process, an air knife process, an air chamber process, and a vacuum nozzle process. Such a process for improving adhesion may be performed over the entire face or a partial face of a molten sheet.

In addition to a conventional method continuously compressing the molten thermoplastic resin composition with the surfaces of two rolls into a film shape, the pressure between the rolls is preferably 5 to 500 MPa, more preferably 20 to 300 MPa, more preferably 25 to 200 MPa, and most preferably 30 to 150 MPa.

In the present invention, the material of the two rolls is preferably a metal and more preferably stainless steel, and rolls of which surfaces are plated are also preferred. Rubber rolls and metal rolls with rubber lining have rough surfaces to cause damages on the surface of the film and should not be used.

Usable examples of the touching roll include those described in Japanese Patent Laid-Open Nos. Hei 11-314263, 2002-36332, and Hei 11-235747, International Publication No. WO97/28950, and Japanese Patent Laid-Open Nos. 2004-216717 and 2003-145609.

The film is preferably cooled with one or more casting rolls in addition to the two rolls (e.g., a casting roll and a touching roll) between which the molten sheet passes. The touching roll is usually disposed so as to be in contact with the first casting roll on the uppermost stream (the side closer to the die). Although three cooling rolls are typically used, any other number of cooling rolls can be also employed. When a plurality of casting rolls are disposed, the distance between the rolls is preferably 0.3 to 300 mm, more preferably 1 to 100 mm, and most preferably 3 to 30 mm as the space between the surfaces.

The surfaces of the touching roll and the casting roll each usually have an arithmetic mean height Ra of 100 nm or less, preferably 50 nm or less, and more preferably 25 nm or less.

Here, the circumferential velocity ratio of two rolls means the ratio of the circumferential velocities of two rolls (the circumferential velocity of a first roll to the circumferential velocity of a second roll), provided that the circumferential velocity of a second roll is larger than the circumferential velocity of a first roll. A larger difference between the circumferential velocities of two rolls, i.e., a smaller circumferential velocity ratio tends to provide a larger value of R[+40°]/R[−40°] of the resulting film (a larger tilt angle of the major axis). An excess difference between the circumferential velocities, however, tends to cause damages on the surface of the resulting film. Specifically, in a case of producing a polymer film having a large value of R[+40°]/R[−40°] (a large tilt angle β of the major axis, such as 20° or more), the circumferential velocity ratio of the two rolls is preferably 0.55 to 0.80 and more preferably 0.55 to 0.74. Furthermore, in order to prevent the film from being damaged, the following requirements (i) to (iii) are preferably satisfied.

(i) The temperature is maintained in the range (specifically, in the range of Tg+50° C. to Tg+70° C. (wherein Tg represents the glass transition temperature of the thermoplastic resin)) so that the loss modulus of elasticity is larger than the storage modulus of elasticity of the viscoelasticity of the molten thermoplastic resin composition immediately before contact with at least one of the two rolls;
(ii) The temperature distribution in the lateral direction of the molten sheet extruded from the die is ±5° C. or less immediately before the molten sheet comes into contact with at least one of the two rolls; and
(iii) The surfaces of the two rolls are at least made of a metal.

The two rolls may be cooperatively or independently driven. In order to reduce the variation of the optical axis, independent driving is preferred. In the present invention, as described above, the two rolls are driven at different circumferential velocities from each other. Furthermore, the surface temperatures of the two rolls may be different from each other. The difference in temperatures is preferably 5° C. to 80° C., more preferably 20° C. to 80° C., and most preferably 20° C. to 60° C. During the drive, the temperature of each roll is controlled to 60° C. to 160° C., more preferably 70° C. to 150° C., and most preferably 80° C. to 140° C. Such temperature control can be achieved by sending a temperature controlled liquid or gas to the interior of the touching roll.

The molten sheet is stretched into a film, and then both ends are preferably trimmed. The cut-out portion by trimming may be pulverized to be recycled as a raw material.

One end or both ends may be subjected to knurling. The height of the asperities by the knurling is preferably 1 to 50 μm and more preferably 3 to 20 μm. The convex may be formed on both surfaces or only one surface by the knurling. The width of the knurling is preferably 1 to 50 mm and more preferably 3 to 30 mm. The knurling can be performed at a temperature from room temperature to 300° C. It is preferred to attach a laminate film or films on one surface or both surfaces before winding. The laminate film preferably has a thickness of 5 to 100 μm and more preferably 10 to 50 μm. The laminate film may be composed of any material such as polyethylene, polyester, or polypropylene.

The winding tension is preferably 2 to 50 kg/m width and more preferably 5 to 30 kg/m width.

In order to produce a polymer film satisfying the characteristics that are required in optically anisotropic layer, the produced film may be subjected to stretching and/or relaxation treatment. For example, the following treatments (a) to (i) may be performed in combination.

(a) horizontal stretching
(b) horizontal stretching→relaxation treatment
(c) vertical stretching→horizontal stretching
(d) vertical stretching→horizontal stretching→relaxation treatment
(e) vertical stretching→relaxation treatment→horizontal stretching→relaxation treatment
(f) horizontal stretching→vertical stretching→relaxation treatment
(g) horizontal stretching→relaxation treatment→vertical stretching→relaxation treatment
(h) vertical stretching→horizontal stretching→vertical stretching
(i) vertical stretching→horizontal stretching→vertical stretching→relaxation treatment

Among these treatments, the horizontal stretching process (a) is particularly necessary.

The horizontal stretching can be performed with a tenter. That is, both ends in the lateral direction of a film are held with clips, and stretching is performed by widening in the horizontal direction. During the process, the stretching temperature can be controlled by sending wind at an intended temperature into the tenter. Throughout the specification, the term “stretching temperature” (hereinafter, also referred to as “horizontal stretching temperature”) is specified by the surface temperature of the film (throughout the specification, in each stretching process other than the horizontal stretching, the stretching temperature is also specified by the surface temperature of the film). The stretching temperature is preferably controlled within a range of (Tg−40° C.) to (Tg+40° C.). That is, the horizontal stretching temperature in the horizontal stretching process is preferably from (Tg−40° C.) to (Tg+40° C.), more preferably from (Tg−20° C.) to (Tg+20° C.), and most preferably from (Tg−10° C.) to (Tg+10° C.). Here, the horizontal stretching temperature in the horizontal stretching process is the average temperature of the temperatures during from the start point of stretching to the end point of the stretching.

The stretching time in the horizontal stretching process is preferably from 1 sec to 10 min, more preferably from 2 sec to 5 min, and most preferably from 5 sec to 3 min. The control of the stretching temperature and the stretching time within the above-mentioned ranges prevents relaxation of a tilting structure in the thickness direction in the film formed in the molten compressing process, highly maintains the tilting structure of the film after stretching, and thus achieve the ratio R[+40°]/R[−40°] in the preferred range of the present invention. The stretching temperature in the horizontal stretching process can be controlled by sending wind at an intended temperature into the tenter.

The magnification of the horizontal stretching is preferably 1.01 to 4 times, more preferably 1.03 to 3.5 times, and most preferably 1.1 to 3.0 times. A magnification of the horizontal stretching of 1.51 to 3.0 times is particularly preferred.

The horizontal stretching may be performed in accordance with a usual horizontal stretching process by widening clips in the lateral direction in a tenter or may be performed by similarly holding a film with clips and widening it in accordance with the following stretching process.

### (Simultaneous Biaxial Stretching)

In this process, clips are widened in the horizontal direction, as in the usual method for horizontal stretching. At the same time, stretching or contraction in the vertical direction is performed. Specifically, Japanese Utility Model Laid-Open No. Sho 55-93520, Japanese Patent Laid-Open Nos. Sho 63-247021, Hei 6-210726, Hei 6-278204, 2000-334832, 2004-106434, 2004-195712, 2006-142595, 2007-210306, and 2005-22087, National Publication of International Patent Application No. 2006-517608, and Japanese Patent Laid-Open No. 2007-210306 describe such methods, which is incorporated by reference.

### (Oblique Stretching)

In this process, right and left clips are widened as in the usual method for horizontal stretching but at different velocities in the horizontal direction such that a film is stretched in an oblique direction. As a result, the film can be preferably stretched in a direction of 30° to 150°, more preferably 40° to 140°, and most preferably 50° to 130° from the MD direction. Specifically, Japanese Patent Laid-Open Nos. 2002-22944, 2002-86554, 2004-325561, 2008-23775, 2008-110573, 2000-9912, 2003-342384, 2004-20701, 2004-258508, 2006-224618, 2006-255892, 2008-221834, and 2003-342384 and International Publication No. WO2003/102639 describe such methods, which is incorporated by reference.

Preheating before such stretching or heat fixation after the stretching can reduce the distributions of Re and Rth and reduce the variation in alignment angle associated with a bowing phenomenon. Though either preheating or heat fixation is available, more preferred is combination thereof. The preheating and the heat fixation are preferably performed while a film is being held with clips. That is, these treatments and stretching are preferably performed sequentially.

The preheating can be performed at a temperature higher than the stretching temperature by about 1° C. to 50° C., preferably 2° C. to 40° C., and more preferably 3° C. to 30° C. The preheating time is preferably from 1 sec to 10 min, more preferably from 5 sec to 4 min, and most preferably from 10 sec to 2 min. In the preheating, the width of the tenter is preferably maintained to be approximately constant. Here, the term “approximately” refers to ±10% of the width of an unstretched film.

The heat fixation can be performed at a temperature lower than the stretching temperature by 1° C. to 50° C., more preferably 2° C. to 40° C., and most preferably 3° C. to 30° C. In particular, the heat fixation temperature is preferably a temperature not higher than the stretching temperature and also not higher than Tg. The heat fixation time is preferably from 1 sec to 10 min, more preferably from 5 sec to 4 min, and most preferably from 10 sec to 2 min. In the heat fixation, the width of the tenter is preferably maintained to be approximately constant. Here, the term “approximately” refers to from 0% (the same width as tenter width after stretching) to −10% (contraction by 10% of the tenter width after stretching: contraction in width) of the tenter width after completion of the stretching. Widening larger than the stretching width tends to cause residual strain in the film and to readily increase the variations in Re and Rth over time.

Such preheating and heat fixation can reduce the variations in alignment angles, Re, and Rth for the following reasons:

(i) The film is stretched in the lateral direction and thereby tends to become thinner in the orthogonal direction (the longitudinal direction) (necking phenomenon). Consequently, tensile stress occurs in the film before and after the horizontal stretching. The both ends in the lateral direction are fixed with clips and are thereby barely deformed by the stress, whereas the central portion in the lateral direction is readily deformed. As a result, the stress due to necking causes arcuate deformation, resulting in the occurrence of bowing. Such a phenomenon leads to variations in the in-plane Re and Rth and a distribution in alignment axis.

(ii) In order to inhibit this phenomenon, preheating (before stretching) is performed at a high temperature, and the heat treatment (after stretching) is performed at a low temperature. As a result, necking readily occurs in the high temperature side (preheating) at a low modulus of elasticity but barely occurs during the heat treatment (after stretching). Consequently, bowing after stretching can be reduced.

Such stretching can further reduce variations in Re and Rth in the lateral direction and the longitudinal direction to 5% or less, more preferably 4% or less, and most preferably 3% or less. In addition, the alignment angle can be controlled to be within 90°±5° or 0°±5°, more preferably within 90°±3° or 0°±3°, and most preferably within 90°±1° or 0°±1°.

High-speed stretching may be performed preferably at 20 m/min or more, more preferably 25 m/min or more, and most preferably 30 m/min or more.

The film that can be used as the optically anisotropic layer contains a thermoplastic resin having positive intrinsic birefringence. The thermoplastic resin is preferably amorphous. Intrinsic birefringence of various resins is described in, for example, MSDS, resin specification tables, and polymer databases, which is incorporated by reference. Even if the intrinsic birefringence value is not described in document, the value can be measured by a prism coupling method. In the present invention, the term “amorphous resin” refers to a resin not showing any crystal melting peak when a film of the resin is subjected to thermal analysis. Any resin satisfying the above-mentioned properties can be used. Examples of the thermoplastic resin include cyclic olefin copolymers, cellulose acylates, polyesters, and polycarbonates. For production of the film by melt extrusion, materials having satisfactory melt extrudability are preferably used. From this viewpoint, cyclic olefin copolymers and cellulose acylates are preferred. Such resins may be contained alone or in combination of two or more thereof. In particular, cellulose acylates and cyclic olefin resins prepared by addition polymerization are preferred.

Examples of the cyclic olefin copolymers include resins prepared by polymerization of norbornene compounds. The resins may be prepared by ring-opening polymerization or addition polymerization.

The addition polymerization and the resins prepared thereby are described in, for example, Japanese Patent Nos. 3517471, 3559360, 3867178, 3871721, 3907908, and 3945598, National Publication of International Patent Application No. 2005-527696, Japanese Patent Laid-Open Nos. 2006-28993 and 2006-11361, and International Publication Nos. WO2006/004376 and WO2006/030797. In particular, those described in Japanese Patent No. 3517471 are most preferred.

The ring-opening polymerization and the resins prepared thereby are described in, for example, International Publication No. WO98/14499, Japanese Patent Nos. 3060532, 3220478, 3273046, 3404027, 3428176, 3687231, 3873934, and 3912159. In particular, those described in International Publication No. WO98/14499 and Japanese Patent No. 3060532 are most preferred.

In particular, cyclic olefins prepared by addition polymerization are more preferred. Commercially available resins can also be used. In particular, “TOPAS #6013” (manufactured by Polyplastics Co., Ltd.) can be used, which barely generates gel during extrusion molding.

Examples of the cellulose acylates include those in which three hydroxy groups in the cellulose structural unit is at least partially replaced with acyl groups. The acyl group (preferably an acyl group having 3 to 22 carbon atoms) may be an aliphatic acyl group or an aromatic acyl group. In particular, cellulose acylates having aliphatic acyl groups are preferred, and the aliphatic acyl group preferably has 3 to 7 carbon atoms, more preferably 3 to 6 carbon atoms, and most preferably 3 to 5 carbon atoms. The cellulose acylate may have different acyl groups in one molecule. Preferable examples of the acyl group include an acetyl group, a propionyl group, a butyryl group, a pentanoyl group, and a hexanoyl group. Among them, more preferred are cellulose acylates having one or more selected from an acetyl group, a propionyl group, and a butyryl group, and more preferred is a cellulose acylate having both of an acetyl group and a propionyl group (CAP). The CAP is preferred from the points of ease in synthesis of a resin and high stability in extrusion molding.

For production of a film by melt extrusion, the cellulose acylate to be used preferably satisfies the following expressions (S-1) and (S-2). A cellulose acylate satisfying the following expressions has a low melting point and improved meltability and therefore shows excellent film-forming properties in melt extrusion.

2.5≦X+Y≦3.0 Expression (S-1):

1.25≦Y≦3.0 Expression (S-2):

In the expressions, X represents the degree of substitution of the hydroxy groups of the cellulose by acetyl groups; and Y represents the sum of the degrees of substitution of the hydroxy groups of the cellulose by acyl groups. The term “degree of substitution” in this specification refers to the total number of the substituted hydrogen atoms of the hydroxy groups at 2-, 3-, and 6-positions of the cellulose structural unit. When the hydrogen atoms of all the hydroxy groups at 2-, 3-, and 6-positions are replaced with acyl groups, the degree of substitution is 3.

A cellulose acylate satisfying the following expressions is more preferred.

2.6≦X+Y≦2.95

2.0≦Y≦2.95

A cellulose acylate satisfying the following expressions is more preferred.

2.7≦X+Y≦2.95

2.3≦Y≦2.9

The cellulose acylates may have any mass-average degree of polymerization and number-average molecular weight. The mass-average degree of polymerization is about 350 to 800, and the number-average molecular weight is about 70000 to 230000. The cellulose acylates can be synthesized with an acid anhydride or chloride as an acylating agent. In the most typical synthesis on an industrial scale, cellulose ester is synthesized by esterification of cellulose prepared from, for example, cotton linter or wood pulp with an organic acid mixture containing organic acids (acetic acid, propionic acid, and butyric acid) corresponding to acetyl group and other acyl groups or acid anhydrides thereof (acetic anhydride, propionic anhydride, and butyric anhydride). The synthetic process of cellulose acylate satisfying the expressions (S-1) and (S-2) is described in JIII journal of technical disclosure (Journal of Technical Disclosure No. 2001-1745, Mar. 15, 2001, Japan Institute of Invention and Innovation) pp. 7-12, Japanese Patent Laid-Open Nos. 2006-45500, 2006-241433, 2007-138141, 2001-188128, 2006-142800, and 2007-98917, which is incorporated by reference.

Examples of the polyesters include polyester resins containing a diol unit having a cyclic acetal skeleton. In particular, a polyester resin containing a dicarboxylic acid unit and a diol unit having 1 to 80% by mol of a cyclic acetal skeleton, which has a low birefringence, is preferably used in the present invention.

The polymer film used for the optically anisotropic layer may contain a material other than the thermoplastic resin. Such a polymer film preferably contains one or more of the above-mentioned thermoplastic resins as the main component (the material of which content is the highest among all materials in the composition, and when two or more of the resins are contained, the total content of the resins is higher than each content of the other materials). In order to enhance the front face contrast characteristics in the case of using the polymer film in a liquid crystal display, it is preferred to use only one thermoplastic resin. The term “using only one” herein means that “using one polymer material serving as a main raw material” and does not exclude embodiments containing at least one of the additives shown below.

Examples of the material other than the thermoplastic resins include various additives. Examples of the additives include stabilizers, UV absorbers, light stabilizers, plasticizers, microparticles, and optical adjusters.

Stabilizer:

The polymer film used for the optically anisotropic layer may contain at least one stabilizer. The stabilizer is preferably added before or during thermal melting of the thermoplastic resin. The stabilizer has various effects, for example, inhibiting oxidation of film-constituting materials, capturing acids generated by decomposition, and inhibiting or restricting decomposition reaction caused by radical species generated by light or heat. The stabilizer is effective for inhibiting deterioration, such as coloring and a reduction in molecular weight, and generation of volatile components caused by various decomposition reaction including unexplained decomposition reactions. The stabilizer is required to function without decomposition even at the melting temperature of the resin for forming a film. Typical examples of the stabilizer include phenolic stabilizers, phosphorous (phosphite) stabilizers, thioether stabilizers, amine stabilizers, epoxy stabilizers, lactone stabilizers, amine stabilizers, and metal deactivators (tin stabilizers). These stabilizers are described in, for example, Japanese Patent Laid-Open Nos. Hei 3-199201, Hei 5-1907073, Hei 5-194789, Hei 5-271471, and Hei 6-107854. In the present invention, at least one of the phenolic and phosphorous stabilizers is preferably used. In particular, a phenolic stabilizer having a molecular weight of 500 or more is preferably used. Preferable examples of the phenolic stabilizer include hindered phenolic stabilizers.

These materials can be readily commercially available from the following manufacturers: Irganox 1076, Irganox 1010, Irganox 3113, Irganox 245, Irganox 1135, Irganox 1330, Irganox 259, Irganox 565, Irganox 1035, Irganox 1098, and Irganox 1425WL available from Ciba Specialty Chemicals Inc.; ADK STAB AO-50, ADK STAB AO-60, ADK STAB AO-20, ADK STAB AO-70, and ADK STAB AO-80 available from ADEKA Corporation; Sumilizer BP-76, Sumilizer BP-101, and Sumilizer GA-80 available from Sumitomo Chemical Company, Limited; and Seenox 326M and Seenox 336B available from Shipro Kasei Kaisha, Ltd.

Phosphorous stabilizers more preferably used are described in paragraphs [0023] to [0039] of Japanese Patent Laid-Open No. 2004-182979. Specific examples of the phosphite stabilizer include the compounds described in Japanese Patent Laid-Open Nos. Sho 51-70316, Hei 10-306175, Sho 57-78431, Sho 54-157159, and Sho 55-13765. Other preferred stabilizers are substances described in detail in JIII journal of technical disclosure (Journal of Technical Disclosure No. 2001-1745, Mar. 15, 2001, Japan Institute of Invention and Innovation) pp. 17-22.

The phosphite stabilizers having high molecular weights are useful for maintaining stability at high temperature. The molecular weight is 500 or more, more preferably 550 or more, and most preferably 600 or more. Furthermore, at least one substituent is an aromatic ester group. The phosphite stabilizer is preferably triesters, and it is desirable not to contain impurities such as phosphoric acid, monoesters, and diesters. If these impurities are contained, the content is preferably 5% by mass or less, more preferably 3% by mass or less, and most preferably 2% by mass or less. Examples of the phosphite stabilizer include the compounds described in paragraphs [0023] to [0039] of Japanese Patent Laid-Open No. 2004-182979 and also the compounds described in Japanese Patent Laid-Open Nos. Sho 51-70316, Hei 10-306175, Sho 57-78431, Sho 54-157159, and Sho 55-13765. Specific examples of the phosphite stabilizer that can be preferably used in the present invention include, but not limited to, the following compounds:

The phosphite stabilizers are commercially available: ADK STAB 1178, ADK STAB 2112, ADK STAB PEP-8, ADK STAB PEP-24G, ADK STAB PEP-36G, and ADK STAB HP-10 are available from ADEKA Corporation; and Sandostab P-EPQ is available from Clariant K.K. Stabilizers having phenol and phosphite in a single molecule are also preferably used. These compounds are described in detail in Japanese Patent Laid-Open No. Hei 10-273494, and examples thereof include, but not limited to, those mentioned in the examples of the above-described stabilizer. Typical examples of the commercially available product include Sumilizer GP available from Sumitomo Chemical Company. In addition, Sumilizer TPL, Sumilizer TPM, Sumilizer TPS, and Sumilizer TDP are available from Sumitomo Chemical Company; and ADK STAB AO-412S is available from ADEKA Corporation.

The stabilizers can be used alone or in combination of two or more thereof, and the amount thereof is appropriately determined within a range that can achieve the object of the present invention. The amount of the stabilizer is preferably 0.001 to 5% by mass, more preferably 0.005 to 3% by mass, and most preferably 0.01 to 0.8% by mass, based on the mass of the thermoplastic resin.

UV Absorber:

The polymer film used for the optically anisotropic layer may contain one or more UV absorbers. The UV absorber preferably has high absorbability for UV light having a wavelength of 380 nm or less from the viewpoint of degradation prevention and has low absorbability for visible light having a wavelength of 400 nm or more from the viewpoint of transparency. Examples of the UV absorber include oxybenzophenone compounds, benzotriazole compounds, salicylate ester compounds, benzophenone compounds, cyanoacrylate compounds, and nickel complex compounds. Particularly preferred UV absorbers are benzotriazole compounds and benzophenone compounds. In particular, preferred are benzotriazole compounds, which can reduce undesirable coloring of cellulose-mixed ester. These UV absorbers are described in Japanese Patent Laid-Open Nos. Sho 60-235852, Hei 3-199201, Hei 5-1907073, Hei 5-194789, Hei 5-271471, Hei 6-107854, Hei 6-118233, Hei 6-148430, Hei 7-11056, Hei 7-11055, Hei 7-11056, Hei 8-29619, Hei 8-239509, and 2000-204173.

The amount of the UV absorber is preferably 0.01 to 2% by mass and more preferably 0.01 to 1.5% by mass based on the amount of the thermoplastic resin.

Light Stabilizer:

The polymer film used for the optically anisotropic layer may contain one or more light stabilizers. Examples of the light stabilizer include hindered amine light stabilizer (HALS) compounds, more specifically, 2,2,6,6-tetraalkylpiperadine compounds and their acid addition salts and complexes with metal compounds as described in columns 5 to 11 of U.S. Pat. No. 4,619,956 and columns 3 to 5 of U.S. Pat. No. 4,839,405. These compounds are commercially available: ADK STAB LA-57, ADK STAB LA-52, ADK STAB LA-67, ADK STAB LA-62, and ADK STAB LA-77 are available from ADEKA Corporation; and TINUVIN 765 and INUVIN 144 are available from Ciba Specialty Chemicals Inc.

These hindered amine light stabilizers can be used alone or in combination of two or more thereof. These hindered amine light stabilizers may be used together with other additives such as plasticizers, stabilizers, and UV absorbers or may be introduced into parts of the molecular structures of such additives. The amount of the stabilizer is determined within a range that can achieve the object of the present invention and is usually about 0.01 to 20 parts by mass, preferably about 0.02 to 15 parts by mass, and most preferably about 0.05 to 10 parts by mass to 100 parts by mass of the thermoplastic resin. The light stabilizer may be added at any stage of preparing a molten thermoplastic resin composition and, for example, may be added at the final stage of the process of preparing the molten composition.

Plasticizer:

The polymer film used for the optically anisotropic layer may contain a plasticizer. The addition of a plasticizer is preferred from the viewpoint of improving the quality of the film, for example, improving the mechanical properties, providing flexibility, providing water-absorption resistance, and reducing moisture permeability. In a case of producing the optical film of the present invention by molten film formation, the plasticizer would be added for decreasing the melting temperature of the film-constituting materials to a temperature lower than the glass transition temperature of the thermoplastic resin used or for decreasing the viscosity of the thermoplastic resin at the heating temperature to a viscosity lower than that of the thermoplastic resin in the absence of the plasticizer. The polymer film preferably contains a plasticizer selected from phosphate ester derivatives and carboxylate ester derivatives, for example. Other preferable examples of the plasticizer include polymers having a weight-average molecular weight of 500 to 10000 prepared by polymerization of an ethylene unsaturated monomer described in Japanese Patent Laid-Open No. 2003-12859, acrylic polymers, acrylic polymers having aromatic rings in the side chains, and acrylic polymers having cyclohexyl groups in the side chains.

Microparticles:

The polymer film used for the optically anisotropic layer may contain microparticles. Usable examples of the microparticles include microparticles of inorganic compounds and microparticles of organic compounds. The average primary particle size of the microparticles contained in the thermoplastic resin in the present invention is preferably 5 nm to 3 μm, more preferably 5 nm to 2.5 μm, and most preferably 10 nm to 2.0 μm from the viewpoint of reducing haze. Here, the average primary particle size of the microparticles is determined by observing the thermoplastic resin with a transmission electron microscope (magnification: 500000 to 1000000) and calculating the average value of the primary particle sizes of 100 particles. The amount of the microparticles is preferably 0.005 to 1.0% by mass, more preferably 0.01 to 0.8% by mass, and most preferably 0.02 to 0.4% by mass based on the amount of the thermoplastic resin.

Optical Adjuster:

The polymer film used for the optically anisotropic layer may contain an optical adjuster. Examples of the optical adjuster include retardation controlling agents such as those described in Japanese Patent Laid-Open Nos. 2001-166144, 2003-344655, 2003-248117, and 2003-66230. The retardation (Re) in the in-plane direction and the retardation (Rth) in the thickness direction can be controlled by containing the optical adjuster. The amount thereof is preferably 0 to 10% by mass, more preferably 0 to 8% by mass, and most preferably 0 to 6% by mass.

### 2. Liquid Crystal Cell

The barrier element of the present invention comprises a liquid crystal cell. The liquid crystal cell may be in any mode. Liquid crystal cells in various modes such as a VA mode, an IPS mode, an OCB mode, a TN mode, or a STN mode can be used. A liquid crystal cell in a TN mode is preferred from its high transmittance, and a liquid crystal cell in a TN mode of, in particular, a normally white mode is preferred from the viewpoint of power saving.

The liquid crystal cell may have any configuration. In general, the liquid crystal cell has a configuration comprising a pair of substrates facing each other, a liquid crystal layer disposed between the substrates, and an electrode disposed in at least one of the substrates to apply a voltage. The liquid crystal cell optionally has an alignment film for controlling the alignment of the liquid crystal layer.

Each substrate constituting the liquid crystal cell may be of any type that can align the liquid crystalline materials constituting the liquid crystal layer in a specific alignment direction. Specifically, for example, a substrate having properties for aligning liquid crystals by the substrate itself or a substrate not having alignment ability but having, for example, an alignment film having properties for aligning liquid crystals can be used.

In the liquid crystal cell included in the barrier element, the Δnd(λ) (d represents the thickness (nm) of the liquid crystal layer, Δn(λ) represents the birefringence of the liquid crystal layer at a wavelength λ, and Δnd(λ) represents the product of Δn(λ) and d) is preferably higher than the Δnd(550) of the liquid crystal cell in each driving mode used in a usual 2D display apparatus, from the viewpoint of transmittance. Specifically, in a liquid crystal cell in a TN mode, the Δnd(550) is preferably, but not limited to, 380 to 540 nm. In order to reduce a change in tint of white portions in a 2D display mode, the Δnd(450)/Δnd(550) of the liquid crystal cell included in the barrier element is preferably 1.20 or less, more preferably 1.10 or less, and most preferably 1.05 or less. The Δnd(450)/Δnd(550) of the liquid crystal cell can be reduced with, for example, a liquid crystal layer of a liquid crystal material having a small ratio Δn(450)/Δn(550). In an embodiment in which the liquid crystal cell comprises a color filter, the Δnd(450)/Δnd(550) of the liquid crystal cell can also be reduced by controlling the thickness of the liquid crystal cell in a region of a color filter (e.g., blue) having the largest transmittance at 450 nm to be smaller than the thickness of the liquid crystal cell in a region of a color filter (e.g., green) having the highest transmittance at 550 nm.

### 3. Polarization Controlling Element

The barrier element of the present invention comprises at least one polarization controlling element. The polarization controlling element may be any of an absorptive polarizer, a reflective polarizer, and an anisotropic scattering polarizer. In an embodiment in which the barrier element of the present invention is disposed in the front of an image display device and the polarization controlling element is disposed at the side of the display face, an absorptive polarizer having a high degree of polarization, such as a linearly polarizing film, is preferably used. In an embodiment in which the barrier element of the present invention is disposed in the back of an image display device and the polarization controlling element is disposed at the side of the backlight, a reflective or anisotropic scattering polarizer having high transmittance, in particular, an enhanced reflective polarizer, is preferably used.

Any absorptive polarizer can be used, and a common linearly polarizing film can be used. For example, any of an iodine polarizing film, a dye polarizing film including a dichroic dye, and a polyene polarizing film can be used. The iodine polarizing film and the dye polarizing film are generally produced through adsorption of iodine or a dichroic dye onto a polyvinyl alcohol film and then stretching of it.

The polarizing film is generally used in the form of a polarizing plate including protective films laminated in both faces of the polarizing film. The present invention also can use a polarizing plate. In such a case, the protective film disposed at the side of the liquid crystal cell is preferably the above-described retardation film. As shown in FIGS. 4 and 6, in an embodiment in which the image display apparatus is a liquid crystal panel and the polarizing film 11 of the liquid crystal panel and the polarizing film 9 of the barrier element of the present invention are laminated, the protective film disposed therebetween is preferably an optically isotropic polymer film having a low Re and a low Rth.

Any reflective polarizer can be used. The enhanced reflective polarizer described in, for example, National Publication of International Patent Application No. Hei 9-506985 is preferred in view of high brightness. The enhanced reflective polarizer is also commercially available as brightness-increasing films, and such commercially available products can be used. Usable examples of the reflective polarizer include anisotropic reflective polarizers. Examples of the anisotropic reflective polarizer include anisotropic multilayer thin films transmitting linearly polarized light in one direction of vibration and reflecting linearly polarized light in another direction of vibration. Examples of the anisotropic multilayer thin film include DBEF manufactured by 3M Corporation (e.g., see Japanese Patent Laid-Open No. Hei 4-268505). An example of the anisotropic reflective polarizer is a composite of a cholesteric liquid crystal layer and a λ/4 plate. Examples of the composite include PCF manufactured by Nitto Denko Corporation (e.g., see Japanese Patent Laid-Open No. Hei 11-231130). An example of the anisotropic reflective polarizer is a grid reflective polarizer. Examples of the reflective grid polarizer include metal grid reflective polarizers prepared by micromachining a metal so as to reflect polarized light even in a visible light region (e.g., see U.S. Pat. No. 6,288,840) and polarizers prepared by adding metal microparticles to a polymer matric and stretching it (e.g., see Japanese Patent Laid-Open No. Hei 8-184701).

Any anisotropic scattering polarizer can be used. The anisotropic scattering polarizer may be commercially available brightness-increasing films. Usable examples of the anisotropic scattering polarizer include DRP manufactured by 3M Corporation (see U.S. Pat. No. 5,825,543). Furthermore, a polarizing element that can polarize light by one pass can be used, and examples thereof include those using smectic C* (e.g., see Japanese Patent Laid-Open No. 2001-201635). Anisotropic diffraction gratings can also be used.

In an embodiment of the image display device in the 3D display apparatus of the present invention being a liquid crystal panel, the image display device also has a pair of polarization controlling elements (in general, a pair of linearly polarizing films). The first polarization controlling element (and the second polarization controlling element, in the embodiment shown in FIG. 1(b)) of the barrier element preferably has a transmittance equivalent to or higher than those of the pair of polarization controlling elements of the image display device. The polarization controlling elements of the barrier element may have a low degree of polarization compared to the image display device (e.g., the contrast ratio, white display/black display, may be about 4), but higher transmittance is required for avoiding a reduction in brightness in a 2D display mode. From this viewpoint, the first polarization controlling element (and the second polarization controlling element, in the embodiment shown in FIG. 1(b)) of the barrier element preferably has a transmittance of 40% to 46%, more preferably 42% to 46%, and most preferably 43% to 45%.

Incidentally, a common linearly polarizing film included in an image display device has a transmittance of about 40% to 43%.

### EXAMPLES

The invention is described in more detail with reference to the following Examples. In the following Examples, the material used, its amount and ratio, the details of the treatment and the treatment process may be suitably modified or changed not overstepping the sprit and the scope of the invention. Accordingly, the invention should not be limitatively interpreted by the Examples mentioned below.

In Examples and Comparative Examples, the value Re(550), the value Rth(550), and the ratio R[+40°]/R[−40°] are measured with an automatic birefractometer, KOBRA-21ADH (manufactured by Oji Keisoku Kiki Co., Ltd.), at a wavelength of 550 nm, unless specifically defined otherwise.

The transmittance of a polarizing film was measured with an ultraviolet spectrophotometer, V-7100 (manufactured by JASCO Corp.).

### (Production of Polymer Film)

### (1) Production of Films 1 to 10, 12, and 13

Cellulose acylate was synthesized in accordance with a method described in Japanese Patent Laid-Open Nos. Hei 10-45804 and Hei 08-231761, and the degree of substitution of the cellulose acylate was measured. Specifically, acylation was performed at 40° C. using sulfuric acid (7.8 parts by mass to 100 parts by mass of cellulose) as a catalyst and carboxylic acid as a source of the acyl substituent. The type of the acyl group and the degree of substitution can be controlled by modifying the type and the amount of the carboxylic acid on this procedure. After the acylation, aging was performed at 40° C. The low molecular weight components of the cellulose acylate were removed by washing with acetone.

### <Preparation of Cellulose Acylate Solutions “C01” to “C04”>

The following composition was placed into a mixing tank and stirred for dissolving each component to prepare a cellulose acylate solution. The amounts of the solvents (methylene chloride and methanol) were appropriately controlled such that each cellulose acylate solution had a solid content of 22% by mass and a viscosity of 60 Pa·s.

Cellulose acetate (the degree of substitution is shown in
the table below): 100.0 parts by mass
Additive shown in the table below: the amount shown in the
table below
Methylene chloride: 365.5 parts by mass
Methanol: 54.6 parts by mass

Other cellulose acylate solutions for layers of low degrees of substitution were prepared as in solution “C01” except that the type of the acyl group and the degree of substitution of the cellulose acylate and the amounts and the types of the additives were changed as shown in the table below. The amounts of the solvents (methylene chloride and methanol) were appropriately controlled such that each cellulose acylate solution had a solid content of 22% by mass.

TABLE 1

| | Cellulose acylate | | Additive A | | Additive B | |
|---|---|---|---|---|---|---|
| | Degree of | Additive amount | | Additive amount | | Additive amount |
| Solution | substitution | (Parts by mass) | Compound | (Parts by mass) | Compound | (Parts by mass) |
| C01 | 2.45 | 100 | A*1 | 19 | — | — |
| C02 | 2.8 | 100 | A*1 | 12 | — | — |
| C03 | 2.8 | 100 | A*1 | 10 | — | — |
| C04 | 2.8 | 100 | A*1 | 10 | B*2 | 2 |

*1: Compound A represents copolymer of terephthalic acid/succinic acid/ethylene glycol/propylene glycol (ratio of copolymer (mol %) = 27.5/22.5/25/25). Compound A is a non-phosphorylated compound and retardation by formula below.
[Chem 4]

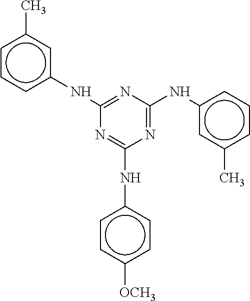

### <Preparation of Cellulose Acylate Film>

A film was produced with at least one of the cellulose acylate solutions through the following mono-casting or co-casting. The stretching temperatures and the draw ratios are shown in the table below.

### Mono-Casting (Production of Films 5 to 10):

Each of the cellulose acylate solutions shown in the table below was flow-cast into a thickness of 60 μm with a band stretching machine. Subsequently, the resulting web (film) was detached from the band, was held with clips, and was laterally stretched with a tenter. The stretching temperature and the draw ratios are shown in the table below. The clips were removed from the film, and the film was dried at 130° C. for 20 min.

### Co-Casting (Production of Films 1 to 4, 12, and 13):

The cellulose acylate solution C01 and the cellulose acylate solution C02 were respectively flow-cast with a band stretching machine to form a core layer with a thickness of 56 μm and a skin A layer with a thickness of 2 μm. Subsequently, the clips were removed, followed by drying at 130° C. for 20 min. The resulting web (film) was detached from the band, was held with clips, and was laterally stretched with a tenter. The stretching temperature and the draw ratio are shown in the table below.

The constitution of the resulting film, the stretching conditions, and characteristics of the film are shown in the table below.

TABLE 2

| | Structure of | | Structure of | | Stretching | | | | |
|---|---|---|---|---|---|---|---|---|---|
| | core layer | | skin layer A | | conditions | | Structure of film | | |
| | | Thickness | | Thickness | Temperature | | Thickness | Re(550) | Rth(550) |
| Sample No. | Solution | (μm) | Solution | (μm) | (° C.) | Ratio | (μm) | (nm)*1 | (nm) |
| Film 1 | C01 | 56 | C02 | 2 | 172 | 30% | 60 | 50 | 120 |
| Film 2 | C01 | 76 | C02 | 2 | — | 0% | 80 | 0 | 150 |
| Film 3 | C01 | 66 | C02 | 2 | 172 | 40% | 70 | 80 | 140 |
| Film 4 | C01 | 61 | C02 | 2 | — | 0% | 65 | 0 | 60 |
| Film 5 | C03 | 76 | — | — | 130 | 12% | 76 | −10 | 80 |
| Film 6 | C04 | 60 | — | — | 130 | 15% | 60 | 20 | 120 |
| Film 7 | C03 | 95 | — | — | 130 | 12% | 95 | 10 | 100 |
| Film 8 | C04 | 68 | — | — | 130 | 8% | 68 | 10 | 135 |
| Film 9 | C04 | 75 | — | — | 130 | 8% | 75 | 10 | 150 |
| Film 10 | C04 | 60 | — | — | 130 | 15% | 60 | 20 | 120 |
| Film 12 | C01 | 81 | C02 | 2 | 172 | 32% | 85 | 80 | 180 |
| Film 13 | C01 | 104 | C02 | 2 | 172 | 30% | 108 | 100 | 230 |

*1Positive and negative of Re is determined disposed in the film equiped with a display device (mainly relationship with transmission axis of adjacent polarizing film: Positive is parallel direction to the transmission axis, negative is orthogonal direction to the transmission axis.).

### (2) Production of Film 11

A commercially available norbornene polymer film, “ZEONOR ZF14” (manufactured by Optes Inc.), was stretched by fixed-end uniaxial stretching to produce film 11.

### (3) Preparation of Film 14

A commercially available cellulose acylate film, trade name “FUJITAC TD80UL” (manufactured by Fuji Film Co., Ltd.), was used as film 14.

### (4) Production of Film 15

A cellulose acylate was prepared with the acyl group and the degree of substitution shown in the table below. This was subjected to acylation at 40° C. using sulfuric acid (7.8 parts by mass to 100 parts by mass of cellulose) as a catalyst and carboxylic acid as a source of the acyl substituent. The type of the acyl group and the degree of substitution were controlled by changing the type and the amount of the carboxylic acid in the reaction. After the acylation, aging was performed at 40° C. The low molecular weight components of the cellulose acylate were removed by washing with acetone. In the table, Ac denotes acetyl group, and CTA denotes cellulose triacetate (cellulose ester derivative in which the acyl group is acetate group only).

### <Cellulose Acylate Solution>

The following composition was placed into a mixing tank and stirred for dissolving each component and was heated at 90° C. for about 10 min, followed by filtration with a filter of an average pore diameter of 34 μm and a sintered metal filter of an average pore diameter of 10 μm.

Cellulose acylate solution

CTA shown in the table below: 100.0 parts by mass
Triphenyl phosphate (TPP): 7.8 parts by mass
Biphenyl diphenyl phosphate (BDP): 3.9 parts by mass
Methylene chloride: 403.0 parts by mass
Methanol: 60.2 parts by mass

### <Matting Agent Dispersion>

The following composition containing the cellulose acylate solution prepared above was placed into a disperser to prepare a matting agent dispersion.

Matting agent dispersion

Silica particles having an average particle diameter of 16
nm (Aerosil R972 manufactured by Nippon Aerosil Co., Ltd.): 2.0
parts by mass
Methylene chloride: 72.4 parts by mass
Methanol: 10.8 parts by mass
Cellulose acylate solution: 10.3 parts by mass

### <Additive Solution>

The following composition containing the cellulose acylate solution prepared above was placed into a mixing tank and was heated with stirring for dissolving each component to prepare an additive solution.

Additive solution

Retardation-expressing agent (1): 20.0 parts by mass
Methylene chloride: 58.3 parts by mass
Methanol: 8.7 parts by mass
Cellulose acylate solution: 12.8 parts by mass

A dope for film formation was prepared by mixing 100 parts by mass of the cellulose acylate solution, 1.35 parts by mass of the matting agent dispersion, and a predetermined amount of additive solution such that the amount of the retardation-expressing agent (1) in a cellulose acylate film was 10 parts by mass. The proportion of the additive is shown in terms of parts by mass relative to 100 parts by mass of cellulose acylate.

Here, abbreviations in the table and the above-mentioned additive and plasticizer are as follows:

CTA: cellulose triacetate
TPP: triphenyl phosphate
BDP: biphenyl diphenyl phosphate

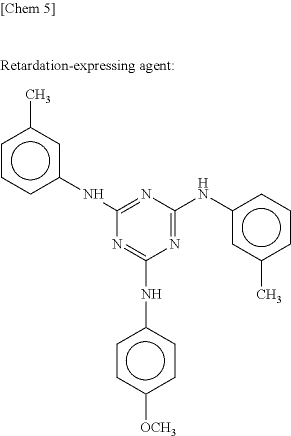

The dope was cast with a band casting machine. The film having a residual solvent content shown in the table below was detached from the band and was stretched in the longitudinal direction at a draw ratio shown in the table below in the path from the detaching position to the tenter. Subsequently, the film was stretched in the lateral direction at a draw ratio shown in the table below using the tenter. Immediately after the horizontal stretching, the film was contracted (relaxed) in the lateral direction at a percentage shown in the table below. The film was then released from the tenter to obtain a cellulose acylate film. The residual solvent content in the film released from the tenter is shown in the table below. Both ends of the film were cut out anterior to the winding section, and the film was wound into a roll film having a width of 2000 mm and a length 4000 m. The draw ratios are shown in the following table.

TABLE 3

| Cellulose acylate film | | |
|---|---|---|
| Web | Sort of web | CTA |
| | Total degree of substitution | 2.81 |
| | Substitutional rate of 6 position | 0.320 |
| | Degree of substitution of 6 position | 0.9 |
| | Substituent | Ac |
| Additive | Sort of additive | Retardation |
| | | expressing |
| | | agent (1) |
| | Additive amount (Parts by mass with | 6.4 |
| | respect to the web 100 parts by mass) | |
| Plasticizer | Sort of plasticizer | TPP/BDP |
| | Plasticizer amount (Parts by mass with | 7.8/3.9 |
| | respect to the web 100 parts by mass) | |
| Stretching | Ratio of vertical stretching [%] | 3 |
| conditions | Ratio of horizontal stretching [%] | 38 |
| | Relaxation ratio [%] | 7 |
| | Rate of stretching [% min] | 35 |
| | Temperature of film surface [° C.] | 120 |
| | Amount of residual solvent of peel off [%] | 50 |
| | Amount of residual solvent of stretching | 10 |
| | termination [%] | |

### (5) Production of Film 16

A cellulose acylate film was produced as in film 15 except that the cellulose acylate shown in the table below was used, the amount of the retardation-expressing agent (1) was changed to that shown in the table below, and the stretching was performed under different conditions. The resulting film was used as film 16. The abbreviations of the additive and the plasticizer below are defined as above.

TABLE 4

| Cellulose acylate film | | |
|---|---|---|
| Web | Sort of web | CTA |
| | Total degree of substitution | 2.81 |
| | Substitutional rate of 6 position | 0.320 |
| | Degree of substitution of 6 position | 0.9 |
| | Substituent | Ac |
| Additive | Sort of additive | Retardation |
| | | expressing |
| | | agent (1) |
| | Additive amount (Parts by mass with | 2.2 |
| | respect to the web 100 parts by mass) | |
| Plasticizer | Sort of plasticizer | TPP/BDP |
| | Plasticizer amount (Parts by mass with | 7.8/3.9 |
| | respect to the web 100 parts by mass) | |
| Stretching | Ratio of vertical stretching [%] | 6 |
| conditions | Ratio of horizontal stretching [%] | 48 |
| | Relaxation ratio [%] | 7 |
| | Rate of stretching [% min] | 35 |
| | Temperature of film surface [° C.] | 120 |
| | Amount of residual solvent of peel off [%] | 55 |
| | Amount of residual solvent of stretching | 12 |
| | termination [%] | |

### (6) Production of Film 17

### <Cellulose Acylate Solution for Low-Degree Substitution Layer>

The following composition was placed into a mixing tank and was heated with stirring for dissolving each component to prepare a cellulose acylate solution for a low-degree substitution layer.

Cellulose acylate solution

Cellulose acetate with a degree of substitution of 2.43: 100
parts by mass
Retardation-expressing agent (2): 18.5 parts by mass
Methylene chloride: 365.5 parts by mass
Methanol: 54.6 parts by mass

The composition of the retardation-expressing agent (2) is shown in Table 5. In Table 5, EG denotes ethylene glycol, PG denotes propylene glycol, BG denotes butylene glycol, TPA denotes terephthalic acid, PA denotes phthalic acid, AA denotes adipic acid, and SA denotes succinic acid. The retardation-expressing agent (2) is a non-phosphate ester compound and also a retardation-expressing agent. A terminal of the retardation-expressing agent (2) is capped with an acetyl group.

TABLE 5

| | Glycol unit | | | | Dicarboxilic acid unit | | | |
|---|---|---|---|---|---|---|---|---|
| | Capped ratio of | | | Average | | | Average | |
| Retardation | terminally-hydroxyl | EG | PG | number of | TPA | SA | number of | Molecular |
| expressing agent | groups (%) | (%) | (%) | carbon atoms | (mol %) | (mol %) | carbon atoms | weight |
| (2) | 100 | 50 | 50 | 2.5 | 55 | 45 | 6.2 | 730 |

### <Cellulose Acylate Solution for High-Degree Substitution Layer>

The following composition was placed into a mixing tank and was stirred for dissolving each component to prepare a cellulose acylate solution for a high-degree substitution layer.

Cellulose acylate solution

Cellulose acetate with a degree of substitution of 2.79: 100
parts by mass
Retardation-expressing agent (2): 11.0 parts by mass
Silica particles having an average particle diameter of 16
nm (Aerosil R972 manufactured by Nippon Aerosil Co., Ltd.): 0.15
parts by mass
Methylene chloride: 395.0 parts by mass
Methanol: 59.0 parts by mass

### (Production of Cellulose Acylate Sample)

The cellulose acylate solution for a low-degree substitution layer was flow-cast to form a core layer having a thickness of 70 μm, and the cellulose acylate solution for a high-degree substitution layer was flow-cast to form a skin A layer and a skin B layer each having a thickness of 2 μm. The resulting film was detached from the band, was held with clips, and was laterally stretched with a tenter by 41% in the lateral direction at a stretching temperature of 180° C. at a state that the residual solvent content was 20% to the total mass of the film. Subsequently, the clips were removed from the film, followed by drying at 130° C. for 20 min to prepare film 17.

### (7) Production of Film 18

Film 18 was produced as in the production of film 17 except that the thickness of the core layer at the casting was 65 μm and that the stretching was performed at a stretching temperature of 200° C. at a draw ratio of 60%.

### (8) Production of Film 19

### (Cellulose Acylate Solution for Low-Degree Substitution Layer)

The following composition was placed into a mixing tank and was heated with stirring for dissolving each component to prepare a cellulose acylate solution for a low-degree substitution layer.

Cellulose acylate solution

Cellulose acetate with a degree of substitution of 2.43: 100
parts by mass
Retardation-expressing agent (2): 17.0 parts by mass
Methylene chloride: 361.8 parts by mass
Methanol: 54.1 parts by mass

### <Cellulose Acylate Solution for High-Degree Substitution Layer>

The following composition was placed into a mixing tank and was stirred for dissolving each component to prepare a cellulose acylate solution for a high-degree substitution layer.

Cellulose acylate solution

Cellulose acetate with a degree of substitution of 2.79:
100.0 parts by mass
Retardation-expressing agent (2): 11.0 parts by mass
Silica particles having an average particle diameter of 16
nm (Aerosil R972 manufactured by Nippon Aerosil Co., Ltd.): 0.15
parts by mass
Methylene chloride: 395.0 parts by mass
Methanol: 59.0 parts by mass

### <Production of Cellulose Acylate Sample>

The cellulose acylate solution for a low-degree substitution layer was flow-cast to form a core layer having a thickness of 76 μm, and the cellulose acylate solution for a high-degree substitution layer was flow-cast to form a skin A layer and a skin B layer each having a thickness of 2 μm. The resulting film was detached from the band, was held with clips, and was subjected to tenter conveying at 170° C. at a state that the residual solvent content was 20% to the total mass of the film. Subsequently, the clips were removed from the film. The film was dried at 130° C. for 20 min and was then stretched by 23% in the lateral direction at stretching temperature of 180° C. and further laterally stretched using the tenter to prepare film 19.

### (9) Production of Film 20

### <Production of Film 20A>

Film 20A was produced as in the production of film 18 except that the thickness of the core layer was 18 μm instead of 65 μm and that the draw ratio in the lateral direction was 62% instead of 60%. Film 20A had a thickness of 22 μm, an Re(550) of 30 nm, and an Rth(550) of 25 nm.

### <Production of Film 20B>

A cellulose acylate solution (dope) having the following composition was prepared.

Methylene chloride: 435 parts by mass
Methanol: 65 parts by mass
Cellulose acylate benzoate (CBZ): 100 parts by mass (degree
of substitution with acetyl: 2.45, degree of substitution with
benzoyl: 0.55, mass-average molecular weight: 180000)
Silicon dioxide microparticles (average particle diameter:
20 nm, Mohs hardness: about 7): 0.25 parts by mass

The resulting dope was flow-cast on a film-forming band, followed by drying at room temperature for 1 min and then at 45° C. for 5 min. The residual solvent content after the drying was 30% by mass. The cellulose acylate film was detached from the band and was dried at 100° C. for 10 min and then at 130° C. for 20 min to give film 20B. The residual solvent content was 0.1% by mass. Film 20B had a thickness of 29 μm, an Re(550) of 0 nm, and an Rth(550) of −43 nm.

### <Production of Film 20>

Film 20A and film 20B were laminated with an adhesive to produce film 20. Film 20 had a thickness of 61 μm, an Re(550) of 30 nm, and an Rth(550) of −17 nm.

### (10) Production of Film 30

### <Preparation of Dope>

The following composition was placed into a mixing tank and was stirred for dissolving each component and was further heated at 90° C. for about 10 min, followed by filtration with a filter of an average pore diameter of 34 μm and a sintered metal filter of an average pore diameter of 10 μm. Ac and Pr mentioned below denote acetyl group and propionyl group, respectively.

Cellulose acylate solution

Cellulose acylate having a degree of substitution with Ac of

1.6 and a degree of substitution with Pr of 0.9: 100.0 parts by
mass

Sugar ester (1): 8.0 parts by mass
Polyester (1): 1.5 parts by mass
Methylene chloide: 403.0 parts by mass
Methanol: 60.2 parts by mass

[Chem. 6]
Sugar ester (1): 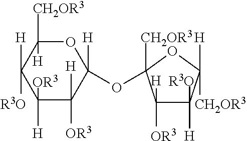 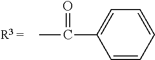
[Chem. 7]
Polyester (1):

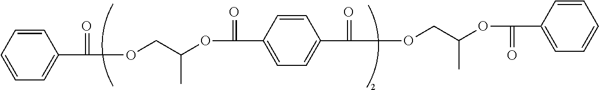

### <Matting Agent Dispersion>

The following composition containing a cellulose acylate solution prepared by the above-described process was placed into a disperser to prepare a matting agent dispersion.

Matting agent dispersion

Matting agent (Aerosil R972): 0.2 parts by mass
Methylene chloride: 72.4 parts by mass
Methanol: 10.8 parts by mass
Cellulose acylate solution: 10.3 parts by mass

### (Production of Cellulose Acylate Sample)

The matting agent dispersion was mixed with 100 parts by mass of the cellulose acylate solution such that the amount of the inorganic microparticles was 0.02 parts by mass to the amount of the cellulose acylate resin to prepare a dope for film formation. The dope for film formation was flow-cast with a band casting machine. The band was made of stainless steel.

The web (film) prepared by flow casting was dried at 158° C. on the band with a drying apparatus for 20 min before detachment. In another embodiment, the web was detached from the band and was clips at both ends and dried for 20 min in a tenter apparatus for conveying the web. The results of these two embodiments were substantially the same. The drying temperature herein means the surface temperature of a film.

The resulting web (film) was detached from the band, was held with clips, and was stretched under fixed-end uniaxial stretching conditions at a state that the residual solvent content was 30% to 5% to the total mass of the film by 30% in the lateral direction, the direction (horizontal direction) orthogonal to the film-conveying direction, at a stretching temperature of 165° C. using a tenter. Subsequently, the clips were removed from the film, followed by drying at 110° C. for 30 min to prepare film 30.

### (11) Production of Film 31

### <Preparation of Dope>

The cellulose acylate solutions shown below were produced as dopes for inner layer and outer layers A and B.

Composition of cellulose acylate solution for inner layer

Cellulose acylate having an average degree of substitution

of 2.86: 100.0 parts by mass

Methylene chloride (first solvent): 71.9 parts by mass
Methanol (second solvent): 71.9 parts by mass
Butanol (third solvent): 3.6 parts by mass
Oligomer (composition shown below): 7.0 parts by mass
UV absorber mixture (composition shown below): 3.5 parts by

mass
*Oligomer: terephthalic acid/adipic acid/ethylene glycol/propylene glycol copolymer
Co-polymerization ratio: 1/1/1/1
Number-average molecular weight: 1200
*UV absorber mixture: compound 16/compound 17/compound 18 each shown below
Mixing ratio: 2/2/1
[Chem. 8]
Compound 16: 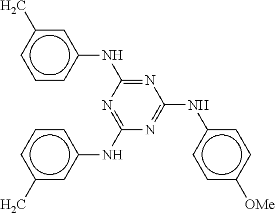
[Chem. 9]
Compound 17: 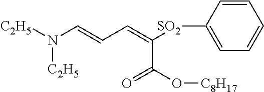
[Chem. 10]
Compound 18:

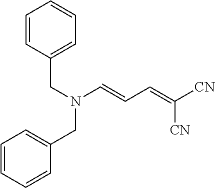 [SMILES: N#CC(C#N)=C/C=C/N(Cc1ccccc1)Cc1ccccc1]

Composition of cellulose acylate solution for outer layers A and B

Cellulose acylate having an average degree of substitution
of 2.86: 100.0 parts by mass
Methylene chloride (first solvent): 335.0 parts by mass
Methanol (second solvent): 84.8 parts by mass
Butanol (third solvent): 4.2 parts by mass
Silica particles having an average particle size of 16 nm
(Aerosil R972, manufactured by Nippon Aerosil Co., Ltd.): 0.1
parts by mass
Oligomer (composition shown above): 4.0 parts by mass
UV absorber mixture (composition shown above): 2.0 parts by mass

Each of the cellulose acylate solutions shown above was placed into a mixing tank and was stirred for dissolving each component, followed by filtration with a filter of an average pore diameter of 34 μm and a sintered metal filter of an average pore diameter of 10 μm to prepare each cellulose acylate dope.

### <Solution Co-Casting>

The prepared dopes were co-cast onto a mirror-surface stainless steel support, which is a drum having a diameter of 3 m, through a casting geeser such that the inner layer had a thickness of 75 μm, the outer layer A had a thickness of 2.5 μm, and the outer layer B has a thickness of 2.5 dun. The sum of the thicknesses of the inner layer and the outer layers A and B at each lateral position was controlled by adjusting the clearance at the outlet of the casting geeser. The thicknesses of the outer layers A and B at each lateral position were controlled by adjusting the flow rates of the outer layer dopes, the widths of the passages at the confluent position with the inner layer in the casting geeser, and the clearance in the direction positions.

Subsequently, the sheet formed on the drum by co-casting of the dopes was detached at a PIT draw of 103%, held with a pin tenter, and conveyed in a drying zone. When a solid content of 77% and a film surface temperature of 48° C. were achieved, the sheet was stretched in the direction orthogonal to the conveying direction at a draw ratio of 110%.

The sheet being held with the pin tenter was further conveyed in the drying zone and was released from the pin tenter when the solid content reached 97% or more. The sheet was dried with the drying air of 140° C. to achieve a solid content of 99% or more and was wound to prepare film 31.

### (12) Production of Film 32

Film 32 was produced as in film 31 except that the thickness of the inner layer was changed to 50 μm from 75 μm in film 31.

### (13) Production of Film 33

### <Production of Cellulose Acylate Film>

The following composition was placed into a mixing tank and was heated to 30° C. with stirring for dissolving each component to prepare a cellulose acetate solution.

| Cellulose acetate solution composition | | |
|---|---|---|
| (parts by mass) | Inner layer | Outer layer |
| Cellulose acetate having a degree of | 100 | 100 |
| acetylation of 60.9% | | |
| Triphenyl phosphate (plasticizer) | 7.8 | 7.8 |
| Biphenyl diphenyl phosphate | 3.9 | 3.9 |
| (plasticizer) | | |
| Methylene chloride (first solvent) | 293 | 314 |
| Methanol (second solvent) | 71 | 76 |
| 1-Butanol (third solvent) | 1.5 | 1.6 |
| Silica miroparticles (Aerosil R972, | 0 | 0.8 |
| manufactured by Nippon Aerosil Co., | | |
| Ltd.) | | |
| Retardation increasing agent (A) shown | 1.7 | 0 |
| below | | |

[Chem. 11]

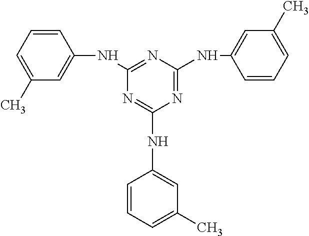 [SMILES: Cc1cccc(Nc2nc(Nc3cccc(C)c3)nc(Nc3cccc(C)c3)n2)c1]

The resulting dopes for inner layer and outer layers were cast onto a drum cooled to 0° C. using a three-layer co-casting die. The sheet was detached from the drum when the residual solvent content became 70% by mass and was held with a pin tenter at both ends. The sheet was dried at 80° C. while being conveyed at a draw ratio of 110% in the conveying direction and was then dried at 110° C. after the residual solvent content became 10%. Subsequently, the sheet was dried at 140° C. for 30 min to produce film 33 (thickness: 80 μm (outer layer: 3 μm, inner layer: 74 μm, outer layer: 3 μm)) having 0.3% by mass of the residual solvent.

### (14) Production of Film 34

A commercially available norbornene polymer film, “ZEONOR ZF14-100” (manufactured by Optes Inc.), was fixed-end biaxial stretched at 153° C. by 1.5 times in the MD direction and 1.5 times in the TD direction, and the surface was then subjected to corona discharge treatment. Two sheets of this film were laminated with an acrylic adhesive to give film 34 having a thickness of 90 μm.

### (15) Production of Film 42

### <<Preparation of Cellulose Acylate>>

A cellulose acylate having a total degree of substitution of 2.97 (total of a degree of substitution with acetyl of 0.45 and a degree of substitution with propionyl of 2.52). A mixture of sulfuric acid (7.8 parts by mass to 100 parts by mass of cellulose) as a catalyst and a carboxylic anhydride was cooled to −20° C. and was then added to cellulose derived from pulp, followed by acylation at 40° C. In the reaction, the type of the acyl group and its degree of substitution were controlled by controlling the type and amount of the carboxylic anhydride. After the acylation, aging was performed at 40° C. to adjust the total degree of substitution.

### <<Preparation of Cellulose Acylate Solution>>

### 1) Cellulose Acylate

The prepared cellulose acylate was dried by heating at 120° C. into a moisture content of 0.5% by mass or less, and 30 parts by mass of dry product was mixed with a solvent.

### 2) Solvent

The solvent used was a mixture of dichloromethane/methanol/butanol (81/15/4 (parts by mass)). The moisture contents of these solvents were each 0.2% by mass or less.

### 3) Additive

Each prepared solution contained 0.9 parts by mass of trimethylol propane triacetate, 0.2 parts by mass of the retardation increasing agent (A), and 0.25 parts by mass of silicon dioxide microparticles (particle diameter: 20 nm, Mohs hardness: about 7).

### 4) Swelling and Dissolution

The solvent and additives were placed into a 400-L stainless steel dissolution tank equipped with an agitator blade and cooled by circumferential cooling water, and the cellulose acylate was gradually added thereto with stirring to prepare a dispersion. After completion of the discharge, the dispersion was stirred at room temperature for 2 hours, swelled for 3 hours, and stirred again to give a cellulose acylate solution.

The stirring was performed with a dissolver agitator having an eccentric shaft at a circumferential velocity of 15 m/sec (shear stress: 5×10⁴ kgf/m/sec²) and an agitator having a central shaft provided with an anchor blade at a circumferential velocity of 1 m/sec (shear stress: 1×10⁴ kgf/m/sec²). The swelling was performed by stopping the high-speed agitator and stirring with the agitator having the anchor blade at a circumferential velocity of 0.5 m/sec.

### 5) Filtration

The resulting cellulose acylate solution was filtered through a filter (#63, manufactured by Toyo Roshi Co., Ltd.) having an absolute filtration precision of 0.01 mm and then with a filter (FH025, manufactured by Pall Ltd.) having an absolute filtration precision of 2.5 μm to give a cellulose acylate solution.

The cellulose acylate solution was warmed to 30° C. and was flow-cast through a casting die (described in Japanese Patent Laid-Open No. Hei 11-314233) onto a mirror surface stainless steel support (a band length of 60 m, a temperature of 15° C.) at a casting rate of 15 m/min and a coating width of 200 cm. The space temperature of the entire flow casting portion was set to 15° C. The cast cellulose acylate film rotatably conveyed was detached from the band at a position of 50 cm short of the flow casting site and was fed with drying wind at 45° C. The film was further dried at 110° C. for 5 min and then at 140° C. for 10 min to give a cellulose acylate film 42 (thickness: 53 μm).

### (16) Production of Film 43

A commercially available cellulose acylate film, trade name “Z-TAC” (manufactured by Fuji Film Co., Ltd.), was used as film 43.

The thicknesses and the values of Re(550) and Rth(550) of produced films 1 to 20, 30 to 34, 42, and 43 are summarized in the following table.

TABLE 6

| | Thickness | Re(550)*1 | Rth(550) |
|---|---|---|---|
| | (μm) | (nm) | (nm) |
| Film 1 | 60 | 50 | 120 |
| Film 2 | 80 | 0 | 150 |
| Film 3 | 70 | 80 | 140 |
| Film 4 | 65 | 0 | 60 |
| Film 5 | 76 | −10 | 80 |
| Film 6 | 60 | 20 | 120 |
| Film 7 | 95 | 10 | 100 |
| Film 8 | 68 | 10 | 135 |
| Film 9 | 75 | 10 | 150 |
| Film 10 | 60 | 20 | 120 |
| Film 11 | 55 | 50 | 120 |
| Film 12 | 85 | 80 | 180 |
| Film 13 | 108 | 100 | 230 |
| Film 14 | 80 | −3 | 40 |
| Film 15 | 36 | 30 | 90 |
| Film 16 | 92 | 100 | 190 |
| Film 17 | 74 | 100 | 150 |
| Film 18 | 69 | 100 | 110 |
| Film 19 | 80 | −40 | 150 |
| Film 20 | 61 | 30 | −17 |
| Film 30 | 42 | 50 | 120 |
| Film 31 | 80 | 10 | 135 |
| Film 32 | 55 | −6 | 90 |
| Film 33 | 80 | −6 | 90 |
| Film 34 | 90 | −6 | 90 |
| Film 42 | 53 | −5 | −15 |
| Film 43 | 80 | −2 | −5 |

*1Positive and negative of Re is determined disposed in the film equiped with a display device (mainly relationship with transmission axis of adjacent polarizing film: Positive is parallel direction to the transmission axis, negative is orthogonal direction to the transmission axis.).

The values of Rth of the films at wavelengths of 450 nm and 550 nm shown in the following table were measured to determine the ratios Rth(450)/Rth(550).

TABLE 7

| | Rth (450)/Rth (550) | Wavelength dispersion |
|---|---|---|
| Film 31 | 1.17 | Forward wavelength dispersion |
| Film 32 | 1.17 | Forward wavelength dispersion |
| Film 33 | 0.94 | Reverse wavelength dispersion |
| Film 34 | 1.00 | Flat wavelength dispersion |
| | | (Identification regardless of wavelength) |

### (17) Production of Film 21

### <Production of Alignment Film>

The produced film 5 was saponified, and a coating solution having the following composition was applied to the saponified surface with a wire bar coater #16 into a density of 28 mL/m², followed by drying with warm wind at 60° C. for 60 sec and then warm wind at 90° C. for 150 sec. The surface of the formed film was subjected to rubbing treatment with a rubbing roller rolling at 500 rpm along the conveying direction to form an alignment film.

(Alignment film coating solution composition)

Modified polyvinyl alcohol shown below: 20 parts by mass
Water: 360 parts by mass
Methanol: 120 parts by mass
Glutaraldehyde (cross-linking agent): 1.0 parts by mass
[Chem. 12]
Modified polyvinyl alcohol:

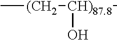

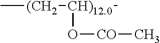

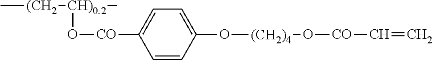

### <Production of Optically Anisotropic Layer>

A coating solution having the following composition was prepared.

The coating solution was prepared by dissolving the following composition in 98 parts by mass of methyl ethyl ketone.

Discostic liquid crystalline compound (1) shown below: 41.01

parts by mass

Ethylene oxide modified trimethylol propane triacrylate

(V#360, manufactured by Osaka Organic Chemical Industry Ltd.): 4.06
parts by mass

Cellulose acetate butylate (CAB551-0.2, manufactured by

Eastman Chemical Company): 0.34 parts by mass

Cellulose acetate butylate (CAB531-1, manufactured by

Eastman Chemical Company): 0.11 parts by mass

Polymer containing fluoroaliphatic groups 1 shown below:

0.13 parts by mass

Polymer containing fluoroaliphatic groups 2 shown below:

0.03 parts by mass

Photopolymerization initiator (Irgacure 907, manufactured by

Ciba-Geigy Co.): 1.35 parts by mass

Sensitizer (Kayacure DETX, manufactured by Nippon Kayaku

Co., Ltd.): 0.45 parts by mass
[Chem. 13]
Discotic liquid crystalline compound (1): 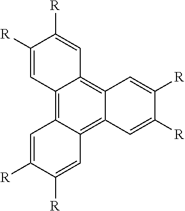 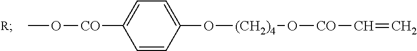
[Chem. 14]
Polymer containing fluoroaliphatic groups 1: (a/b/c = 20/20/60 wt %) 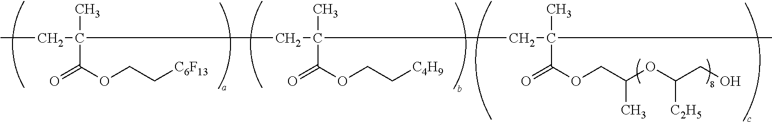
[Chem. 15]
Polymer containing fluoroaliphatic groups 2: (a/b = 98/2 wt %)

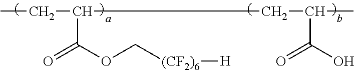

The coating solution was continuously applied, with a wire bar #3.2, onto the alignment surface of the roll film being conveyed at 30 m/min. The solvent was evaporated in the process of continuously heating from room temperature to 100° C. Then, the discotic liquid crystalline compound was aligned by heating the layer for about 90 sec in a drying zone at 135° C. and a wind velocity of 1.5 m/sec in parallel to the film conveying direction at the surface of the discotic liquid crystalline compound film. Subsequently, the film was conveyed to a drying zone at 80° C. and was irradiated with UV light of an illuminance of 600 mW for 4 sec at a surface temperature of about 100° C. using an ultraviolet irradiation apparatus (UV lamp: output: 160 W/cm, emission light wavelength: 1.6 m) to fix the discotic liquid crystalline compound in its alignment state by cross-linking. Subsequently, the film was cooled to room temperature and was wound into a cylindrical form.

Film 21 having optical anisotropy was thereby produced on a support.

### (18) Production of Film 22

Film 22 was produced as in film 21 except that film 6 was used instead of film 5 as the support and that the optically anisotropic layer was formed by the following method.

### <Production of Alignment Film>

Film 6 was saponified, and a coating solution having the following composition was applied to the saponified surface into a density of 28 mL/m² with a wire bar coater #16, followed by drying with warm wind at 60° C. for 60 sec and then warm wind at 90° C. for 150 sec. The formed film surface was subjected to rubbing treatment with a rubbing roller rolling at 500 rpm along the conveying direction to form an alignment film.

Alignment film coating solution composition

Modified polyvinyl alcohol shown below: 20 parts by mass
Water: 360 parts by mass
Methanol: 120 parts by mass
Glutaraldehyde (cross-linking agent): 1.0 parts by mass
[Chem. 16]
Modified polyvinyl alcohol:

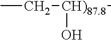

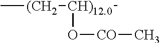

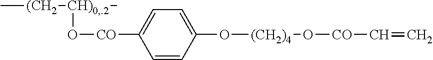

### <Production of Optically Anisotropic Layer>

The coating solution B having the following composition containing a discotic liquid crystalline compound was continuously applied onto the alignment film with a wire bar #2.7. The conveying velocity (V) of the film was 36 m/min. The film was heated with hot wind at 120° C. for 90 sec for evaporating the solvent of the coating solution and aging the alignment of the discotic liquid crystalline compound. Subsequently, the alignment of the liquid crystalline compound was fixed by irradiation with UV light at 80° C. to form an optically anisotropic layer. Film 22 having optical anisotropy was thereby produced on a support.

Composition of coating solution (B) for optically
anisotropic layer

Discotic liquid crystalline compound shown below: 100 parts

by mass

Photopolymerization initiator (Irgacure 907, manufactured by

Ciba-Geigy Co.): 3 parts by mass

Sensitizer (Kayacure DETX, manufactured by Nippon Kayaku

Co., Ltd.): 1 part by mass

Pyridinium salt shown below: 1 part by mass
Fluorine polymer (FP2) shown below: 0.4 parts by mass
Methyl ethyl ketone: 252 parts by mass

[Chem. 17]
Discotic liquid crystalline compound: 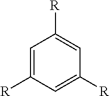 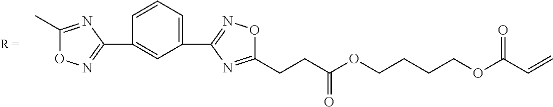 [SMILES: C=CC(=O)OCCCCOC(=O)CCc1nc(-c2cccc(-c3noc(C)n3)c2)no1]
[Chem. 18]
Pyridinium salt: 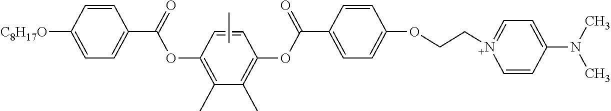 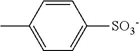
[Chem. 19]
Fluorine polymer (FP2):

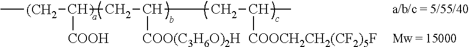

### (19) Production of Film 23

Film 23 was produced as in film 21 except that film 7 was used as the support instead of film 5 and that the thickness during the coating was 0.7 times that of film 21.

### (20) Production of Film 24

Film 24 was produced as in film 21 except that film 7 was used as the support instead of film 5 and that the type of the wire bar, the conveying velocity and temperature during the coating, and the conveying velocity and temperature during the drying were appropriately controlled.

### (21) Production of Film 25

Film 25 was produced as in film 21 except that film 12 was used as the support instead of film 5 and that the type of the wire bar, the conveying velocity and temperature during the coating, and the conveying velocity and temperature during the drying were appropriately controlled.

### (22) Production of Film 26

Film 26 was produced as in film 22 except that film 8 was used as the support instead of film 6 and that the thickness at the coating was 0.8 times that of film 22.

### (23) Production of Film 27

Film 27 was produced as in film 22 except that film 8 was used as the support instead of film 6 and that the thickness at the coating was 0.7 times that of film 22.

### (24) Production of Film 28

Film 28 was produced as in film 21 except that film 7 was used as the support instead of film 5.

### (25) Production of Film 29

Film 29 was produced as in film 22 except that film 8 was used as the support instead of film 6.

### (26) Production of Film 35

### <Saponification of Cellulose Acylate Film>

The produced film 31 was allowed to pass between dielectric heating rolls at 60° C. to increase the film surface temperature to 40° C. An alkali solution having the following composition was applied thereto at 14 ml/m² with a bar coater. The film was retained under a far infrared steam heater (manufactured by Noritake Co., Ltd.) heated to 110° C. for 10 sec, and pure water was applied thereto at 3 ml/m² with a bar coater. The film temperature was 40° C. during the process. Subsequently, washing with water using a fountain coater and draining with an air knife were repeated three times, and then the film was dried in a drying zone at 70° C. for 10 sec.

Composition of alkali solution for saponification

Potassium hydroxide: 4.7 parts by mass
Water: 15.8 parts by mass
Isopropanol: 63.7 parts by mass
Propylene glycol: 14.8 parts by mass
Surfactant (C₁₆H₃₃O(CH₂CH₂O)₁₀H): 1.0 parts by mass

### <Production of Alignment Film>

A coating solution having the following composition was applied with a wire bar coater #14 onto the saponified surface of film 31 into a density of 24 mL/m², followed by drying with warm wind at 100° C. for 120 sec. The thickness of the alignment film was 0.6 μm. Subsequently, rubbing treatment was performed with a rubbing roller rolling at 400 rpm along the conveying direction to form an alignment film. The conveying velocity was 40 m/min during the process. Subsequently, dust on the rubbed surface was removed by supersonic vibration.

Alignment film coating solution composition

Modified polyvinyl alcohol shown below: 23.4 parts by mass
Water: 732.0 parts by mass
Methanol: 166.3 parts by mass
Isopropyl alcohol: 77.7 parts by mass
Irgacure 2959 (manufactured by BASF): 0.6 parts by mass
[Chem. 20]

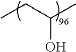

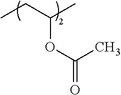

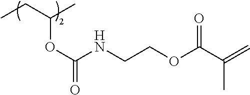

### <Production of Optically Anisotropic Layer>

An coating solution for forming optically anisotropic layer having the composition shown in the table below was continuously applied onto the rubbed and dust-removed surface of the alignment film with a wire bar coater #2.6, followed by heating in a drying zone at 70° C. for 90 sec to align the discotic liquid crystalline compound. Subsequently, the film was irradiated with UV light of an illuminance of 500 mW/cm² at a surface temperature of about 100° C. for 4 sec using an ultraviolet irradiation apparatus (UV lamp: output: 160 W/cm, emission light wavelength: 1.6 m) to fix the liquid crystalline compound in its alignment state by cross-linking. Subsequently, the film was cooled to room temperature and was wound into a cylindrical form. Thus, film 35 having optical anisotropy was thereby produced on a support.

Composition of coating solution for forming optically
anisotropic layer

Discotic liquid crystalline compound shon below: 100 parts

by mass

Photopolymerization initiator (Irgacure 907, manufactured by

Ciba-Geigy Co.): 1.5 parts by mass

Sensitizer (Kayacure DETX, manufactured by Nippon Kayaku

Co., Ltd.): 0.5 parts by mass

Pyridinium salt hon below: 1.0 parts by mass
Fluorine polymer shown below: 0.8 parts by mass
Methyl ethyl ketone: 345 parts by mass

[Chem. 21]
Discotic liquid crystalline compound: 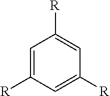 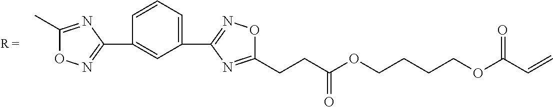 [SMILES: C=CC(=O)OCCCCOC(=O)CCc1nc(-c2cccc(-c3noc(C)n3)c2)no1]
[Chem. 22]
Pyridinium salt: 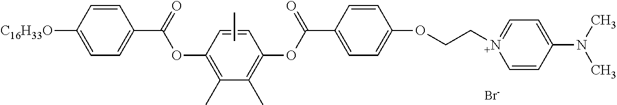
[Chem. 23]
Fluorine polymer:

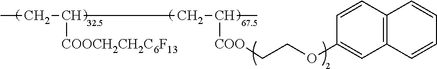

### (27) Production of Film 36

Film 36 was produced as in film 35 except that the thickness of the optically anisotropic layer during the coating was 0.7 times that of film 35.

### (28) Production of Film 37

Film 37 was produced as in film 21 except that film 32 was used instead of film 5 as the support.

### (29) Production of Film 38

Film 38 was produced as in film 21 except that film 33 was used instead of film 5 as the support.

### (30) Production of Film 39

Film 39 was produced by transferring the optically anisotropic layer of film 21 onto film 34.

### (31) Production of Film 40

An optically anisotropic film was produced from a cyclic olefin in accordance with the method described in Example 11 of Japanese Patent Laid-Open No. 2010-58495 except that the touching pressure was different. A surface of this film was subjected to corona discharge treatment. The film was laminated to film 32 with an acrylic adhesive to produce film 40.

### (32) Production of Film 41

Film 41 was produced as in film 38 except that the thickness during the coating was 0.7 times that of film 38.

### (33) Production of Film 44

Film 44 was produced as in film 21 except that the thickness during the coating was 0.7 times that of film 21.

### (34) Production of Film 45

Film 45 was produced as in film 44 except that film 14 was used as the support instead of film 5.

### (35) Production of Film 46

Film 46 was produced as in film 44 except that film 43 was used as the support instead of film 5.

### (36) Production of Film 47

Film 47 was produced as in film 24 except that film 42 was used as the support instead of film 7.

### (37) Production of Film 48

Film 48 was produced as in film 44 except that film 42 was used as the support instead of film 5.

The values of Re(550) and R[+40°]/R[−40°] of the optically anisotropic layers of the produced films 21 to 29, 35 to 41, and 44 to 48 are summarized in the following tables. For determination of the Re(550) and the R[+40°]/R[−40°] of the optically anisotropic layer of each film, optically anisotropic layers identical to those of the films were separately formed on respective glass plates.

TABLE 8

| | Re(550) | R[+40°]/ |
|---|---|---|
| | (nm) | [−40°] |
| Film 21 | 50 | 4 |
| (Film 5 + Optical anisotropic layer) | | |
| Film 22 | 50 | 4 |
| (Film 6 + Optical anisotropic layer) | | |
| Film 23 | 35 | 4 |
| (Film 7 + Optical anisotropic layer) | | |
| Film 24 | 19 | 9 |
| (Film 7 + Optical anisotropic layer) | | |
| Film 25 | 58 | 3 |
| (Film 12 + Optical anisotropic layer) | | |
| Film 26 | 40 | 4 |
| (Film 8 + Optical anisotropic layer) | | |
| Film 27 | 35 | 4 |
| (Film 8 + Optical anisotropic layer) | | |
| Film 28 | 50 | 4 |
| (Film 7 + Optical anisotropic layer) | | |
| Film 29 | 50 | 4 |
| (Film 8 + Optical anisotropic layer) | | |

TABLE 9

| | Re(550) | R[+40°]/ |
|---|---|---|
| | (nm) | [−40°] |
| Film 35 | 50 | 4 |
| (Film 31 + Optical anisotropic layer) | | |
| Film 36 | 35 | 4 |
| (Film 31 + Optical anisotropic layer) | | |
| Film 37 | 50 | 4 |
| (Film 32 + Optical anisotropic layer) | | |
| Film 38 | 50 | 4 |
| (Film 33 + Optical anisotropic layer) | | |
| Film 39 | 50 | 4 |
| (Film 34 + Optical anisotropic layer) | | |
| Film 40 | 50 | 4 |
| (Film 32 + Optical anisotropic layer) | | |
| Film 41 | 35 | 4 |
| (Film 33 + Optical anisotropic layer) | | |
| Film 44 | 35 | 4 |
| (Film 5 + Optical anisotropic layer) | | |
| Film 45 | 35 | 4 |
| (Film 14 + Optical anisotropic layer) | | |
| Film 46 | 35 | 4 |
| (Film 43 + Optical anisotropic layer) | | |
| Film 47 | 19 | 9 |
| (Film 42 + Optical anisotropic layer) | | |
| Film 48 | 35 | 4 |
| (Film 42 + Optical anisotropic layer) | | |

### 1. Production of 3D Display Apparatus

### (Image Display Device)

A vertically aligned (VA) mode liquid crystal cell was prepared as an image display device. Specifically, liquid crystals for PVA mode were sealed between substrates by vacuum injection to prepare a VA mode liquid crystal cell with a liquid crystal layer having a Δn·d of 290 nm at a wavelength of 550 nm. This display apparatus was used in the following examples and comparative examples as the liquid crystal cell (10) and the image display device comprising the third and fourth polarizing films (11 and 12). In the following examples and comparative examples of image display devices having barrier elements on the back, a low-reflective film, Clear LR (manufactured by Fuji Film Co., Ltd., “CV-LC”), laminated, with an easy-adhesive, to the surface of the polarizing film disposed at the side of the outer face of the display of the image display device.

### (Barrier Element)

A polyvinyl alcohol (PVA) film having a thickness of 80 μm was immersed in a iodine aqueous solution having a iodine concentration of 0.05% by mass at 30° C. for 60 sec for dyeing and was then vertically stretched by 5 times the original length during being immersed in a boric acid aqueous solution having a boric acid concentration of 4% by mass for 60 sec, followed by drying at 50° C. for 4 min to obtain a polarizing film having a thickness of 20 μm.

Each of the polymer films produced above was saponified with an alkali and was bonded to one surface of a polarizing film with a polyvinyl alcohol adhesive to produce a laminate. Films 11, 39, and 40 were subjected to corona discharge treatment on their surfaces and were then laminated to polarizing films with an acrylic adhesive. The other surface of each polarizing film was bonded to a commercially available cellulose acylate film, “TD80UL” (manufactured by Fuji Film Co., Ltd.), or a low-reflective film, Clear LR (manufactured by Fuji Film Co., Ltd. CV-LC).

TN mode liquid crystal cells and VA mode liquid crystal cells were produced as liquid crystal cells for barrier elements. Specifically, a TN mode liquid crystal cell with a liquid crystal layer having a Δn·d of 400 nm at a wavelength of 550 nm was prepared by sealing a liquid crystal material having a positive dielectric anisotropic layer between substrates by vacuum injection. The liquid crystal material used had positive dielectric anisotropy, refractive index anisotropy, a in of 0.0854 (589 nm, 20° C.), and a Δ∈ of about +8.5. The TN mode liquid crystal cell had a twist angle of 90°. A VA mode liquid crystal cell with a liquid crystal layer having a Δn·d of 290 nm at a wavelength of 550 nm was prepared by sealing liquid crystals for a PVA mode between substrates by vacuum injection.

Any of the laminates produced above was bonded to surfaces of the produced TN mode liquid crystal cell and the VA mode liquid crystal cell. In the following examples and comparative examples of barrier elements disposed in the front of the image display device, a laminate including a low-reflective film, Clear LR (manufactured by Fuji Film Co., Ltd., CV film CV-LC), was disposed at the side of the outer face of the display. In the case of bonding these laminates to barrier elements comprising the TN mode liquid crystal cells, as shown in the tables below, the absorption axis of the polarizing film was disposed in an E mode or an O mode in relationship to the liquid crystal cell. The axial relationship between individual components of the laminate is shown in the tables below.

### (Production of 3D Display Apparatus)

The barrier elements produced above were each laminated in the front or the back of an image display device to produce a 3D display apparatus. The axial relationship between individual components of the laminate is shown in the tables below. In the tables below, the slow axes of the first retardation film and the second retardation film are shown in regard to the axial relationship with the absorption axes of the third and second polarizing films. For example, in a first retardation film having a slow axis angle being “orthogonal” and an Re being positive, the slow axis of the first retardation film is orthogonal to the absorption axes of the third and the second polarizing films; in a first retardation film having a slow axis angle being “orthogonal” and an Re being negative, the slow axis of the first retardation film is parallel to the absorption axes of the third and the second polarizing films; in a second retardation film having a slow axis angle being “parallel” and an Re being positive, the slow axis of the second retardation film is parallel to the absorption axes of the third and the second polarizing films; and in second retardation film having a slow axis angle being “parallel” and an Re being negative, the slow axis of the second retardation film is orthogonal to the absorption axes of the third and the second polarizing films.

In Comparative Examples 1, 2, 11, and 12, 3D display apparatuses were each produced by laminating a glass substrate provided with a barrier layer having a black stripe pattern, instead of the barrier element produced above, to an image display device.

### 2. Evaluation of 3D Display Apparatus

### (1) Front Brightness in 2D Display

The front brightness of each display apparatus was measured in a 2D display mode with a luminance meter (BM-5A, manufactured by Topcon Technohouse Corp.) and was evaluated in accordance with the following criteria. With each example evaluated as rank A, the brightness was calculated as a relative value to the front brightness (100%) in Example 7 and is shown in the tables below.

[Evaluation criteria]
Rank A: brightness higher than that in Comparative Example 1
Rank B: brightness equivalent to or lower than that in Comparative

### Example 1

### (2) Brightness in the Lateral Direction in 2D Display

The brightnesses at azimuthal angles of 0° and 180° in a polar angle of 60° of each display apparatus in a 2D display were measured with a luminance meter (BM-5A, manufactured by Topcon Technohouse Corp.) and were evaluated by the following criteria. With each example evaluated as rank A, the brightness was calculated as a relative value to the horizontal brightness (100%) in Example 4 and is shown in the tables below.

### [Evaluation Criteria]

Rank A: brightness higher than that in Comparative Example 1
Rank B: brightness equivalent to or lower than that in Comparative Example 1

### (3) Change in Tint of White Portion in 2D Display

Changes in tint in a 2D display mode of each display apparatus at different viewing positions oblique to the front were evaluated at eight azimuthal angles of 0°, 45°, 90°, 135°, 180°, 225°, 270°, and 315° in accordance with the following criteria. The chromaticity u′ and the tint v′ at each of the eight directions in a polar angle of 60° were measured with a luminance meter (BM-5A, manufactured by Topcon Technohouse Corp.). The maximum difference Δu′v′ in chromaticity from that at the front was also measured.

### [Evaluation Criteria]

Rank A: no change in tint was recognized in all eight directions by visual observation (Δu′v′<0.015).
Rank B: a slight but acceptable change in tint was recognized in one direction by visual observation (0.015≦Δu′v′<0.041).
Rank C: slight but acceptable changes in tint were recognized in two to five directions by visual observation (0.015≦Δu′v′<0.041).
Rank D: a distinct change in tint was recognized in one direction by visual observation (0.041≦Δu′v′), but changes in tint in other seven directions were slight (Δu′v′<0.041) and acceptable.
Rank E: distinct changes in tint were recognized in two directions by visual observations and were unacceptable (0.041≦Δu′v′).

### (4) Visibility in 3D Display Mode

The barrier pattern image displayed by barrier elements was controlled such that the 3D display was achieved in each direction of eight azimuthal angles of 0°, 45°, 90°, 135°, 180°, 225°, 270°, and 315° in a polar angle of 45°, and the oblique visibility of the 3D display was evaluated by visual observation based on the following criteria.

### [Evaluation Criteria]

Rank A: no crosstalk was recognized in all eight directions by visual observation.
Rank B: slight but acceptable crosstalk was recognized in one to four directions by visual observation.
Rank C: slight but acceptable crosstalk was recognized in five or more directions by visual observation.

TABLE 10

| | | Example 1 | Example 2 | Example 3 | Example 4 | Example 5 |
|---|---|---|---|---|---|---|
| Structure | | FIG. 7b | FIG. 7b | FIG. 7b | FIG. 7b | FIG. 7b |
| Fourth polarizing film | Angle of the absorption axis | 90° | 90° | 90° | 45° | 135° |
| | seen from the front | | | | | |
| | Angle of the transmission | 0° | 0° | 0° | 135° | 45° |
| | axis seen from the front | | | | | |
| Liquid crystal cell for | Mode | VA | VA | VA | VA | VA |
| image display | | | | | | |
| Third polarizing film | Angle of the absorption axis | 0° | 0° | 0° | 135° | 45° |
| | seen from the front | | | | | |
| Second polarizing film | Angle of the absorption axis | 0° | 0° | 0° | 135° | 45° |
| | seen from the front | | | | | |
| First retardation film | Type | Film 1 | Film 30 | Film 11 | Film 1 | Film 1 |
| | Re (nm) | 50 | 50 | 50 | 50 | 50 |
| | Rth (nm) | 120 | 120 | 120 | 120 | 120 |
| | Slow axis angle | Orthogonal | Orthogonal | Orthogonal | Orthogonal | Orthogonal |
| Liquid crystal cell for | Δnd (nm) | 400 | 400 | 400 | 400 | 400 |
| barrier element | Mode | TN | TN | TN | TN | TN |
| | Disposition (E/O Mode) | E | E | E | E | E |
| Second retardation film | Type | Film 1 | Film 30 | Film 11 | Film 1 | Film 1 |
| | Re (nm) | 50 | 50 | 50 | 50 | 50 |
| | Rth (nm) | 120 | 120 | 120 | 120 | 120 |
| | Slow axis angle | Parallel | Parallel | Parallel | Parallel | Parallel |
| First polarizing film | Angle of the absorption axis | 90° | 90° | 90° | 45° | 135° |
| | seen from the front | | | | | |
| | Transmission (%) | 41.8 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 114 | 114 | 114 | 114 | 114 |
| | Brightness in the lateral | A | A | A | A | A |
| | direction of 2D (%) | 200 | 200 | 200 | 100 | 139 |
| | Color shift of 2D | D | D | D | D | D |
| | Visibility of 3D | B | B | B | B | B |

TABLE 11

| | | Example 6 | Example 7 | Example 8 | Example 9 | Example 10 |
|---|---|---|---|---|---|---|
| Structure | | FIG. 7b | FIG. 7b | FIG. 7b | FIG. 7b | FIG. 7b |
| Fourth polarizing film | Angle of the absorption axis | 90° | 90° | 90° | 90° | 90° |
| | seen from the front | | | | | |
| | Angle of the transmission | 0° | 0° | 0° | 0° | 0° |
| | axis seen from the front | | | | | |
| Liquid crystal cell for | Mode | VA | VA | VA | VA | VA |
| image display | | | | | | |
| Third polarizing film | Angle of the absorption axis | 0° | 0° | 0° | 0° | 0° |
| | seen from the front | | | | | |
| Second polarizing film | Angle of the absorption axis | 0° | 0° | 0° | 0° | 0° |
| | seen from the front | | | | | |
| First retardation film | Type | Film 1 | Film 1 | Film 4 | Film 1 | Film 9 |
| | Re (nm) | 50 | 50 | 0 | 50 | 10 |
| | Rth (nm) | 120 | 120 | 60 | 120 | 150 |
| | Slow axis angle | Orthogonal | Orthogonal | Orthogonal | Orthogonal | Orthogonal |
| Liquid crystal cell for | Δnd (nm) | 400 | 290 | 290 | 400 | 400 |
| barrier element | Mode | TN | VA | VA | TN | TN |
| | Disposition (E/O Mode) | E | — | — | O | E |
| Second retardation film | Type | Film 1 | Film 1 | Film 12 | Film 1 | Film 9 |
| | Re (nm) | 50 | 50 | 80 | 50 | 10 |
| | Rth (nm) | 120 | 120 | 180 | 120 | 150 |
| | Slow axis angle | Parallel | Parallel | Parallel | Parallel | Parallel |
| First polarizing film | Angle of the absorption axis | 90° | 90° | 90° | 90° | 90° |
| | seen from the front | | | | | |
| | Transmission (%) | 43.4 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 121 | 100 | 100 | 114 | 114 |
| | Brightness in the lateral | A | A | A | A | A |
| | direction of 2D (%) | 211 | 175 | 175 | 195 | 200 |
| | Color shift of 2D | D | C | C | B | D |
| | Visibility of 3D | B | A | B | B | B |

TABLE 12

| | | Example 11 | Example 12 | Example 13 | Example 14 | Example 15 |
|---|---|---|---|---|---|---|
| Structure | | FIG. 7b | FIG. 7b | FIG. 7b | FIG. 7b | FIG. 7b |
| Fourth polarizing film | Angle of the absorption axis | 90° | 90° | 90° | 90° | 90° |
| | seen from the front | | | | | |
| | Angle of the transmission | 0° | 0° | 0° | 0° | 0° |
| | axis seen from the front | | | | | |
| Liquid crystal cell for | Mode | VA | VA | VA | VA | VA |
| image display | | | | | | |
| Third polarizing film | Angle of the absorption axis | 0° | 0° | 0° | 0° | 0° |
| | seen from the front | | | | | |
| Second polarizing film | Angle of the absorption axis | 0° | 0° | 0° | 0° | 0° |
| | seen from the front | | | | | |
| First retardation film | Type | Film 9 | Film 9 | Film 15 | Film 2 | Film 3 |
| | Re (nm) | 10 | 10 | −30 | 0 | 80 |
| | Rth (nm) | 150 | 150 | 90 | 150 | 140 |
| | Slow axis angle | 100° | 80° | Orthogonal | Orthogonal | Orthogonal |
| Liquid crystal cell for | Δnd (nm) | 400 | 400 | 400 | 400 | 400 |
| barrier element | Mode | TN | TN | TN | TN | TN |
| | Disposition (E/O Mode) | E | E | E | O | E |
| Second retardation film | Type | Film 9 | Film 9 | Film 15 | Film 2 | Film 3 |
| | Re (nm) | 10 | 10 | −30 | 0 | 80 |
| | Rth (nm) | 150 | 150 | 90 | 150 | 140 |
| | Slow axis angle | 10° | −10° | Parallel | Parallel | Parallel |
| First polarizing film | Angle of the absorption axis | 90° | 90° | 90° | 90° | 90° |
| | seen from the front | | | | | |
| | Transmission (%) | 41.8 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 107 | 106 | 114 | 114 | 114 |
| | Brightness in the lateral | A | A | A | A | A |
| | direction of 2D (%) | 186 | 183 | 201 | 196 | 200 |
| | Color shift of 2D | D | D | D | C | C |
| | Visibility of 3D | B | B | B | B | B |

TABLE 13

| | | Example 16 | Example 17 | Example 18 | Example 19 | Example 20 |
|---|---|---|---|---|---|---|
| Structure | | FIG. 7b | FIG. 7b | FIG. 7b | FIG. 7b | FIG. 7b |
| Fourth polarizing film | Angle of the absorption axis | 90° | 90° | 90° | 90° | 90° |
| | seen from the front | | | | | |
| | Angle of the transmission | 0° | 0° | 0° | 0° | 0° |
| | axis seen from the front | | | | | |
| Liquid crystal cell for | Mode | VA | VA | VA | VA | VA |
| image display | | | | | | |
| Third polarizing film | Angle of the absorption axis | 0° | 0° | 0° | 0° | 0° |
| | seen from the front | | | | | |
| Second polarizing film | Angle of the absorption axis | 0° | 0° | 0° | 0° | 0° |
| | seen from the front | | | | | |
| First retardation film | Type | Film 4 | Film 4 | Film 21 | Film 22 | Film 1 |
| | Re (nm) | 0 | 0 | −10 | 20 | 50 |
| | Rth (nm) | 60 | 60 | 80 | 120 | 120 |
| | Slow axis angle | Orthogonal | Orthogonal | Orthogonal | Orthogonal | Orthogonal |
| Liquid crystal cell for | Δnd (nm) | 400 | 400 | 400 | 400 | 460 |
| barrier element | Mode | TN | TN | TN | TN | TN |
| | Disposition (E/O Mode) | E | O | O | O | E |
| Second retardation film | Type | Film 4 | Film 4 | Film 21 | Film 22 | Film 1 |
| | Re (nm) | 0 | 0 | −10 | 20 | 50 |
| | Rth (nm) | 60 | 60 | 80 | 120 | 120 |
| | Slow axis angle | Parallel | Parallel | Parallel | Parallel | Parallel |
| First polarizing film | Angle of the absorption axis | 90° | 90° | 90° | 90° | 90° |
| | seen from the front | | | | | |
| | Transmission (%) | 41.8 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 114 | 114 | 114 | 114 | 120 |
| | Brightness in the lateral | A | A | A | A | A |
| | direction of 2D (%) | 201 | 196 | 203 | 203 | 210 |
| | Color shift of 2D | D | B | C | C | D |
| | Visibility of 3D | B | B | A | A | B |

TABLE 14

| | | Example 21 | Example 22 | Example 23 | Example 24 | Example 25 |
|---|---|---|---|---|---|---|
| Structure | | FIG. 7b | FIG. 7b | FIG. 7b | FIG. 7b | FIG. 7a |
| Fourth polarizing film | Angle of the absorption axis | 90° | 90° | 90° | 90° | 90° |
| | seen from the front | | | | | |
| | Angle of the transmission | 0° | 0° | 0° | 0° | 0° |
| | axis seen from the front | | | | | |
| Liquid crystal cell for | Mode | VA | VA | VA | VA | VA |
| image display | | | | | | |
| Third polarizing film | Angle of the absorption axis | 0° | 0° | 0° | 0° | 0° |
| | seen from the front | | | | | |
| Second polarizing film | Angle of the absorption axis | 0° | 0° | 0° | 0° | — |
| | seen from the front | | | | | |
| First retardation film | Type | Film 1 | Film 28 | Film 29 | Film 29 | Film 1 |
| | Re (nm) | 50 | 10 | 10 | 10 | 50 |
| | Rth (nm) | 120 | 100 | 135 | 135 | 120 |
| | Slow axis angle | Orthogonal | Orthogonal | Orthogonal | Orthogonal | Orthogonal |
| Liquid crystal cell for | Δnd (nm) | 460 | 460 | 460 | 460 | 400 |
| barrier element | Mode | TN | TN | TN | TN | TN |
| | Disposition (E/O Mode) | O | O | O | O | E |
| Second retardation film | Type | Film 1 | Film 28 | Film 29 | Film 29 | Film 1 |
| | Re (nm) | 50 | 10 | 10 | 10 | 50 |
| | Rth (nm) | 120 | 100 | 135 | 135 | 120 |
| | Slow axis angle | Parallel | Parallel | Parallel | Parallel | Parallel |
| First polarizing film | Angle of the absorption axis | 90° | 90° | 90° | 90° | 90° |
| | seen from the front | | | | | |
| | Transmission (%) | 41.8 | 41.8 | 41.8 | 43.4 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 120 | 120 | 120 | 126 | 130 |
| | Brightness in the lateral | A | A | A | A | A |
| | direction of 2D (%) | 205 | 209 | 213 | 225 | 228 |
| | Color shift of 2D | B | C | C | C | D |
| | Visibility of 3D | B | A | A | A | B |

TABLE 15

| | | Example 26 | Example 27 | Example 28 | Example 29 | Example 30 |
|---|---|---|---|---|---|---|
| Structure | | FIG. 7a | FIG. 7a | FIG. 7a | FIG. 7a | FIG. 7a |
| Fourth polarizing film | Angle of the absorption axis | 90° | 90° | 90° | 90° | 90° |
| | seen from the front | | | | | |
| | Angle of the transmission | 0° | 0° | 0° | 0° | 0° |
| | axis seen from the front | | | | | |
| Liquid crystal cell for | Mode | VA | VA | VA | VA | VA |
| image display | | | | | | |
| Third polarizing film | Angle of the absorption axis | 0° | 0° | 0° | 0° | 0° |
| | seen from the front | | | | | |
| Second polarizing film | Angle of the absorption axis | — | — | — | — | — |
| | seen from the front | | | | | |
| First retardation film | Type | Film 1 | Film 18 | Film 21 | Film 22 | Film 1 |
| | Re (nm) | 50 | 100 | −10 | 20 | 50 |
| | Rth (nm) | 120 | 110 | 80 | 120 | 120 |
| | Slow axis angle | Orthogonal | Orthogonal | Orthogonal | Orthogonal | Orthogonal |
| Liquid crystal cell for | Δnd (nm) | 400 | 400 | 400 | 400 | 460 |
| barrier element | Mode | TN | TN | TN | TN | TN |
| | Disposition (E/O Mode) | E | E | O | O | E |
| Second retardation film | Type | Film 1 | Film 18 | Film 21 | Film 22 | Film 1 |
| | Re (nm) | 50 | 100 | −10 | 20 | 50 |
| | Rth (nm) | 120 | 110 | 80 | 120 | 120 |
| | Slow axis angle | Parallel | Parallel | Parallel | Parallel | Parallel |
| First polarizing film | Angle of the absorption axis | 90° | 90° | 90° | 90° | 90° |
| | seen from the front | | | | | |
| | Transmission (%) | 43.4 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 138 | 130 | 130 | 130 | 137 |
| | Brightness in the lateral | A | A | A | A | A |
| | direction of 2D (%) | 241 | 226 | 231 | 231 | 239 |
| | Color shift of 2D | D | B | C | C | D |
| | Visibility of 3D | B | B | A | A | B |

TABLE 16

| | | Example 31 | Example 32 | Example 33 | Example 34 | Example 35 |
|---|---|---|---|---|---|---|
| Structure | | FIG. 7a | FIG. 7a | FIG. 7a | FIG. 7a | FIG. 7a |
| Fourth polarizing film | Angle of the absorption axis | 90° | 90° | 90° | 90° | 90° |
| | seen from the front | | | | | |
| | Angle of the transmission | 0° | 0° | 0° | 0° | 0° |
| | axis seen from the front | | | | | |
| Liquid crystal cell for | Mode | VA | VA | VA | VA | VA |
| image display | | | | | | |
| Third polarizing film | Angle of the absorption axis | 0° | 0° | 0° | 0° | 0° |
| | seen from the front | | | | | |
| Second polarizing film | Angle of the absorption axis | — | — | — | — | — |
| | seen from the front | | | | | |
| First retardation film | Type | Film 28 | Film 23 | Film 18 | Film 17 | Film 14 |
| | Re (nm) | 10 | 10 | 100 | 100 | −3 |
| | Rth (nm) | 100 | 100 | 110 | 150 | 40 |
| | Slow axis angle | Orthogonal | Orthogonal | Orthogonal | Orthogonal | Orthogonal |
| Liquid crystal cell for | Δnd (nm) | 460 | 460 | 460 | 460 | 460 |
| barrier element | Mode | TN | TN | TN | TN | TN |
| | Disposition (E/O Mode) | O | O | O | O | O |
| Second retardation film | Type | Film 28 | Film 23 | Film 28 | Film 24 | Film 25 |
| | Re (nm) | 10 | 10 | 10 | 10 | 80 |
| | Rth (nm) | 100 | 100 | 100 | 100 | 180 |
| | Slow axis angle | Parallel | Parallel | Parallel | Parallel | Parallel |
| First polarizing film | Angle of the absorption axis | 90° | 90° | 90° | 90° | 90° |
| | seen from the front | | | | | |
| | Transmission (%) | 41.8 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 137 | 137 | 137 | 137 | 137 |
| | Brightness in the lateral | A | A | A | A | A |
| | direction of 2D (%) | 239 | 239 | 237 | 237 | 232 |
| | Color shift of 2D | C | A | C | C | C |
| | Visibility of 3D | A | A | A | A | A |

TABLE 17

| | | Example 36 | Example 37 | Example 38 | Example 39 |
|---|---|---|---|---|---|
| Structure | | FIG. 7a | FIG. 7a | FIG. 7a | FIG. 7a |
| Fourth polarizing film | Angle of the absorption axis | 90° | 90° | 90° | 90° |
| | seen from the front | | | | |
| | Angle of the transmission | 0° | 0° | 0° | 0° |
| | axis seen from the front | | | | |
| Liquid crystal cell for | Mode | VA | VA | VA | VA |
| Image display | | | | | |
| Third polarizing film | Angle of the absorption axis | 0° | 0° | 0° | 0° |
| | seen from the front | | | | |
| Second polarizing film | Angle of the absorption axis | — | — | — | — |
| | seen from the front | | | | |
| First retardation film | Type | Film 29 | Film 29 | Film 26 | Film 27 |
| | Re (nm) | 10 | 10 | 10 | 10 |
| | Rth (nm) | 135 | 135 | 135 | 135 |
| | Slow axis angle | Orthogonal | Orthogonal | Orthogonal | Orthogonal |
| Liquid crystal cell for | Δnd (nm) | 460 | 460 | 460 | 460 |
| barrier element | Mode | TN | TN | TN | TN |
| | Disposition (E/O Mode) | O | O | O | O |
| Second retardation film | Type | Film 29 | Film 29 | Film 26 | Film 27 |
| | Re (nm) | 10 | 10 | 10 | 10 |
| | Rth (nm) | 135 | 135 | 135 | 135 |
| | Slow axis angle | Parallel | Parallel | Parallel | Parallel |
| First polarizing film | Angle of the absorption axis | 90° | 90° | 90° | 90° |
| | seen from the front | | | | |
| | Transmission (%) | 41.8 | 43.4 | 41.8 | 41.8 |
| Transmission of third polarizing film (%) | | 41.8 | 41.8 | 41.8 | 41.8 |
| Evaluation | Front brightness of 2D (%) | A | A | A | A |
| | | 137 | 145 | 137 | 137 |
| | Brightness in the lateral | A | A | A | A |
| | direction of 2D (%) | 239 | 253 | 239 | 239 |
| | Color shift of 2D | C | C | A | A |
| | Visibility of 3D | A | A | A | A |

TABLE 18

| | | Comparative | Comparative | Comparative | Comparative | Comparative | Comparative |
|---|---|---|---|---|---|---|---|
| | | example 1 | example 2 | example 3 | example 4 | example 5 | example 6 |
| Structure | | — | — | FIG. 7b | FIG. 7b | FIG. 7b | FIG. 7b |
| Fourth polarizing film | Angle of the absorption axis | 90° | 0° | 90° | 90° | 90° | 90° |
| | seen from the front | | | | | | |
| | Angle of the transmission | 0° | 90° | 0° | 0° | 0° | 0° |
| | axis seen from the front | | | | | | |
| Liquid crystal cell for | Mode | VA | VA | VA | VA | VA | VA |
| Image display | | | | | | | |
| Third polarizing film | Angle of the absorption axis | 0° | 90° | 0° | 0° | 0° | 0° |
| | seen from the front | | | | | | |
| Second polarizing film | Angle of the absorption axis | — | — | 0° | 0° | 0° | 0° |
| | seen from the front | | | | | | |
| First retardation film | Type | — | — | Film 19 | Film 16 | Film 13 | Film 20 |
| | Re (nm) | — | — | −40 | 100 | 100 | 30 |
| | Rth (nm) | — | — | 150 | 190 | 230 | −17 |
| | Slow axis angle | — | — | Orthogonal | Orthogonal | Orthogonal | Orthogonal |
| Liquid crystal cell for | Δnd (nm) | — | — | 400 | 400 | 400 | 400 |
| barrier element | Mode | — | — | TN | TN | TN | TN |
| | Disposition (E/O Mode) | — | — | E | O | E | O |
| Second retardation film | Type | — | — | Film 19 | Film 16 | Film 13 | Film 20 |
| | Re (nm) | — | — | −40 | 100 | 100 | 30 |
| | Rth (nm) | — | — | 150 | 190 | 230 | −17 |
| | Slow axis angle | — | — | Parallel | Parallel | Parallel | Parallel |
| First polarizing film | Angle of the absorption axis | — | — | 90° | 90° | 90° | 90° |
| | seen from the front | | | | | | |
| | Transmission (%) | — | — | 41.8 | 41.8 | 41.8 | 41.8 |
| Transmission of third polarizing film (%) | | — | — | 41.8 | 41.8 | 41.8 | 41.8 |
| Evaluation | Front brightness of 2D (%) | B | B | A | A | A | A |
| | | | | 114 | 114 | 114 | 114 |
| | Brightness in the lateral | A | A | A | A | A | A |
| | direction of 2D (%) | | | 201 | 200 | 200 | 200 |
| | Color shift of 2D | — | — | E | C | E | B |
| | Visibility of 3D | — | — | C | C | B | C |

TABLE 19

| | | Example 40 | Example 41 | Example 42 | Example 43 | Example 44 | Example 45 |
|---|---|---|---|---|---|---|---|
| Structure | | FIG. 4 | FIG. 4 | FIG. 4 | FIG. 4 | FIG. 4 | FIG. 4 |
| Fourth polarizing film | Angle of the absorption axis | 0° | 0° | 0° | 0° | 0° | 0° |
| | seen from the front | | | | | | |
| | Angle of the transmission | 90° | 90° | 90° | 90° | 90° | 90° |
| | axis seen from the front | | | | | | |
| Liquid crystal cell for | Mode | VA | VA | VA | VA | VA | VA |
| Image display | | | | | | | |
| Third polarizing film | Angle of the absorption axis | 90° | 90° | 90° | 90° | 90° | 90° |
| | seen from the front | | | | | | |
| Second polarizing film | Angle of the absorption axis | 90° | 90° | 90° | 90° | 90° | 90° |
| | seen from the front | | | | | | |
| First retardation film | Type | Film 1 | Film 30 | Film 11 | Film 1 | Film 1 | Film 4 |
| | Re (nm) | 50 | 50 | 50 | 50 | 50 | 0 |
| | Rth (nm) | 120 | 120 | 120 | 120 | 120 | 60 |
| | Slow axis angle | Orthogonal | Orthogonal | Orthogonal | Orthogonal | Orthogonal | Orthogonal |
| Liquid crystal cell for | Δnd (nm) | 400 | 400 | 400 | 400 | 290 | 290 |
| barrier element | Mode | TN | TN | TN | TN | VA | VA |
| | Disposition (E/O Mode) | E | E | E | E | — | — |
| Second retardation film | Type | Film 1 | Film 30 | Film 11 | Film 1 | Film 1 | Film 12 |
| | Re (nm) | 50 | 50 | 50 | 50 | 50 | 80 |
| | Rth (nm) | 120 | 120 | 120 | 120 | 120 | 180 |
| | Slow axis angle | Parallel | Parallel | Parallel | Parallel | Parallel | Parallel |
| First polarizing film | Angle of the absorption axis | 0° | 0° | 0° | 0° | 0° | 0° |
| | seen from the front | | | | | | |
| | Transmission (%) | 41.8 | 41.8 | 41.8 | 41.8 | 41.8 | 41.8 |
| Transmission of third polarizing film (%) | | 41.8 | 41.8 | 41.8 | 41.8 | 41.8 | 41.8 |
| Evaluation | Front brightness of 2D (%) | A | A | A | A | A | A |
| | | 114 | 114 | 114 | 121 | 100 | 100 |
| | Brightness in the lateral | A | A | A | A | A | A |
| | direction of 2D (%) | 200 | 200 | 200 | 211 | 175 | 175 |
| | Color shift of 2D | D | D | D | D | C | C |
| | Visibility of 3D | B | B | B | B | A | B |

TABLE 20

| | | Example 46 | Example 47 | Example 48 | Example 49 |
|---|---|---|---|---|---|
| Structure | | FIG. 4 | FIG. 4 | FIG. 4 | FIG. 4 |
| Fourth polarizing film | Angle of the absorption axis | 0° | 0° | 0° | 0° |
| | seen from the front | | | | |
| | Angle of the transmission | 90° | 90° | 90° | 90° |
| | axis seen from the front | | | | |
| Liquid crystal cell for | Mode | VA | VA | VA | VA |
| image display | | | | | |
| Third polarizing film | Angle of the absorption axis | 90° | 90° | 90° | 90° |
| | seen from the front | | | | |
| Second polarizing film | Angle of the absorption axis | 90° | 90° | 90° | 90° |
| | seen from the front | | | | |
| First retardation film | Type | Film 1 | Film 9 | Film 9 | Film 9 |
| | Re (nm) | 50 | 10 | 10 | 10 |
| | Rth (nm) | 120 | 150 | 150 | 150 |
| | Slow axis angle | Orthogonal | Orthogonal | 10° | −10° |
| Liquid crystal cell for | Δnd (nm) | 400 | 400 | 400 | 400 |
| barrier element | Mode | TN | TN | TN | TN |
| | Disposition (E/O Mode) | O | E | E | E |
| Second retardation film | Type | Film 1 | Film 9 | Film 9 | Film 9 |
| | Re (nm) | 50 | 10 | 10 | 10 |
| | Rth (nm) | 120 | 150 | 150 | 150 |
| | Slow axis angle | Parallel | Parallel | 100° | 80° |
| First polarizing film | Angle of the absorption axis | 0° | 0° | 0° | 0° |
| | seen from the front | | | | |
| | Transmission (%) | 41.8 | 41.8 | 41.8 | 41.8 |
| Transmission of third polarizing film (%) | | 41.8 | 41.8 | 41.8 | 41.8 |
| Evaluation | Front brightness of 2D (%) | A | A | A | A |
| | | 114 | 114 | 107 | 106 |
| | Brightness in the lateral | A | A | A | A |
| | direction of 2D (%) | 195 | 200 | 186 | 183 |
| | Color shift of 2D | B | D | D | D |
| | Visibility of 3D | B | B | B | B |

TABLE 21

| | | Example 50 | Example 51 | Example 52 | Example 53 | Example 54 |
|---|---|---|---|---|---|---|
| Structure | | FIG. 4 | FIG. 4 | FIG. 4 | FIG. 4 | FIG. 4 |
| Fourth polarizing film | Angle of the absorption axis | 0° | 0° | 0° | 0° | 0° |
| | seen from the front | | | | | |
| | Angle of the transmission | 90° | 90° | 90° | 90° | 90° |
| | axis seen from the front | | | | | |
| Liquid crystal cell for | Mode | VA | VA | VA | VA | VA |
| image display | | | | | | |
| Third polarizing film | Angle of the absorption axis | 90° | 90° | 90° | 90° | 90° |
| | seen from the front | | | | | |
| Second polarizing film | Angle of the absorption axis | 90° | 90° | 90° | 90° | 90° |
| | seen from the front | | | | | |
| First retardation film | Type | Film 15 | Film 2 | Film 3 | Film 4 | Film 4 |
| | Re (nm) | −30 | 0 | 80 | 0 | 0 |
| | Rth (nm) | 90 | 150 | 140 | 60 | 60 |
| | Slow axis angle | Orthogonal | Orthogonal | Orthogonal | Orthogonal | Orthogonal |
| Liquid crystal cell for | Δnd (nm) | 400 | 400 | 400 | 400 | 400 |
| barrier element | Mode | TN | TN | TN | TN | TN |
| | Disposition (E/O Mode) | E | O | E | E | O |
| Second retardation film | Type | Film 15 | Film 2 | Film 3 | Film 4 | Film 4 |
| | Re (nm) | −30 | 0 | 80 | 0 | 0 |
| | Rth (nm) | 90 | 150 | 140 | 60 | 60 |
| | Slow axis angle | Parallel | Parallel | Parallel | Parallel | Parallel |
| First polarizing film | Angle of the absorption axis | 0° | 0° | 0° | 0° | 0° |
| | seen from the front | | | | | |
| | Transmission (%) | 41.8 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 114 | 114 | 114 | 114 | 114 |
| | Brightness in the lateral | A | A | A | A | A |
| | direction of 2D (%) | 201 | 196 | 200 | 201 | 196 |
| | Color shift of 2D | D | C | C | D | B |
| | Visibility of 3D | B | B | B | B | B |

TABLE 22

| | | Example 55 | Example 56 | Example 57 | Example 58 | Example 59 |
|---|---|---|---|---|---|---|
| Structure | | FIG. 4 | FIG. 4 | FIG. 4 | FIG. 4 | FIG. 4 |
| Fourth polarizing film | Angle of the absorption axis | 0° | 0° | 0° | 0° | 0° |
| | seen from the front | | | | | |
| | Angle of the transmission | 90° | 90° | 90° | 90° | 90° |
| | axis seen from the front | | | | | |
| Liquid crystal cell for | Mode | VA | VA | VA | VA | VA |
| image display | | | | | | |
| Third polarizing film | Angle of the absorption axis | 90° | 90° | 90° | 90° | 90° |
| | seen from the front | | | | | |
| Second polarizing film | Angle of the absorption axis | 90° | 90° | 90° | 90° | 90° |
| | seen from the front | | | | | |
| First retardation film | Type | Film 21 | Film 22 | Film 1 | Film 1 | Film 28 |
| | Re (nm) | −10 | 20 | 50 | 50 | 10 |
| | Rth (nm) | 80 | 120 | 120 | 120 | 100 |
| | Slow axis angle | Orthogonal | Orthogonal | Orthogonal | Orthogonal | Orthogonal |
| Liquid crystal cell for | Δnd (nm) | 400 | 400 | 460 | 460 | 460 |
| barrier element | Mode | TN | TN | TN | TN | TN |
| | Disposition (E/O Mode) | O | O | E | O | O |
| Second retardation film | Type | Film 21 | Film 22 | Film 1 | Film 1 | Film 28 |
| | Re (nm) | −10 | 20 | 50 | 50 | 10 |
| | Rth (nm) | 80 | 120 | 120 | 120 | 100 |
| | Slow axis angle | Parallel | Parallel | Parallel | Parallel | Parallel |
| First polarizing film | Angle of the absorption axis | 0° | 0° | 0° | 0° | 0° |
| | seen from the front | | | | | |
| | Transmission (%) | 41.8 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 114 | 114 | 120 | 120 | 120 |
| | Brightness in the lateral | A | A | A | A | A |
| | direction of 2D (%) | 203 | 203 | 210 | 205 | 209 |
| | Color shift of 2D | C | C | D | B | C |
| | Visibility of 3D | A | A | B | B | A |

TABLE 23

| | | Example 60 | Example 61 | Example 62 | Example 63 | Example 64 |
|---|---|---|---|---|---|---|
| Structure | | FIG. 4 | FIG. 4 | FIG. 3 | FIG. 3 | FIG. 3 |
| Fourth polarizing film | Angle of the absorption axis | 0° | 0° | 0° | 0° | 0° |
| | seen from the front | | | | | |
| | Angle of the transmission | 90° | 90° | 90° | 90° | 90° |
| | axis seen from the front | | | | | |
| Liquid crystal cell for | Mode | VA | VA | VA | VA | VA |
| Image display | | | | | | |
| Third polarizing film | Angle of the absorption axis | 90° | 90° | 90° | 90° | 90° |
| | seen from the front | | | | | |
| Second polarizing film | Angle of the absorption axis | 90° | 90° | — | — | — |
| | seen from the front | | | | | |
| First retardation film | Type | Film 29 | Film 29 | Film 1 | Film 1 | Film 21 |
| | Re (nm) | 10 | 10 | 50 | 50 | −10 |
| | Rth (nm) | 135 | 135 | 120 | 120 | 80 |
| | Slow axis angle | Orthogonal | Orthogonal | Orthogonal | Orthogonal | Orthogonal |
| Liquid crystal cell for | Δnd (nm) | 460 | 460 | 400 | 400 | 400 |
| barrier element | Mode | TN | TN | TN | TN | TN |
| | Disposition (E/O Mode) | O | O | E | E | O |
| Second retardation film | Type | Film 29 | Film 29 | Film 1 | Film 1 | Film 21 |
| | Re (nm) | 10 | 10 | 50 | 50 | −10 |
| | Rth (nm) | 135 | 135 | 120 | 120 | 80 |
| | Slow axis angle | Parallel | Parallel | Parallel | Parallel | Parallel |
| First polarizing film | Angle of the absorption axis | 0° | 0° | 0° | 0° | 0° |
| | seen from the front | | | | | |
| | Transmission (%) | 41.8 | 43.4 | 41.8 | 43.4 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 120 | 126 | 130 | 138 | 130 |
| | Brightness in the lateral | A | A | A | A | A |
| | direction of 2D (%) | 213 | 225 | 228 | 241 | 231 |
| | Color shift of 2D | B | C | D | D | C |
| | Visibility of 3D | A | A | B | B | A |

TABLE 24

| | | Example 65 | Example 66 | Example 67 | Example 68 | Example 69 |
|---|---|---|---|---|---|---|
| Structure | | FIG. 3 | FIG. 3 | FIG. 3 | FIG. 3 | FIG. 3 |
| Fourth polarizing film | Angle of the absorption axis | 0° | 0° | 0° | 0° | 0° |
| | seen from the front | | | | | |
| | Angle of the transmission | 90° | 90° | 90° | 90° | 90° |
| | axis seen from the front | | | | | |
| Liquid crystal cell for | Mode | VA | VA | VA | VA | VA |
| image display | | | | | | |
| Third polarizing film | Angle of the absorption axis | 90° | 90° | 90° | 90° | 90° |
| | seen from the front | | | | | |
| Second polarizing film | Angle of the absorption axis | — | — | — | — | — |
| | seen from the front | | | | | |
| First retardation film | Type | Film 22 | Film 1 | Film 28 | Film 23 | Film 18 |
| | Re (nm) | 20 | 50 | 10 | 10 | 100 |
| | Rth (nm) | 120 | 120 | 100 | 100 | 110 |
| | Slow axis angle | Orthogonal | Orthogonal | Orthogonal | Orthogonal | Orthogonal |
| Liquid crystal cell for | Δnd (nm) | 400 | 460 | 460 | 460 | 460 |
| barrier element | Mode | TN | TN | TN | TN | TN |
| | Disposition (E/O Mode) | O | E | O | O | O |
| Second retardation film | Type | Film 22 | Film 1 | Film 28 | Film 23 | Film 28 |
| | Re (nm) | 20 | 50 | 10 | 10 | 10 |
| | Rth (nm) | 120 | 120 | 100 | 100 | 100 |
| | Slow axis angle | Parallel | Parallel | Parallel | Parallel | Parallel |
| First polarizing film | Angle of the absorption axis | 0° | 0° | 0° | 0° | 0° |
| | seen from the front | | | | | |
| | Transmission (%) | 41.8 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 130 | 137 | 137 | 137 | 137 |
| | Brightness in the lateral | A | A | A | A | A |
| | direction of 2D (%) | 231 | 239 | 239 | 239 | 237 |
| | Color shift of 2D | C | D | C | A | C |
| | Visibility of 3D | A | B | A | A | A |

TABLE 25

| | | Example 70 | Example 71 | Example 72 | Example 73 | Example 74 | Example 75 |
|---|---|---|---|---|---|---|---|
| Structure | | FIG. 3 | FIG. 3 | FIG. 3 | FIG. 3 | FIG. 3 | FIG. 3 |
| Fourth polarizing | Angle of the absorption axis | 0° | 0° | 0° | 0° | 0° | 0° |
| film | seen from the front | | | | | | |
| | Angle of the transmission | 90° | 90° | 90° | 90° | 90° | 90° |
| | axis seen from the front | | | | | | |
| Liquid crystal cell | Mode | VA | VA | VA | VA | VA | VA |
| for image display | | | | | | | |
| Third polarizing | Angle of the absorption axis | 90° | 90° | 90° | 90° | 90° | 90° |
| film | seen from the front | | | | | | |
| Second polarizing | Angle of the absorption axis | — | — | — | — | — | — |
| film | seen from the front | | | | | | |
| First retardation film | Type | Film 17 | Film 14 | Film 29 | Film 29 | Film 26 | Film 27 |
| | Re (nm) | 100 | −3 | 10 | 10 | 10 | 10 |
| | Rth (nm) | 150 | 40 | 135 | 135 | 135 | 135 |
| | Slow axis angle | Orthogonal | Orthogonal | Orthogonal | Orthogonal | Orthogonal | Orthogonal |
| Liquid crystal cell | Δnd (nm) | 460 | 460 | 460 | 460 | 460 | 460 |
| for barrier element | Mode | TN | TN | TN | TN | TN | TN |
| | Disposition (E/O Mode) | O | O | O | O | O | O |
| Second retardation | Type | Film 24 | Film 25 | Film 29 | Film 29 | Film 26 | Film 27 |
| film | Re (nm) | 10 | 80 | 10 | 10 | 10 | 10 |
| | Rth (nm) | 100 | 180 | 135 | 135 | 135 | 135 |
| | Slow axis angle | Parallel | Parallel | Parallel | Parallel | Parallel | Parallel |
| First polarizing film | Angle of the absorption axis | 0° | 0° | 0° | 0° | 0° | 0° |
| | seen from the front | | | | | | |
| | Transmission (%) | 41.8 | 41.8 | 41.8 | 43.4 | 41.8 | 41.8 |
| Transmission of third polarizing film (%) | | 41.8 | 41.8 | 41.8 | 41.8 | 41.8 | 41.8 |
| Evaluation | Front brightness of 2D (%) | A | A | A | A | A | A |
| | | 137 | 137 | 137 | 145 | 137 | 137 |
| | Brightness in the lateral | A | A | A | A | A | A |
| | direction of 2D (%) | 237 | 232 | 239 | 253 | 239 | 239 |
| | Color shift of 2D | C | C | C | C | B | A |
| | Visibility of 3D | A | A | A | A | A | A |

TABLE 26

| | | Comparative | Comparative | Comparative | Comparative |
|---|---|---|---|---|---|
| | | example 7 | example 8 | example 9 | example 10 |
| Structure | | FIG. 4 | FIG. 4 | FIG. 4 | FIG. 4 |
| Fourth polarizing film | Angle of the absorption axis | 0° | 0° | 0° | 0° |
| | seen from the front | | | | |
| | Angle of the transmission | 90° | 90° | 90° | 90° |
| | axis seen from the front | | | | |
| Liquid crystal cell for | Mode | VA | VA | VA | VA |
| image display | | | | | |
| Third polarizing film | Angle of the absorption axis | 90° | 90° | 90° | 90° |
| | seen from the front | | | | |
| Second polarizing film | Angle of the absorption axis | 90° | 90° | 90° | 90° |
| | seen from the front | | | | |
| First retardation film | Type | Film 19 | Film 16 | Film 13 | Film 20 |
| | Re (nm) | −40 | 100 | 100 | 30 |
| | Rth (nm) | 150 | 190 | 230 | −17 |
| | Slow axis angle | Orthogonal | Orthogonal | Orthogonal | Orthogonal |
| Liquid crystal cell for | Δnd (nm) | 400 | 400 | 400 | 400 |
| barrier element | Mode | TN | TN | TN | TN |
| | Disposition (E/O Mode) | E | O | E | O |
| Second retardation film | Type | Film 19 | Film 16 | Film 13 | Film 20 |
| | Re (nm) | −40 | 100 | 100 | 30 |
| | Rth (nm) | 150 | 190 | 230 | −17 |
| | Slow axis angle | Parallel | Parallel | Parallel | Parallel |
| First polarizing film | Angle of the absorption axis | 0° | 0° | 0° | 0° |
| | seen from the front | | | | |
| | Transmission (%) | 41.8 | 41.8 | 41.8 | 41.8 |
| Transmission of third polarizing film (%) | | 41.8 | 41.8 | 41.8 | 41.8 |
| Evaluation | Front brightness of 2D (%) | A | A | A | A |
| | | 114 | 114 | 114 | 114 |
| | Brightness in the lateral | A | A | A | A |
| | direction of 2D (%) | 201 | 200 | 200 | 200 |
| | Color shift of 2D | E | C | E | B |
| | Visibility of 3D | C | C | B | C |

TABLE 27

| | | Example 76 | Example 77 | Example 78 | Example 79 | Example 80 |
|---|---|---|---|---|---|---|
| Structure | | FIG. 8b | FIG. 8b | FIG. 8b | FIG. 8b | FIG. 8b |
| First polarizing film | Angle of the absorption axis | 90° | 90° | 90° | 135° | 45° |
| | seen from the front | | | | | |
| | Angle of the transmission | 0° | 0° | 0° | 45° | 135° |
| | axis seen from the front | | | | | |
| First retardation film | Type | Film 1 | Film 30 | Film 11 | Film 1 | Film 1 |
| | Re (nm) | 50 | 50 | 50 | 50 | 50 |
| | Rth (nm) | 120 | 120 | 120 | 120 | 120 |
| | Slow axis angle | Parallel | Parallel | Parallel | Parallel | Parallel |
| Liquid crystal cell for | Δnd (nm) | 400 | 400 | 400 | 400 | 400 |
| barrier element | Mode | TN | TN | TN | TN | TN |
| | Disposition (E/O Mode) | E | E | E | E | E |
| Second retardation film | Type | Film 1 | Film 30 | Film 11 | Film 1 | Film 1 |
| | Re (nm) | 50 | 50 | 50 | 50 | 50 |
| | Rth (nm) | 120 | 120 | 120 | 120 | 120 |
| | Slow axis angle | Orthogonal | Orthogonal | Orthogonal | Orthogonal | Orthogonal |
| Second polarizing film | Angle of the absorption axis | 0° | 0° | 0° | 45° | 135° |
| | seen from the front | | | | | |
| Third polarizing film | Angle of the absorption axis | 0° | 0° | 0° | 45° | 135° |
| | seen from the front | | | | | |
| Liquid crystal cell for | Mode | VA | VA | VA | VA | VA |
| image display | | | | | | |
| Fourth polarizing film | Angle of the absorption axis | 90° | 90° | 90° | 135° | 45° |
| | seen from the front | | | | | |
| Transmission of first polarizing film (%) | | 41.8 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 114 | 114 | 114 | 114 | 114 |
| | Brightness in the lateral | A | A | A | A | A |
| | direction of 2D (%) | 200 | 200 | 200 | 100 | 139 |
| | Color shift of 2D | D | D | D | D | D |
| | Visibility of 3D | B | B | B | B | B |

TABLE 28

| | | Example 81 | Example 82 | Example 83 | Example 84 | Example 85 |
|---|---|---|---|---|---|---|
| Structure | | FIG. 8b | FIG. 8b | FIG. 8b | FIG. 8b | FIG. 8b |
| First polarizing film | Angle of the absorption axis | 90° | 90° | 90° | 90° | 90° |
| | seen from the front | | | | | |
| | Angle of the transmission | 0° | 0° | 0° | 0° | 0° |
| | axis seen from the front | | | | | |
| First retardation film | Type | Film 1 | Film 1 | Film 4 | Film 1 | Film 9 |
| | Re (nm) | 50 | 50 | 0 | 50 | 10 |
| | Rth (nm) | 120 | 120 | 60 | 120 | 150 |
| | Slow axis angle | Parallel | Parallel | Parallel | Parallel | Parallel |
| Liquid crystal cell for | Δnd (nm) | 400 | 290 | 290 | 400 | 400 |
| barrier element | Mode | TN | VA | VA | TN | TN |
| | Disposition (E/O Mode) | E | — | — | O | E |
| Second retardation film | Type | Film 1 | Film 1 | Film 12 | Film 1 | Film 9 |
| | Re (nm) | 50 | 50 | 80 | 50 | 10 |
| | Rth (nm) | 120 | 120 | 180 | 120 | 150 |
| | Slow axis angle | Orthogonal | Orthogonal | Orthogonal | Orthogonal | Orthogonal |
| Second polarizing film | Angle of the absorption axis | 0° | 0° | 0° | 0° | 0° |
| | seen from the front | | | | | |
| Third polarizing film | Angle of the absorption axis | 0° | 0° | 0° | 0° | 0° |
| | seen from the front | | | | | |
| Liquid crystal cell for | Mode | VA | VA | VA | VA | VA |
| image display | | | | | | |
| Fourth polarizing film | Angle of the absorption axis | 90° | 90° | 90° | 90° | 90° |
| | seen from the front | | | | | |
| Transmission of first polarizing film (%) | | 43.4 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 121 | 100 | 100 | 114 | 114 |
| | Brightness in the lateral | A | A | A | A | A |
| | direction of 2D (%) | 211 | 175 | 175 | 195 | 200 |
| | Color shift of 2D | D | C | C | B | D |
| | Visibility of 3D | B | A | B | B | B |

TABLE 29

| | | Example 86 | Example 87 | Example 88 | Example 89 | Example 90 |
|---|---|---|---|---|---|---|
| Structure | | FIG. 8b | FIG. 8b | FIG. 8b | FIG. 8b | FIG. 8b |
| First polarizing film | Angle of the absorption axis | 90° | 90° | 90° | 90° | 90° |
| | seen from the front | | | | | |
| | Angle of the transmission | 0° | 0° | 0° | 0° | 0° |
| | axis seen from the front | | | | | |
| First retardation film | Type | Film 9 | Film 9 | Film 15 | Film 2 | Film 3 |
| | Re (nm) | 10 | 10 | −30 | 0 | 80 |
| | Rth (nm) | 150 | 150 | 90 | 150 | 140 |
| | Slow axis angle | 10° | −10° | Parallel | Parallel | Parallel |
| Liquid crystal cell for | Δnd (nm) | 400 | 400 | 400 | 400 | 400 |
| barrier element | Mode | TN | TN | TN | TN | TN |
| | Disposition (E/O Mode) | E | E | E | O | E |
| Second retardation film | Type | Film 9 | Film 9 | Film 15 | Film 2 | Film 3 |
| | Re (nm) | 10 | 10 | −30 | 0 | 80 |
| | Rth (nm) | 150 | 150 | 90 | 150 | 140 |
| | Slow axis angle | 100° | 80° | Orthogonal | Orthogonal | Orthogonal |
| Second polarizing film | Angle of the absorption axis | 0° | 0° | 0° | 0° | 0° |
| | seen from the front | | | | | |
| Third polarizing film | Angle of the absorption axis | 0° | 0° | 0° | 0° | 0° |
| | seen from the front | | | | | |
| Liquid crystal cell for | Mode | VA | VA | VA | VA | VA |
| image display | | | | | | |
| Fourth polarizing film | Angle of the absorption axis | 90° | 90° | 90° | 90° | 90° |
| | seen from the front | | | | | |
| Transmission of first polarizing film (%) | | 41.8 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 107 | 106 | 114 | 114 | 114 |
| | Brightness in the lateral | A | A | A | A | A |
| | direction of 2D (%) | 186 | 183 | 201 | 196 | 200 |
| | Color shift of 2D | D | D | D | C | C |
| | Visibility of 3D | B | B | B | B | B |

TABLE 30

| | | Example 91 | Example 92 | Example 93 | Example 94 | Example 95 |
|---|---|---|---|---|---|---|
| Structure | | FIG. 8b | FIG. 8b | FIG. 8b | FIG. 8b | FIG. 8b |
| First polarizing film | Angle of the absorption axis | 90° | 90° | 90° | 90° | 90° |
| | seen from the front | | | | | |
| | Angle of the transmission | 0° | 0° | 0° | 0° | 0° |
| | axis seen from the front | | | | | |
| First retardation film | Type | Film 4 | Film 4 | Film 21 | Film 22 | Film 1 |
| | Re (nm) | 0 | 0 | −10 | 20 | 50 |
| | Rth (nm) | 60 | 60 | 80 | 120 | 120 |
| | Slow axis angle | Parallel | Parallel | Parallel | Parallel | Parallel |
| Liquid crystal cell for | Δnd (nm) | 400 | 400 | 400 | 400 | 460 |
| barrier element | Mode | TN | TN | TN | TN | TN |
| | Disposition (E/O Mode) | E | O | O | O | E |
| Second retardation film | Type | Film 4 | Film 4 | Film 21 | Film 22 | Film 1 |
| | Re (nm) | 0 | 0 | −10 | 20 | 50 |
| | Rth (nm) | 60 | 60 | 80 | 120 | 120 |
| | Slow axis angle | Orthogonal | Orthogonal | Orthogonal | Orthogonal | Orthogonal |
| Second polarizing film | Angle of the absorption axis | 0° | 0° | 0° | 0° | 0° |
| | seen from the front | | | | | |
| Third polarizing film | Angle of the absorption axis | 0° | 0° | 0° | 0° | 0° |
| | seen from the front | | | | | |
| Liquid crystal cell for | Mode | VA | VA | VA | VA | VA |
| image display | | | | | | |
| Fourth polarizing film | Angle of the absorption axis | 90° | 90° | 90° | 90° | 90° |
| | seen from the front | | | | | |
| Transmission of first polarizing film (%) | | 41.8 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 114 | 114 | 114 | 114 | 120 |
| | Brightness in the lateral | A | A | A | A | A |
| | direction of 2D (%) | 201 | 196 | 203 | 203 | 210 |
| | Color shift of 2D | D | B | C | C | D |
| | Visibility of 3D | B | B | A | A | B |

TABLE 31

| | | Example 96 | Example 97 | Example 98 | Example 99 | Example 100 |
|---|---|---|---|---|---|---|
| Structure | | FIG. 8b | FIG. 8b | FIG. 8b | FIG. 8b | FIG. 8a |
| First polarizing film | Angle of the absorption axis | 90° | 90° | 90° | 90° | 90° |
| | seen from the front | | | | | |
| | Angle of the transmission | 0° | 0° | 0° | 0° | 0° |
| | axis seen from the front | | | | | |
| First retardation film | Type | Film 1 | Film 28 | Film 29 | Film 29 | Film 1 |
| | Re (nm) | 50 | 10 | 10 | 10 | 50 |
| | Rth (nm) | 120 | 100 | 135 | 135 | 120 |
| | Slow axis angle | Parallel | Parallel | Parallel | Parallel | Parallel |
| Liquid crystal cell for | Δnd (nm) | 460 | 460 | 460 | 460 | 400 |
| barrier element | Mode | TN | TN | TN | TN | TN |
| | Disposition (E/O Mode) | O | O | O | O | E |
| Second retardation film | Type | Film 1 | Film 28 | Film 29 | Film 29 | Film 1 |
| | Re (nm) | 50 | 10 | 10 | 10 | 50 |
| | Rth (nm) | 120 | 100 | 135 | 135 | 120 |
| | Slow axis angle | Orthogonal | Orthogonal | Orthogonal | Orthogonal | Orthogonal |
| Second polarizing film | Angle of the absorption axis | 0° | 0° | 0° | 0° | — |
| | seen from the front | | | | | |
| Third polarizing film | Angle of the absorption axis | 0° | 0° | 0° | 0° | 0° |
| | seen from the front | | | | | |
| Liquid crystal cell for | Mode | VA | VA | VA | VA | VA |
| image display | | | | | | |
| Fourth polarizing film | Angle of the absorption axis | 90° | 90° | 90° | 90° | 90° |
| | seen from the front | | | | | |
| Transmission of first polarizing film (%) | | 41.8 | 41.8 | 41.8 | 43.4 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 120 | 120 | 120 | 126 | 130 |
| | Brightness in the lateral | A | A | A | A | A |
| | direction of 2D (%) | 205 | 209 | 213 | 225 | 228 |
| | Color shift of 2D | B | C | C | C | D |
| | Visibility of 3D | B | A | A | A | B |

TABLE 32

| | | Example 101 | Example 102 | Example 103 | Example 104 | Example 105 |
|---|---|---|---|---|---|---|
| Structure | | FIG. 8a | FIG. 8a | FIG. 8a | FIG. 8a | FIG. 8a |
| First polarizing film | Angle of the absorption axis | 90° | 90° | 90° | 90° | 90° |
| | seen from the front | | | | | |
| | Angle of the transmission | 0° | 0° | 0° | 0° | 0° |
| | axis seen from the front | | | | | |
| First retardation film | Type | Film 1 | Film 21 | Film 22 | Film 1 | Film 28 |
| | Re (nm) | 50 | −10 | 20 | 50 | 10 |
| | Rth (nm) | 120 | 80 | 120 | 120 | 100 |
| | Slow axis angle | Parallel | Parallel | Parallel | Parallel | Parallel |
| Liquid crystal cell for | Δnd (nm) | 400 | 400 | 400 | 460 | 460 |
| barrier element | Mode | TN | TN | TN | TN | TN |
| | Disposition (E/O Mode) | E | O | O | E | O |
| Second retardation film | Type | Film 1 | Film 21 | Film 22 | Film 1 | Film 28 |
| | Re (nm) | 50 | −10 | 20 | 50 | 10 |
| | Rth (nm) | 120 | 80 | 120 | 120 | 100 |
| | Slow axis angle | Orthogonal | Orthogonal | Orthogonal | Orthogonal | Orthogonal |
| Second polarizing film | Angle of the absorption axis | — | — | — | — | — |
| | seen from the front | | | | | |
| Third polarizing film | Angle of the absorption axis | 0° | 0° | 0° | 0° | 0° |
| | seen from the front | | | | | |
| Liquid crystal cell for | Mode | VA | VA | VA | VA | VA |
| image display | | | | | | |
| Fourth polarizing film | Angle of the absorption axis | 90° | 90° | 90° | 90° | 90° |
| | seen from the front | | | | | |
| Transmission of first polarizing film (%) | | 43.4 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 138 | 130 | 130 | 137 | 137 |
| | Brightness in the lateral | A | A | A | A | A |
| | direction of 2D (%) | 241 | 231 | 231 | 239 | 239 |
| | Color shift of 2D | D | C | C | D | C |
| | Visibility of 3D | B | A | A | B | A |

TABLE 33

| | | Example 106 | Example 107 | Example 108 | Example 109 |
|---|---|---|---|---|---|
| Structure | | FIG. 8a | FIG. 8a | FIG. 8a | FIG. 8a |
| First polarizing film | Angle of the absorption axis | 90° | 90° | 90° | 90° |
| | seen from the front | | | | |
| | Angle of the transmission | 0° | 0° | 0° | 0° |
| | axis seen from the front | | | | |
| First retardation film | Type | Film 23 | Film 18 | Film 17 | Film 14 |
| | Re (nm) | 10 | 100 | 100 | −3 |
| | Rth (nm) | 100 | 110 | 150 | 40 |
| | Slow axis angle | Parallel | Parallel | Parallel | Parallel |
| Liquid crystal cell for | Δnd (nm) | 460 | 460 | 460 | 460 |
| barrier element | Mode | TN | TN | TN | TN |
| | Disposition (E/O Mode) | O | O | O | O |
| Second retardation film | Type | Film 23 | Film 28 | Film 24 | Film 25 |
| | Re (nm) | 10 | 10 | 10 | 80 |
| | Rth (nm) | 100 | 100 | 100 | 180 |
| | Slow axis angle | Orthogonal | Orthogonal | Orthogonal | Orthogonal |
| Second polarizing film | Angle of the absorption axis | — | — | — | — |
| | seen from the front | | | | |
| Third polarizing film | Angle of the absorption axis | 0° | 0° | 0° | 0° |
| | seen from the front | | | | |
| Liquid crystal cell for | Mode | VA | VA | VA | VA |
| image display | | | | | |
| Fourth polarizing film | Angle of the absorption axis | 90° | 90° | 90° | 90° |
| | seen from the front | | | | |
| Transmission of first polarizing film (%) | | 41.8 | 41.8 | 41.8 | 41.8 |
| Transmission of third polarizing film (%) | | 41.8 | 41.8 | 41.8 | 41.8 |
| Evaluation | Front brightness of 2D (%) | A | A | A | A |
| | | 137 | 137 | 137 | 137 |
| | Brightness in the lateral | A | A | A | A |
| | direction of 2D (%) | 239 | 237 | 236 | 232 |
| | Color shift of 2D | A | C | C | C |
| | Visibility of 3D | A | A | A | A |

TABLE 34

| | | Example 110 | Example 111 | Example 112 | Example 113 |
|---|---|---|---|---|---|
| Structure | | FIG. 8a | FIG. 8a | FIG. 8a | FIG. 8a |
| First polarizing film | Angle of the absorption axis | 90° | 90° | 90° | 90° |
| | seen from the front | | | | |
| | Angle of the transmission | 0° | 0° | 0° | 0° |
| | axis seen from the front | | | | |
| First retardation film | Type | Film 29 | Film 29 | Film 26 | Film 27 |
| | Re (nm) | 10 | 10 | 10 | 10 |
| | Rth (nm) | 135 | 135 | 135 | 135 |
| | Slow axis angle | Parallel | Parallel | Parallel | Parallel |
| Liquid crystal cell for | Δnd (nm) | 460 | 460 | 460 | 460 |
| barrier element | Mode | TN | TN | TN | TN |
| | Disposition (E/O Mode) | O | O | O | O |
| Second retardation film | Type | Film 29 | Film 29 | Film 26 | Film 27 |
| | Re (nm) | 10 | 10 | 10 | 10 |
| | Rth (nm) | 135 | 135 | 135 | 135 |
| | Slow axis angle | Orthogonal | Orthogonal | Orthogonal | Orthogonal |
| Second polarizing film | Angle of the absorption axis | — | — | — | — |
| | seen from the front | | | | |
| Third polarizing film | Angle of the absorption axis | 0° | 0° | 0° | 0° |
| | seen from the front | | | | |
| Liquid crystal cell for | Mode | VA | VA | VA | VA |
| image display | | | | | |
| Fourth polarizing film | Angle of the absorption axis | 90° | 90° | 90° | 90° |
| | seen from the front | | | | |
| Transmission of first polarizing film (%) | | 41.8 | 43.4 | 43.4 | 41.8 |
| Transmission of third polarizing film (%) | | 41.8 | 41.8 | 41.8 | 41.8 |
| Evaluation | Front brightness of 2D (%) | A | A | A | A |
| | | 137 | 145 | 137 | 137 |
| | Brightness in the lateral | A | A | A | A |
| | direction of 2D (%) | 239 | 253 | 239 | 239 |
| | Color shift of 2D | C | C | B | A |
| | Visibility of 3D | A | A | A | A |

TABLE 35

| | | Comparative | Comparative | Comparative | Comparative | Comparative | Comparative |
|---|---|---|---|---|---|---|---|
| | | example 11 | example 12 | example 13 | example 14 | example 15 | example 16 |
| Structure | | — | — | FIG. 8b | FIG. 8b | FIG. 8b | FIG. 8b |
| First polarizing film | Angle of the absorption axis | — | — | 90° | 90° | 90° | 90° |
| | seen from the front | | | | | | |
| | Angle of the transmission | — | — | 0° | 0° | 0° | 0° |
| | axis seen from the front | | | | | | |
| First retardation film | Type | — | — | Film 19 | Film 16 | Film 13 | Film 20 |
| | Re (nm) | — | — | −40 | 100 | 100 | 30 |
| | Rth (nm) | — | — | 150 | 190 | 230 | −17 |
| | Slow axis angle | — | — | Parallel | Parallel | Parallel | Parallel |
| Liquid crystal cell | Δnd (nm) | — | — | 400 | 400 | 400 | 400 |
| for barrier element | Mode | — | — | TN | TN | TN | TN |
| | Disposition (E/O Mode) | — | — | E | O | E | O |
| Second retardation | Type | — | — | Film 19 | Film 16 | Film 13 | Film 20 |
| film | Re (nm) | — | — | −40 | 100 | 100 | 30 |
| | Rth (nm) | — | — | 150 | 190 | 230 | −17 |
| | Slow axis angle | — | — | Orthogonal | Orthogonal | Orthogonal | Orthogonal |
| Second polarizing | Angle of the absorption axis | — | — | 0° | 0° | 0° | 0° |
| film | seen from the front | | | | | | |
| Third polarizing | Angle of the absorption axis | 0° | 90° | 0° | 0° | 0° | 0° |
| film | seen from the front | | | | | | |
| Liquid crystal cell | Mode | VA | VA | VA | VA | VA | VA |
| for image display | | | | | | | |
| Fourth polarizing | Angle of the absorption axis | 90° | 0° | 90° | 90° | 90° | 90° |
| film | seen from the front | | | | | | |
| Transmission of first polarizing film (%) | | — | — | 41.8 | 41.8 | 41.8 | 41.8 |
| Transmission of third polarizing film (%) | | — | — | 41.8 | 41.8 | 41.8 | 41.8 |
| Evaluation | Front brightness of 2D (%) | B | B | A | A | A | A |
| | | | | 114 | 114 | 114 | 114 |
| | Brightness in the lateral | B | B | A | A | A | A |
| | direction of 2D (%) | | | 201 | 200 | 200 | 200 |
| | Color shift of 2D | — | — | E | C | E | B |
| | Visibility of 3D | — | — | C | C | B | C |

TABLE 36

| | | Example 114 | Example 115 | Example 116 | Example 117 | Example 118 |
|---|---|---|---|---|---|---|
| Structure | | FIG. 6 | FIG. 6 | FIG. 6 | FIG. 6 | FIG. 6 |
| First polarizing film | Angle of the absorption axis | 0° | 0° | 0° | 0° | 0° |
| | seen from the front | | | | | |
| | Angle of the transmission | 90° | 90° | 90° | 90° | 90° |
| | axis seen from the front | | | | | |
| First retardation film | Type | Film 1 | Film 30 | Film 11 | Film 1 | Film 1 |
| | Re (nm) | 50 | 50 | 50 | 50 | 50 |
| | Rth (nm) | 120 | 120 | 120 | 120 | 120 |
| | Slow axis angle | Parallel | Parallel | Parallel | Parallel | Parallel |
| Liquid crystal cell for | Δnd (nm) | 400 | 400 | 400 | 400 | 290 |
| barrier element | Mode | TN | TN | TN | TN | VA |
| | Disposition (E/O Mode) | E | E | E | E | — |
| Second retardation film | Type | Film 1 | Film 30 | Film 11 | Film 1 | Film 1 |
| | Re (nm) | 50 | 50 | 50 | 50 | 50 |
| | Rth (nm) | 120 | 120 | 120 | 120 | 120 |
| | Slow axis angle | Orthogonal | Orthogonal | Orthogonal | Orthogonal | Orthogonal |
| Second polarizing film | Angle of the absorption axis | 90° | 90° | 90° | 90° | 90° |
| | seen from the front | | | | | |
| Third polarizing film | Angle of the absorption axis | 90° | 90° | 90° | 90° | 90° |
| | seen from the front | | | | | |
| Liquid crystal cell for | Mode | VA | VA | VA | VA | VA |
| image display | | | | | | |
| Fourth polarizing film | Angle of the absorption axis | 0° | 0° | 0° | 0° | 0° |
| | seen from the front | | | | | |
| Transmission of first polarizing film (%) | | 41.8 | 41.8 | 41.8 | 43.4 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 114 | 114 | 114 | 121 | 100 |
| | Brightness in the lateral | A | A | A | A | A |
| | direction of 2D (%) | 200 | 200 | 200 | 211 | 175 |
| | Color shift of 2D | D | D | D | D | C |
| | Visibility of 3D | B | B | B | B | A |

TABLE 37

| | | Example 119 | Example 120 | Example 121 | Example 122 | Example 123 |
|---|---|---|---|---|---|---|
| Structure | | FIG. 6 | FIG. 6 | FIG. 6 | FIG. 6 | FIG. 6 |
| First polarizing film | Angle of the absorption axis | 0° | 0° | 0° | 0° | 0° |
| | seen from the front | | | | | |
| | Angle of the transmission | 90° | 90° | 90° | 90° | 90° |
| | axis seen from the front | | | | | |
| First retardation film | Type | Film 4 | Film 1 | Film 9 | Film 9 | Film 9 |
| | Re (nm) | 0 | 50 | 10 | 10 | 10 |
| | Rth (nm) | 60 | 120 | 150 | 150 | 150 |
| | Slow axis angle | Parallel | Parallel | Parallel | 100° | 80° |
| Liquid crystal cell for | Δnd (nm) | 290 | 400 | 400 | 400 | 400 |
| barrier element | Mode | VA | TN | TN | TN | TN |
| | Disposition (E/O Mode) | — | O | E | E | E |
| Second retardation film | Type | Film 12 | Film 1 | Film 9 | Film 9 | Film 9 |
| | Re (nm) | 80 | 50 | 10 | 10 | 10 |
| | Rth (nm) | 180 | 120 | 150 | 150 | 150 |
| | Slow axis angle | Orthogonal | Orthogonal | Orthogonal | Orthogonal | Orthogonal |
| Second polarizing film | Angle of the absorption axis | 90° | 90° | 90° | 90° | 90° |
| | seen from the front | | | | | |
| Third polarizing film | Angle of the absorption axis | 90° | 90° | 90° | 90° | 90° |
| | seen from the front | | | | | |
| Liquid crystal cell for | Mode | VA | VA | VA | VA | VA |
| image display | | | | | | |
| Fourth polarizing film | Angle of the absorption axis | 0° | 0° | 0° | 0° | 0° |
| | seen from the front | | | | | |
| Transmission of first polarizing film (%) | | 41.8 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 100 | 114 | 114 | 107 | 106 |
| | Brightness in the lateral | A | A | A | A | A |
| | direction of 2D (%) | 175 | 195 | 200 | 186 | 183 |
| | Color shift of 2D | C | B | D | D | D |
| | Visibility of 3D | B | B | B | B | B |

TABLE 38

| | | Example 124 | Example 125 | Example 126 | Example 127 | Example 128 |
|---|---|---|---|---|---|---|
| Structure | | FIG. 6 | FIG. 6 | FIG. 6 | FIG. 6 | FIG. 6 |
| First polarizing film | Angle of the absorption axis | 0° | 0° | 0° | 0° | 0° |
| | seen from the front | | | | | |
| | Angle of the transmission | 90° | 90° | 90° | 90° | 90° |
| | axis seen from the front | | | | | |
| First retardation film | Type | Film 15 | Film 2 | Film 3 | Film 4 | Film 4 |
| | Re (nm) | −30 | 0 | 80 | 0 | 0 |
| | Rth (nm) | 90 | 150 | 140 | 60 | 60 |
| | Slow axis angle | Parallel | Parallel | Parallel | Parallel | Parallel |
| Liquid crystal cell for | Δnd (nm) | 400 | 400 | 400 | 400 | 400 |
| barrier element | Mode | TN | TN | TN | TN | TN |
| | Disposition (E/O Mode) | E | O | E | E | O |
| Second retardation film | Type | Film 15 | Film 2 | Film 3 | Film 4 | Film 4 |
| | Re (nm) | −30 | 0 | 80 | 0 | 0 |
| | Rth (nm) | 90 | 150 | 140 | 60 | 60 |
| | Slow axis angle | Orthogonal | Orthogonal | Orthogonal | Orthogonal | Orthogonal |
| Second polarizing film | Angle of the absorption axis | 90° | 90° | 90° | 90° | 90° |
| | seen from the front | | | | | |
| Third polarizing film | Angle of the absorption axis | 90° | 90° | 90° | 90° | 90° |
| | seen from the front | | | | | |
| Liquid crystal cell for | Mode | VA | VA | VA | VA | VA |
| image display | | | | | | |
| Fourth polarizing film | Angle of the absorption axis | 0° | 0° | 0° | 0° | 0° |
| | seen from the front | | | | | |
| Transmission of first polarizing film (%) | | 41.8 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 114 | 114 | 114 | 114 | 114 |
| | Brightness in the lateral | A | A | A | A | A |
| | direction of 2D (%) | 201 | 196 | 200 | 201 | 196 |
| | Color shift of 2D | D | C | C | D | B |
| | Visibility of 3D | B | B | B | B | B |

TABLE 39

| | | Example 129 | Example 130 | Example 131 | Example 132 | Example 133 |
|---|---|---|---|---|---|---|
| Structure | | FIG. 6 | FIG. 6 | FIG. 6 | FIG. 6 | FIG. 6 |
| First polarizing film | Angle of the absorption axis | 0° | 0° | 0° | 0° | 0° |
| | seen from the front | | | | | |
| | Angle of the transmission | 90° | 90° | 90° | 90° | 90° |
| | axis seen from the front | | | | | |
| First retardation film | Type | Film 21 | Film 22 | Film 1 | Film 1 | Film 28 |
| | Re (nm) | −10 | 20 | 50 | 50 | 10 |
| | Rth (nm) | 80 | 120 | 120 | 120 | 100 |
| | Slow axis angle | Parallel | Parallel | Parallel | Parallel | Parallel |
| Liquid crystal cell for | Δnd (nm) | 400 | 400 | 460 | 460 | 460 |
| barrier element | Mode | TN | TN | TN | TN | TN |
| | Disposition (E/O Mode) | O | O | E | O | O |
| Second retardation film | Type | Film 21 | Film 22 | Film 1 | Film 1 | Film 28 |
| | Re (nm) | −10 | 20 | 50 | 50 | 10 |
| | Rth (nm) | 80 | 120 | 120 | 120 | 100 |
| | Slow axis angle | Orthogonal | Orthogonal | Orthogonal | Orthogonal | Orthogonal |
| Second polarizing film | Angle of the absorption axis | 90° | 90° | 90° | 90° | 90° |
| | seen from the front | | | | | |
| Third polarizing film | Angle of the absorption axis | 90° | 90° | 90° | 90° | 90° |
| | seen from the front | | | | | |
| Liquid crystal cell for | Mode | VA | VA | VA | VA | VA |
| image display | | | | | | |
| Fourth polarizing film | Angle of the absorption axis | 0° | 0° | 0° | 0° | 0° |
| | seen from the front | | | | | |
| Transmission of first polarizing film (%) | | 41.8 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 114 | 114 | 120 | 120 | 120 |
| | Brightness in the lateral | A | A | A | A | A |
| | direction of 2D (%) | 203 | 203 | 210 | 205 | 209 |
| | Color shift of 2D | C | C | D | B | C |
| | Visibility of 3D | A | A | B | B | A |

TABLE 40

| | | Example 134 | Example 135 | Example 136 | Example 137 | Example 138 |
|---|---|---|---|---|---|---|
| Structure | | FIG. 6 | FIG. 6 | FIG. 5 | FIG. 5 | FIG. 5 |
| First polarizing film | Angle of the absorption axis | 0° | 0° | 0° | 0° | 0° |
| | seen from the front | | | | | |
| | Angle of the transmission | 90° | 90° | 90° | 90° | 90° |
| | axis seen from the front | | | | | |
| First retardation film | Type | Film 29 | Film 29 | Film 1 | Film 1 | Film 21 |
| | Re (nm) | 10 | 10 | 50 | 50 | −10 |
| | Rth (nm) | 135 | 135 | 120 | 120 | 80 |
| | Slow axis angle | Parallel | Parallel | Parallel | Parallel | Parallel |
| Liquid crystal cell for | Δnd (nm) | 460 | 460 | 400 | 400 | 400 |
| barrier element | Mode | TN | TN | TN | TN | TN |
| | Disposition (E/O Mode) | O | O | E | E | O |
| Second retardation film | Type | Film 29 | Film 29 | Film 1 | Film 1 | Film 21 |
| | Re (nm) | 10 | 10 | 50 | 50 | −10 |
| | Rth (nm) | 135 | 135 | 120 | 120 | 80 |
| | Slow axis angle | Orthogonal | Orthogonal | Orthogonal | Orthogonal | Orthogonal |
| Second polarizing film | Angle of the absorption axis | 90° | 90° | — | — | — |
| | seen from the front | | | | | |
| Third polarizing film | Angle of the absorption axis | 90° | 90° | 90° | 90° | 90° |
| | seen from the front | | | | | |
| Liquid crystal cell for | Mode | VA | VA | VA | VA | VA |
| Image display | | | | | | |
| Fourth polarizing film | Angle of the absorption axis | 0° | 0° | 0° | 0° | 0° |
| | seen from the front | | | | | |
| Transmission of first polarizing film (%) | | 41.8 | 43.4 | 41.8 | 43.4 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 120 | 126 | 130 | 138 | 130 |
| | Brightness in the lateral | A | A | A | A | A |
| | direction of 2D (%) | 213 | 225 | 228 | 241 | 231 |
| | Color shift of 2D | C | C | D | D | C |
| | Visibility of 3D | A | A | B | B | A |

TABLE 41

| | | Example 139 | Example 140 | Example 141 | Example 142 | Example 143 |
|---|---|---|---|---|---|---|
| Structure | | FIG. 5 | FIG. 5 | FIG. 5 | FIG. 5 | FIG. 5 |
| First polarizing film | Angle of the absorption axis | 0° | 0° | 0° | 0° | 0° |
| | seen from the front | | | | | |
| | Angle of the transmission | 90° | 90° | 90° | 90° | 90° |
| | axis seen from the front | | | | | |
| First retardation film | Type | Film 22 | Film 1 | Film 28 | Film 23 | Film 18 |
| | Re (nm) | 20 | 50 | 10 | 10 | 100 |
| | Rth (nm) | 120 | 120 | 100 | 100 | 110 |
| | Slow axis angle | Parallel | Parallel | Parallel | Parallel | Parallel |
| Liquid crystal cell for | Δnd (nm) | 400 | 460 | 460 | 460 | 460 |
| barrier element | Mode | TN | TN | TN | TN | TN |
| | Disposition (E/O Mode) | O | E | O | O | O |
| Second retardation film | Type | Film 22 | Film 1 | Film 28 | Film 23 | Film 28 |
| | Re (nm) | 20 | 50 | 10 | 10 | 10 |
| | Rth (nm) | 120 | 120 | 100 | 100 | 100 |
| | Slow axis angle | Orthogonal | Orthogonal | Orthogonal | Orthogonal | Orthogonal |
| Second polarizing film | Angle of the absorption axis | — | — | — | — | — |
| | seen from the front | | | | | |
| Third polarizing film | Angle of the absorption axis | 90° | 90° | 90° | 90° | 90° |
| | seen from the front | | | | | |
| Liquid crystal cell for | Mode | VA | VA | VA | VA | VA |
| Image display | | | | | | |
| Fourth polarizing film | Angle of the absorption axis | 0° | 0° | 0° | 0° | 0° |
| | seen from the front | | | | | |
| Transmission of first polarizing film (%) | | 41.8 | 41.8 | 41.8 | 41.8 | 41.8 |
| Transmission of third polarizing film (%) | | 41.8 | 41.8 | 41.8 | 41.8 | 41.8 |
| Evaluation | Front brightness of 2D (%) | A | A | A | A | A |
| | | 130 | 137 | 137 | 137 | 137 |
| | Brightness in the lateral | A | A | A | A | A |
| | direction of 2D (%) | 231 | 239 | 239 | 239 | 237 |
| | Color shift of 2D | C | D | C | A | C |
| | Visibility of 3D | A | B | A | A | A |

TABLE 42

| | | Example 144 | Example 145 | Example 146 | Example 147 | Example 148 | Example 149 |
|---|---|---|---|---|---|---|---|
| Structure | | FIG. 5 | FIG. 5 | FIG. 5 | FIG. 5 | FIG. 5 | FIG. 5 |
| First polarizing film | Angle of the absorption axis | 0° | 0° | 0° | 0° | 0° | 0° |
| | seen from the front | | | | | | |
| | Angle of the transmission | 90° | 90° | 90° | 90° | 90° | 90° |
| | axis seen from the front | | | | | | |
| First retardation film | Type | Film 17 | Film 14 | Film 29 | Film 29 | Film 26 | Film 27 |
| | Re (nm) | 10 | −3 | 10 | 10 | 10 | 10 |
| | Rth (nm) | 100 | 40 | 135 | 135 | 135 | 135 |
| | Slow axis angle | Parallel | Parallel | Parallel | Parallel | Parallel | Parallel |
| Liquid crystal cell for | Δnd (nm) | 460 | 460 | 460 | 460 | 460 | 460 |
| barrier element | Mode | TN | TN | TN | TN | TN | TN |
| | Disposition (E/O Mode) | O | O | O | O | O | O |
| Second retardation film | Type | Film 24 | Film 25 | Film 29 | Film 29 | Film 26 | Film 27 |
| | Re (nm) | 10 | 80 | 10 | 10 | 10 | 10 |
| | Rth (nm) | 100 | 180 | 135 | 135 | 135 | 135 |
| | Slow axis angle | Orthogonal | Orthogonal | Orthogonal | Orthogonal | Orthogonal | Orthogonal |
| Second polarizing film | Angle of the absorption axis | — | — | — | — | — | — |
| | seen from the front | | | | | | |
| Third polarizing film | Angle of the absorption axis | 90° | 90° | 90° | 90° | 90° | 90° |
| | seen from the front | | | | | | |
| Liquid crystal cell for Image | Mode | VA | VA | VA | VA | VA | VA |
| display | | | | | | | |
| Fourth polarizing film | Angle of the absorption axis | 0° | 0° | 0° | 0° | 0° | 0° |
| | seen from the front | | | | | | |
| Transmission of first polarizing film (%) | | 41.8 | 41.8 | 41.8 | 43.4 | 41.8 | 41.8 |
| Transmission of third polarizing film (%) | | 41.8 | 41.8 | 41.8 | 41.8 | 41.8 | 41.8 |
| Evaluation | Front brightness of 2D (%) | A | A | A | A | A | A |
| | | 137 | 137 | 137 | 145 | 137 | 137 |
| | Brightness in the lateral | A | A | A | A | A | A |
| | direction of 2D (%) | 236 | 232 | 239 | 253 | 239 | 239 |
| | Color shift of 2D | C | C | C | C | B | A |
| | Visibility of 3D | A | A | A | A | A | A |

TABLE 43

| | | Comparative | Comparative | Comparative | Comparative |
|---|---|---|---|---|---|
| | | example 17 | example 18 | example 19 | example 20 |
| Structure | | FIG. 6 | FIG. 6 | FIG. 6 | FIG. 6 |
| First polarizing film | Angle of the absorption axis | 0° | 0° | 0° | 0° |
| | seen from the front | | | | |
| | Angle of the transmission | 90° | 90° | 90° | 90° |
| | axis seen from the front | | | | |
| First retardation film | Type | Film 19 | Film 16 | Film 13 | Film 20 |
| | Re (nm) | −40 | 100 | 100 | 30 |
| | Rth (nm) | 150 | 190 | 230 | −17 |
| | Slow axis angle | Parallel | Parallel | Parallel | Parallel |
| Liquid crystal cell for | Δnd (nm) | 400 | 400 | 400 | 400 |
| barrier element | Mode | TN | TN | TN | TN |
| | Disposition (E/O Mode) | E | O | E | O |
| Second retardation film | Type | Film 19 | Film 16 | Film 13 | Film 20 |
| | Re (nm) | −40 | 100 | 100 | 30 |
| | Rth (nm) | 150 | 190 | 230 | −17 |
| | Slow axis angle | Orthogonal | Orthogonal | Orthogonal | Orthogonal |
| Second polarizing film | Angle of the absorption axis | 90° | 90° | 90° | 90° |
| | seen from the front | | | | |
| Third polarizing film | Angle of the absorption axis | 90° | 90° | 90° | 90° |
| | seen from the front | | | | |
| Liquid crystal cell for | Mode | VA | VA | VA | VA |
| image display | | | | | |
| Fourth polarizing film | Angle of the absorption axis | 0° | 0° | 0° | 0° |
| | seen from the front | | | | |
| Transmission of first polarizing film (%) | | 41.8 | 41.8 | 41.8 | 41.8 |
| Transmission of third polarizing film (%) | | 41.8 | 41.8 | 41.8 | 41.8 |
| Evaluation | Front brightness of 2D (%) | A | A | A | A |
| | | 114 | 114 | 114 | 114 |
| | Brightness in the lateral | A | A | A | A |
| | direction of 2D (%) | 201 | 200 | 200 | 200 |
| | Color shift of 2D | E | C | E | B |
| | Visibility of 3D | C | C | B | C |

TABLE 44

| | | Example 150 | Example 151 | Example 152 | Example 153 | Example 154 | Example 155 |
|---|---|---|---|---|---|---|---|
| Structure | | FIG. 7a | FIG. 7a | FIG. 7a | FIG. 7a | FIG. 7a | FIG. 7a |
| Fourth polarizing film | Angle of the absorption axis seen | 90° | 90° | 90° | 90° | 90° | 90° |
| | from the front | | | | | | |
| | Angle of the transmission | 0° | 0° | 0° | 0° | 0° | 0° |
| | axis seen from the front | | | | | | |
| Liquid crystal cell for | Mode | VA | VA | VA | VA | VA | VA |
| Image display | | | | | | | |
| Third polarizing film | Angle of the absorption axis | 0° | 0° | 0° | 0° | 0° | 0° |
| | seen from the front | | | | | | |
| Second polarizing film | Angle of the absorption axis | — | — | — | — | — | — |
| | seen from the front | | | | | | |
| First retardation film | Type | Film 35 | Film 36 | Film 37 | Film 38 | Film 39 | Film 40 |
| | Re (nm) | 10 | 10 | −6 | −6 | −6 | −6 |
| | Rth (nm) | 135 | 135 | 90 | 90 | 90 | 90 |
| | Slow axis angle | Orthogonal | Orthogonal | Orthogonal | Orthogonal | Orthogonal | Orthogonal |
| Liquid crystal cell for | Δnd (nm) | 460 | 460 | 400 | 400 | 400 | 400 |
| barrier element | Mode | TN | TN | TN | TN | TN | TN |
| | Disposition (E/O Mode) | O | O | O | O | O | O |
| Second retardation film | Type | Film 35 | Film 36 | Film 37 | Film 38 | Film 39 | Film 40 |
| | Re (nm) | 10 | 10 | −6 | −6 | −6 | −6 |
| | Rth (nm) | 135 | 135 | 90 | 90 | 90 | 90 |
| | Slow axis angle | Parallel | Parallel | Parallel | Parallel | Parallel | Parallel |
| First polarizing film | Angle of the absorption axis | 90° | 90° | 90° | 90° | 90° | 90° |
| | seen from the front | | | | | | |
| | Transmission (%) | 41.8 | 41.8 | 41.8 | 41.8 | 41.8 | 41.8 |
| Transmission of third polarizing film (%) | | 41.8 | 41.8 | 41.8 | 41.8 | 41.8 | 41.8 |
| Evaluation | Front brightness of 2D (%) | A | A | A | A | A | A |
| | | 137 | 137 | 137 | 137 | 137 | 137 |
| | Brightness in the lateral | A | A | A | A | A | A |
| | direction of 2D (%) | 239 | 239 | 239 | 239 | 239 | 239 |
| | Color shift of 2D | B | A | B | C | C | B |
| | Visibility of 3D | A | A | A | A | A | A |

TABLE 45

| | | Example 156 | Example 157 | Example 158 | Example 159 | Example 160 | Example 161 |
|---|---|---|---|---|---|---|---|
| Structure | | FIG. 3 | FIG. 3 | FIG. 3 | FIG. 3 | FIG. 3 | FIG. 3 |
| Fourth polarizing film | Angle of the absorption axis seen | 0° | 0° | 0° | 0° | 0° | 0° |
| | from the front | | | | | | |
| | Angle of the transmission | 90° | 90° | 90° | 90° | 90° | 90° |
| | axis seen from the front | | | | | | |
| Liquid crystal cell for | Mode | VA | VA | VA | VA | VA | VA |
| Image display | | | | | | | |
| Third polarizing film | Angle of the absorption axis | 90° | 90° | 90° | 90° | 90° | 90° |
| | seen from the front | | | | | | |
| Second polarizing film | Angle of the absorption axis | — | — | — | — | — | — |
| | seen from the front | | | | | | |
| First retardation film | Type | Film 35 | Film 36 | Film 37 | Film 38 | Film 39 | Film 40 |
| | Re (nm) | 10 | 10 | −6 | −6 | −6 | −6 |
| | Rth (nm) | 135 | 135 | 90 | 90 | 90 | 90 |
| | Slow axis angle | Orthogonal | Orthogonal | Orthogonal | Orthogonal | Orthogonal | Orthogonal |
| Liquid crystal cell for | Δnd (nm) | 460 | 460 | 400 | 400 | 400 | 400 |
| barrier element | Mode | TN | TN | TN | TN | TN | TN |
| | Disposition (E/O Mode) | O | O | O | O | O | O |
| Second retardation film | Type | Film 35 | Film 36 | Film 37 | Film 38 | Film 39 | Film 40 |
| | Re (nm) | 10 | 10 | −6 | −6 | −6 | −6 |
| | Rth (nm) | 135 | 135 | 90 | 90 | 90 | 90 |
| | Slow axis angle | Parallel | Parallel | Parallel | Parallel | Parallel | Parallel |
| First polarizing film | Angle of the absorption axis | 0° | 0° | 0° | 0° | 0° | 0° |
| | seen from the front | | | | | | |
| | Transmission (%) | 41.8 | 41.8 | 41.8 | 41.8 | 41.8 | 41.8 |
| Transmission of third polarizing film (%) | | 41.8 | 41.8 | 41.8 | 41.8 | 41.8 | 41.8 |
| Evaluation | Front brightness of 2D (%) | A | A | A | A | A | A |
| | | 137 | 137 | 137 | 137 | 137 | 137 |
| | Brightness in the lateral | A | A | A | A | A | A |
| | direction of 2D (%) | 239 | 239 | 239 | 239 | 239 | 239 |
| | Color shift of 2D | B | A | B | C | C | B |
| | Visibility of 3D | A | A | A | A | A | A |

TABLE 46

| | | Example 162 | Example 163 | Example 164 | Example 165 | Example 166 | Example 167 |
|---|---|---|---|---|---|---|---|
| Structure | | FIG. 8a | FIG. 8a | FIG. 8a | FIG. 8a | FIG. 8a | FIG. 8a |
| First polarizing film | Angle of the absorption axis seen | 90° | 90° | 90° | 90° | 90° | 90° |
| | from the front | | | | | | |
| | Angle of the transmission | 0° | 0° | 0° | 0° | 0° | 0° |
| | axis seen from the front | | | | | | |
| First retardation film | Type | Film 35 | Film 36 | Film 37 | Film 38 | Film 39 | Film 40 |
| | Re (nm) | 10 | 10 | −6 | −6 | −6 | −6 |
| | Rth (nm) | 135 | 135 | 90 | 90 | 90 | 90 |
| | Slow axis angle | Parallel | Parallel | Parallel | Parallel | Parallel | Parallel |
| Liquid crystal cell for | Δnd (nm) | 460 | 460 | 400 | 400 | 400 | 400 |
| barrier element | Mode | TN | TN | TN | TN | TN | TN |
| | Disposition (E/O Mode) | O | O | O | O | O | O |
| Second retardation film | Type | Film 35 | Film 36 | Film 37 | Film 38 | Film 39 | Film 40 |
| | Re (nm) | 10 | 10 | −6 | −6 | −6 | −6 |
| | Rth (nm) | 135 | 135 | 90 | 90 | 90 | 90 |
| | Slow axis angle | Orthogonal | Orthogonal | Orthogonal | Orthogonal | Orthogonal | Orthogonal |
| Second polarizing film | Angle of the absorption axis | — | — | — | — | — | — |
| | seen from the front | | | | | | |
| Third polarizing film | Angle of the absorption axis | 0° | 0° | 0° | 0° | 0° | 0° |
| | seen from the front | | | | | | |
| Liquid crystal cell for | Mode | VA | VA | VA | VA | VA | VA |
| Image display | | | | | | | |
| Fourth polarizing film | Angle of the absorption axis | 90° | 90° | 90° | 90° | 90° | 90° |
| | seen from the front | | | | | | |
| Transmission of first polarizing film (%) | | 41.8 | 41.8 | 41.8 | 41.8 | 41.8 | 41.8 |
| Transmission of third polarizing film (%) | | 41.8 | 41.8 | 41.8 | 41.8 | 41.8 | 41.8 |
| Evaluation | Front brightness of 2D (%) | A | A | A | A | A | A |
| | | 137 | 137 | 137 | 137 | 137 | 137 |
| | Brightness in the lateral | A | A | A | A | A | A |
| | direction of 2D (%) | 239 | 239 | 239 | 239 | 239 | 239 |
| | Color shift of 2D | B | A | B | C | C | B |
| | Visibility of 3D | A | A | A | A | A | A |

TABLE 47

| | | Example 168 | Example 169 | Example 170 | Example 171 | Example 172 | Example 173 |
|---|---|---|---|---|---|---|---|
| Structure | | FIG. 5 | FIG. 5 | FIG. 5 | FIG. 5 | FIG. 5 | FIG. 5 |
| First polarizing film | Angle of the absorption axis seen | 0° | 0° | 0° | 0° | 0° | 0° |
| | from the front | | | | | | |
| | Angle of the transmission | 90° | 90° | 90° | 90° | 90° | 90° |
| | axis seen from the front | | | | | | |
| First retardation film | Type | Film 35 | Film 36 | Film 37 | Film 38 | Film 39 | Film 40 |
| | Re (nm) | 10 | 10 | −6 | −6 | −6 | −6 |
| | Rth (nm) | 135 | 135 | 90 | 90 | 90 | 90 |
| | Slow axis angle | Parallel | Parallel | Parallel | Parallel | Parallel | Parallel |
| Liquid crystal cell for | Δnd (nm) | 460 | 460 | 400 | 400 | 400 | 400 |
| barrier element | Mode | TN | TN | TN | TN | TN | TN |
| | Disposition (E/O Mode) | O | O | O | O | O | O |
| Second retardation film | Type | Film 35 | Film 36 | Film 37 | Film 38 | Film 39 | Film 40 |
| | Re (nm) | 10 | 10 | −6 | −6 | −6 | −6 |
| | Rth (nm) | 135 | 135 | 90 | 90 | 90 | 90 |
| | Slow axis angle | Orthogonal | Orthogonal | Orthogonal | Orthogonal | Orthogonal | Orthogonal |
| Second polarizing film | Angle of the absorption axis | — | — | — | — | — | — |
| | seen from the front | | | | | | |
| Third polarizing film | Angle of the absorption axis | 90° | 90° | 90° | 90° | 90° | 90° |
| | seen from the front | | | | | | |
| Liquid crystal cell for | Mode | VA | VA | VA | VA | VA | VA |
| image display | | | | | | | |
| Fourth polarizing film | Angle of the absorption axis | 0° | 0° | 0° | 0° | 0° | 0° |
| | seen from the front | | | | | | |
| Transmission of first polarizing film (%) | | 41.8 | 41.8 | 41.8 | 41.8 | 41.8 | 41.8 |
| Transmission of third polarizing film (%) | | 41.8 | 41.8 | 41.8 | 41.8 | 41.8 | 41.8 |
| Evaluation | Front brightness of 2D (%) | A | A | A | A | A | A |
| | | 137 | 137 | 137 | 137 | 137 | 137 |
| | Brightness in the lateral | A | A | A | A | A | A |
| | direction of 2D (%) | 239 | 239 | 239 | 239 | 239 | 239 |
| | Color shift of 2D | B | A | B | C | C | B |
| | Visibility of 3D | A | A | A | A | A | A |

TABLE 48

| | | Example | Example | Example | Example | Example | Example | Example | Example |
|---|---|---|---|---|---|---|---|---|---|
| | | 198 | 199 | 200 | 201 | 202 | 203 | 204 | 205 |
| Structure | | FIG. 7a | FIG. 7a | FIG. 7a | FIG. 7a | FIG. 7a | FIG. 7a | FIG. 7a | FIG. 7a |
| Fourth polarizing film | Angle of the absorption axis | 90° | 90° | 90° | 90° | 90° | 90° | 90° | 90° |
| | seen from the front | | | | | | | | |
| | Angle of the transmission | 0° | 0° | 0° | 0° | 0° | 0° | 0° | 0° |
| | axis seen from the front | | | | | | | | |
| Liquid crystal cell for | Mode | VA | VA | VA | VA | VA | VA | VA | VA |
| Image display | | | | | | | | | |
| Third polarizing film | Angle of the absorption axis | 0° | 0° | 0° | 0° | 0° | 0° | 0° | 0° |
| | seen from the front | | | | | | | | |
| Second polarizing film | Angle of the absorption axis | — | — | — | — | — | — | — | — |
| | seen from the front | | | | | | | | |
| First retardation film | Type | Film 44 | Film 45 | Film 46 | Film 12 | Film 23 | Film 45 | Film 46 | Film 48 |
| | Re (nm) | −10 | −3 | −2 | 80 | 10 | −3 | −2 | −5 |
| | Rth (nm) | 80 | 40 | −5 | 180 | 100 | 40 | −5 | −15 |
| | Slow axis angle | Orthog- | Orthog- | Orthog- | Orthog- | Orthog- | Orthog- | Orthog- | Orthog- |
| | | onal | onal | onal | onal | onal | onal | onal | onal |
| Liquid crystal cell for | Δnd (nm) | 400 | 400 | 400 | 460 | 460 | 460 | 460 | 480 |
| barrier element | Mode | TN | TN | TN | TN | TN | TN | TN | TN |
| | Disposition (E/O Mode) | O | O | O | O | O | O | O | O |
| Second retardation | Type | Film 44 | Film 45 | Film 46 | Film 47 | Film 23 | Film 45 | Film 46 | Film 48 |
| film | Re (nm) | −10 | −3 | −2 | −5 | 10 | −3 | −2 | −5 |
| | Rth (nm) | 80 | 40 | −5 | −15 | 100 | 40 | −5 | −15 |
| | Slow axis angle | Parallel | Parallel | Parallel | Parallel | Parallel | Parallel | Parallel | Parallel |
| First polarizing film | Angle of the absorption axis | 90° | 90° | 90° | 90° | 90° | 90° | 90° | 90° |
| | seen from the front | | | | | | | | |
| | Transmission (%) | 41.8 | 41.8 | 41.8 | 41.8 | 41.8 | 41.8 | 41.8 | 41.8 |
| Transmission of third polarizing film (%) | | 41.8 | 41.8 | 41.8 | 41.8 | 41.8 | 41.8 | 41.8 | 41.8 |
| Evaluation | Front brightness of 2D (%) | A | A | A | A | A | A | A | A |
| | | 130 | 130 | 130 | 137 | 137 | 137 | 137 | 137 |
| | Brightness in the lateral | A | A | A | A | A | A | A | A |
| | direction of 2D (%) | 231 | 231 | 231 | 237 | 239 | 239 | 239 | 239 |
| | Color shift of 2D | A | A | A | C | A | A | A | A |
| | Visibility of 3D | A | A | A | B | A | A | A | B |

TABLE 49

| | | Example | Example | Example | Example | Example | Example | Example | Example |
|---|---|---|---|---|---|---|---|---|---|
| | | 206 | 207 | 208 | 209 | 210 | 211 | 212 | 213 |
| Structure | | FIG. 3 | FIG. 3 | FIG. 3 | FIG. 3 | FIG. 3 | FIG. 3 | FIG. 3 | FIG. 3 |
| Fourth polarizing film | Angle of the absorption axis | 0° | 0° | 0° | 0° | 0° | 0° | 0° | 0° |
| | seen from the front | | | | | | | | |
| | Angle of the transmission | 90° | 90° | 90° | 90° | 90° | 90° | 90° | 90° |
| | axis seen from the front | | | | | | | | |
| Liquid crystal cell for | Mode | VA | VA | VA | VA | VA | VA | VA | VA |
| image display | | | | | | | | | |
| Third polarizing film | Angle of the absorption axis | 90° | 90° | 90° | 90° | 90° | 90° | 90° | 90° |
| | seen from the front | | | | | | | | |
| Second polarizing film | Angle of the absorption axis | — | — | — | — | — | — | — | — |
| | seen from the front | | | | | | | | |
| First retardation film | Type | Film 44 | Film 45 | Film 46 | Film 12 | Film 23 | Film 45 | Film 46 | Film 48 |
| | Re (nm) | −10 | −3 | −2 | 80 | 10 | −3 | −2 | −5 |
| | Rth (nm) | 80 | 40 | −5 | 180 | 100 | 40 | −5 | −15 |
| | Slow axis angle | Orthog- | Orthog- | Orthog- | Orthog- | Orthog- | Orthog- | Orthog- | Orthog- |
| | | onal | onal | onal | onal | onal | onal | onal | onal |
| Liquid crystal cell for | Δnd (nm) | 400 | 400 | 400 | 460 | 460 | 460 | 460 | 460 |
| barrier element | Mode | TN | TN | TN | TN | TN | TN | TN | TN |
| | Disposition (E/O Mode) | O | O | O | O | O | O | O | O |
| Second retardation | Type | Film 44 | Film 45 | Film 46 | Film 47 | Film 23 | Film 45 | Film 46 | Film 48 |
| film | Re (nm) | −10 | −3 | −2 | −5 | 10 | −3 | −2 | −5 |
| | Rth (nm) | 80 | 40 | −5 | −15 | 100 | 40 | −5 | −15 |
| | Slow axis angle | Parallel | Parallel | Parallel | Parallel | Parallel | Parallel | Parallel | Parallel |
| First polarizing film | Angle of the absorption axis | 0° | 0° | 0° | 0° | 0° | 0° | 0° | 0° |
| | seen from the front | | | | | | | | |
| | Transmission (%) | 41.8 | 41.8 | 41.8 | 41.8 | 41.8 | 41.8 | 41.8 | 41.8 |
| Transmission of third polarizing film (%) | | 41.8 | 41.8 | 41.8 | 41.8 | 41.8 | 41.8 | 41.8 | 41.8 |
| Evaluation | Front brightness of 2D (%) | A | A | A | A | A | A | A | A |
| | | 130 | 130 | 130 | 137 | 137 | 137 | 137 | 137 |
| | Brightness in the lateral | A | A | A | A | A | A | A | A |
| | direction of 2D (%) | 231 | 231 | 231 | 237 | 239 | 239 | 239 | 239 |
| | Color shift of 2D | A | A | A | C | A | A | A | A |
| | Visibility of 3D | A | A | A | B | A | A | A | B |

TABLE 50

| | | Example | Example | Example | Example | Example | Example | Example | Example |
|---|---|---|---|---|---|---|---|---|---|
| | | 214 | 215 | 216 | 217 | 218 | 219 | 220 | 221 |
| Structure | | FIG. 8a | FIG. 8a | FIG. 8a | FIG. 8a | FIG. 8a | FIG. 8a | FIG. 8a | FIG. 8a |
| First polarizing film | Angle of the absorption axis | 90° | 90° | 90° | 90° | 90° | 90° | 90° | 90° |
| | seen from the front | | | | | | | | |
| | Angle of the transmission | 0° | 0° | 0° | 0° | 0° | 0° | 0° | 0° |
| | axis seen from the front | | | | | | | | |
| First retardation film | Type | Film 44 | Film 45 | Film 46 | Film 12 | Film 23 | Film 45 | Film 46 | Film 48 |
| | Re (nm) | −10 | −3 | −2 | 80 | 10 | −3 | −2 | −5 |
| | Rth (nm) | 80 | 40 | −5 | 180 | 100 | 40 | −5 | −15 |
| | Slow axis angle | Parallel | Parallel | Parallel | Parallel | Parallel | Parallel | Parallel | Parallel |
| Liquid crystal cell for | Δnd (nm) | 400 | 400 | 400 | 460 | 460 | 460 | 460 | 460 |
| barrier element | Mode | TN | TN | TN | TN | TN | TN | TN | TN |
| | Disposition (E/O Mode) | O | O | O | O | O | O | O | O |
| Second retardation | Type | Film 44 | Film 45 | Film 46 | Film 47 | Film 23 | Film 45 | Film 46 | Film 48 |
| film | Re (nm) | −10 | −3 | −2 | −5 | 10 | −3 | −2 | −5 |
| | Rth (nm) | 80 | 40 | −5 | −15 | 100 | 40 | −5 | −15 |
| | Slow axis angle | Orthog- | Orthog- | Orthog- | Orthog- | Orthog- | Orthog- | Orthog- | Orthog- |
| | | onal | onal | onal | onal | onal | onal | onal | onal |
| Second polarizing film | Angle of the absorption axis | — | — | — | — | — | — | — | — |
| | seen from the front | | | | | | | | |
| Third polarizing film | Angle of the absorption axis | 0° | 0° | 0° | 0° | 0° | 0° | 0° | 0° |
| | seen from the front | | | | | | | | |
| Liquid crystal cell for | Mode | VA | VA | VA | VA | VA | VA | VA | VA |
| image display | | | | | | | | | |
| Fourth polarizing film | Angle of the absorption axis | 90° | 90° | 90° | 90° | 90° | 90° | 90° | 90° |
| | seen from the front | | | | | | | | |
| Transmission of first polarizing film (%) | | 41.8 | 41.8 | 41.8 | 41.8 | 41.8 | 41.8 | 41.8 | 41.8 |
| Transmission of third polarizing film (%) | | 41.8 | 41.8 | 41.8 | 41.8 | 41.8 | 41.8 | 41.8 | 41.8 |
| Evaluation | Front brightness of 2D (%) | A | A | A | A | A | A | A | A |
| | | 130 | 130 | 130 | 137 | 137 | 137 | 137 | 137 |
| | Brightness in the lateral | A | A | A | A | A | A | A | A |
| | direction of 2D (%) | 231 | 231 | 231 | 237 | 239 | 239 | 239 | 239 |
| | Color shift of 2D | A | A | A | C | A | A | A | A |
| | Visibility of 3D | A | A | A | B | A | A | A | B |

TABLE 51

| | | Example | Example | Example | Example | Example | Example | Example | Example |
|---|---|---|---|---|---|---|---|---|---|
| | | 222 | 223 | 224 | 225 | 226 | 227 | 228 | 229 |
| Structure | | FIG. 5 | FIG. 5 | FIG. 5 | FIG. 5 | FIG. 5 | FIG. 5 | FIG. 5 | FIG. 5 |
| First polarizing film | Angle of the absorption axis | 0° | 0° | 0° | 0° | 0° | 0° | 0° | 0° |
| | seen from the front | | | | | | | | |
| | Angle of the transmission | 90° | 90° | 90° | 90° | 90° | 90° | 90° | 90° |
| | axis seen from the front | | | | | | | | |
| First retardation film | Type | Film 44 | Film 45 | Film 46 | Film 12 | Film 23 | Film 45 | Film 46 | Film 48 |
| | Re (nm) | −10 | −3 | −2 | 80 | 10 | −3 | −2 | −5 |
| | Rth (nm) | 80 | 40 | −5 | 180 | 100 | 40 | −5 | −15 |
| | Slow axis angle | Parallel | Parallel | Parallel | Parallel | Parallel | Parallel | Parallel | Parallel |
| Liquid crystal cell for | Δnd (nm) | 400 | 400 | 400 | 460 | 460 | 460 | 460 | 460 |
| barrier element | Mode | TN | TN | TN | TN | TN | TN | TN | TN |
| | Disposition (E/O Mode) | O | O | O | O | O | O | O | O |
| Second retardation | Type | Film 44 | Film 45 | Film 46 | Film 47 | Film 23 | Film 45 | Film 46 | Film 48 |
| film | Re (nm) | −10 | −3 | −2 | −5 | 10 | −3 | −2 | −5 |
| | Rth (nm) | 80 | 40 | −5 | −15 | 100 | 40 | −5 | −15 |
| | Slow axis angle | Orthog- | Orthog- | Orthog- | Orthog- | Orthog- | Orthog- | Orthog- | Orthog- |
| | | onal | onal | onal | onal | onal | onal | onal | onal |
| Second polarizing film | Angle of the absorption axis | — | — | — | — | — | — | — | — |
| | seen from the front | | | | | | | | |
| Third polarizing film | Angle of the absorption axis | 90° | 90° | 90° | 90° | 90° | 90° | 90° | 90° |
| | seen from the front | | | | | | | | |
| Liquid crystal cell for | Mode | VA | VA | VA | VA | VA | VA | VA | VA |
| image display | | | | | | | | | |
| Fourth polarizing film | Angle of the absorption axis | 0° | 0° | 0° | 0° | 0° | 0° | 0° | 0° |
| | seen from the front | | | | | | | | |
| Transmission of first polarizing film (%) | | 41.8 | 41.8 | 41.8 | 41.8 | 41.8 | 41.8 | 41.8 | 41.8 |
| Transmission of third polarizing film (%) | | 41.8 | 41.8 | 41.8 | 41.8 | 41.8 | 41.8 | 41.8 | 41.8 |
| Evaluation | Front brightness of 2D (%) | A | A | A | A | A | A | A | A |
| | | 130 | 130 | 130 | 137 | 137 | 137 | 137 | 137 |
| | Brightness in the lateral | A | A | A | A | A | A | A | A |
| | direction of 2D (%) | 231 | 231 | 231 | 237 | 239 | 239 | 239 | 239 |
| | Color shift of 2D | A | A | A | C | A | A | A | A |
| | Visibility of 3D | A | A | A | B | A | A | A | B |

The results shown in the tables above demonstrate that reductions in the crosstalk in a 3D display mode are noticeable without any change in tint of white portions in a 2D display mode by the use of barrier elements in Examples of the present invention where a retardation film having an Re(550) of −30 to 100 nm and an Rth(550) of −15 to 180 nm is disposed between a liquid crystal cell and a first polarizing film and/or at the side of the back of the liquid crystal cell.

### 3. Evaluation of Wavelength Dispersion of Liquid Crystal Cell for Barrier Element (Examples 174 to 197)

The influence of wavelength dispersion of Δnd(λ) in liquid crystal cells for barrier elements was investigated.

Three liquid crystal materials having positive dielectric anisotropic layers and different wavelength dispersibility of Δn(λ) were each sealed between two substrates to prepare TN mode liquid crystal cells A, B, and C of which liquid crystal layers each having a Δn·d of 400 nm at a wavelength of 550 nm. The TN mode liquid crystal cells A, B, and C each having a twist angle of 90° were used for barrier elements.

The wavelength dispersion of Δnd(λ) in each of the produced liquid crystal cells for barrier elements was measured using AxoScan manufactured by Axometrics, Inc. and accessory software. The results of calculated Δnd(450)/Δnd(550) are shown in the following table.

TABLE 52

| | Δnd (450)/Δnd (550) |
|---|---|
| Liquid crystal cell A | 1.15 |
| Liquid crystal cell B | 1.08 |
| Liquid crystal cell C | 1.04 |

The VA mode liquid crystal cell was used as the liquid crystal cell for image display device.

Any of the laminates was bonded to the surfaces of the produced liquid crystal cell for barrier element and liquid crystal cell for image display device. In the following Examples of barrier elements disposed in the front of the image display device, a laminate including a low-reflective film, Clear LR (manufactured by Fuji Film Co., Ltd., CV film CV-LC), was disposed at the side of the outer face of the display. The TN mode liquid crystal cells, as shown in the tables below, the absorption axis of the polarizing film was disposed in an E mode or an O mode in relationship to the liquid crystal cell. The axial relationship between individual components of the laminate and the types of the liquid crystal cells for barrier elements are shown in the tables below.

The results of evaluation of the produced 3D display apparatuses are also shown in the following tables.

TABLE 53

| | | Example 174 | Example 175 | Example 176 | Example 177 | Example 178 | Example 179 |
|---|---|---|---|---|---|---|---|
| Structure | | FIG. 7a | FIG. 7a | FIG. 7a | FIG. 7a | FIG. 7a | FIG. 7a |
| Fourth polarizing film | Angle of the absorption axis seen | 90° | 90° | 90° | 90° | 90° | 90° |
| | from the front | | | | | | |
| | Angle of the transmission | 0° | 0° | 0° | 0° | 0° | 0° |
| | axis seen from the front | | | | | | |
| Liquid crystal cell for | Mode | VA | VA | VA | VA | VA | VA |
| image display | | | | | | | |
| Third polarizing film | Angle of the absorption axis | 0° | 0° | 0° | 0° | 0° | 0° |
| | seen from the front | | | | | | |
| Second polarizing film | Angle of the absorption axis | — | — | — | — | — | — |
| | seen from the front | | | | | | |
| First retardation film | Type | Film 38 | Film 41 | Film 38 | Film 41 | Film 38 | Film 41 |
| | Re (nm) | −6 | −6 | −6 | −6 | −6 | −6 |
| | Rth (nm) | 90 | 90 | 90 | 90 | 90 | 90 |
| | Slow axis angle | Orthogonal | Orthogonal | Orthogonal | Orthogonal | Orthogonal | Orthogonal |
| Liquid crystal cell for | Type | A | | B | | C | |
| barrier element | (Δnd (450)/ | (1.15) | | (1.08) | | (1.04) | |
| | Δnd(550)) | | | | | | |
| | Δnd (nm) | 400 | 400 | 400 | 400 | 400 | 400 |
| | Mode | TN | TN | TN | TN | TN | TN |
| | Disposition (E/O Mode) | O | O | O | O | O | O |
| Second retardation film | Type | Film 38 | Film 41 | Film 38 | Film 41 | Film 38 | Film 41 |
| | Re (nm) | −6 | −6 | −6 | −6 | −6 | −6 |
| | Rth (nm) | 90 | 90 | 90 | 90 | 90 | 90 |
| | Slow axis angle | Parallel | Parallel | Parallel | Parallel | Parallel | Parallel |
| First polarizing film | Angle of the absorption axis | 90° | 90° | 90° | 90° | 90° | 90° |
| | seen from the front | | | | | | |
| | Transmission (%) | 41.8 | 41.8 | 41.8 | 41.8 | 41.8 | 41.8 |
| Transmission of third polarizing film (%) | | 41.8 | 41.8 | 41.8 | 41.8 | 41.8 | 41.8 |
| Evaluation | Front brightness of 2D (%) | A | A | A | A | A | A |
| | | 137 | 137 | 137 | 137 | 137 | 137 |
| | Brightness in the lateral | A | A | A | A | A | A |
| | direction of 2D (%) | 239 | 239 | 239 | 239 | 239 | 239 |
| | Color shift of 2D | C | B | C | B | B | A |
| | Visibility of 3D | A | A | A | A | A | A |

TABLE 54

| | | Example 180 | Example 181 | Example 182 | Example 183 | Example 184 | Example 185 |
|---|---|---|---|---|---|---|---|
| Structure | | FIG. 3 | FIG. 3 | FIG. 3 | FIG. 3 | FIG. 3 | FIG. 3 |
| Fourth polarizing film | Angle of the absorption axis seen | 0° | 0° | 0° | 0° | 0° | 0° |
| | from the front | | | | | | |
| | Angle of the transmission | 90° | 90° | 90° | 90° | 90° | 90° |
| | axis seen from the front | | | | | | |
| Liquid crystal cell for | Mode | VA | VA | VA | VA | VA | VA |
| image display | | | | | | | |
| Third polarizing film | Angle of the absorption axis | 90° | 90° | 90° | 90° | 90° | 90° |
| | seen from the front | | | | | | |
| Second polarizing film | Angle of the absorption axis | — | — | — | — | — | — |
| | seen from the front | | | | | | |
| First retardation film | Type | Film 38 | Film 41 | Film 38 | Film 41 | Film 38 | Film 41 |
| | Re (nm) | −6 | −6 | −6 | −6 | −6 | −6 |
| | Rth (nm) | 90 | 90 | 90 | 90 | 90 | 90 |
| | Slow axis angle | Orthogonal | Orthogonal | Orthogonal | Orthogonal | Orthogonal | Orthogonal |
| Liquid crystal cell for | Type | A | | B | | C | |
| barrier element | (Δnd (450)/ | (1.15) | | (1.08) | | (1.04) | |
| | Δnd (550)) | | | | | | |
| | Δnd (nm) | 400 | 400 | 400 | 400 | 400 | 400 |
| | Mode | TN | TN | TN | TN | TN | TN |
| | Disposition (E/O Mode) | O | O | O | O | O | O |
| Second retardation film | Type | Film 38 | Film 41 | Film 38 | Film 41 | Film 38 | Film 41 |
| | Re (nm) | −6 | −6 | −6 | −6 | −6 | −6 |
| | Rth (nm) | 90 | 90 | 90 | 90 | 90 | 90 |
| | Slow axis angle | Parallel | Parallel | Parallel | Parallel | Parallel | Parallel |
| First polarizing film | Angle of the absorption axis | 0° | 0° | 0° | 0° | 0° | 0° |
| | seen from the front | | | | | | |
| | Transmission (%) | 41.8 | 41.8 | 41.8 | 41.8 | 41.8 | 41.8 |
| Transmission of third polarizing film (%) | | 41.8 | 41.8 | 41.8 | 41.8 | 41.8 | 41.8 |
| Evaluation | Front brightness of 2D (%) | A | A | A | A | A | A |
| | | 137 | 137 | 137 | 137 | 137 | 137 |
| | Brightness in the lateral | A | A | A | A | A | A |
| | direction of 2D (%) | 239 | 239 | 239 | 239 | 239 | 239 |
| | Color shift of 2D | C | B | C | B | B | A |
| | Visibility of 3D | A | A | A | A | A | A |

TABLE 55

| | | Example 186 | Example 187 | Example 188 | Example 189 | Example 190 | Example 191 |
|---|---|---|---|---|---|---|---|
| Structure | | FIG. 8a | FIG. 8a | FIG. 8a | FIG. 8a | FIG. 8a | FIG. 8a |
| First polarizing film | Angle of the absorption axis seen | 90° | 90° | 90° | 90° | 90° | 90° |
| | from the front | | | | | | |
| | Angle of the transmission | 0° | 0° | 0° | 0° | 0° | 0° |
| | axis seen from the front | | | | | | |
| First retardation film | Type | Film 38 | Film 41 | Film 38 | Film 41 | Film 38 | Film 41 |
| | Re (nm) | −6 | −6 | −6 | −6 | −6 | −6 |
| | Rth (nm) | 90 | 90 | 90 | 90 | 90 | 90 |
| | Slow axis angle | Parallel | Parallel | Parallel | Parallel | Parallel | Parallel |
| Liquid crystal cell for | Type | A | | B | | C | |
| barrier element | (Δnd (450)/ | (1.15) | | (1.08) | | (1.04) | |
| | Δnd (550)) | | | | | | |
| | Δnd (nm) | 400 | 400 | 400 | 400 | 400 | 400 |
| | Mode | TN | TN | TN | TN | TN | TN |
| | Disposition (E/O Mode) | O | O | O | O | O | O |
| Second retardation film | Type | Film 38 | Film 41 | Film 38 | Film 41 | Film 38 | Film 41 |
| | Re (nm) | −6 | −6 | −6 | −6 | −6 | −6 |
| | Rth (nm) | 90 | 90 | 90 | 90 | 90 | 90 |
| | Slow axis angle | Orthogonal | Orthogonal | Orthogonal | Orthogonal | Orthogonal | Orthogonal |
| Second polarizing film | Angle of the absorption axis | — | — | — | — | — | — |
| | seen from the front | | | | | | |
| Third polarizing film | Angle of the absorption axis | 0° | 0° | 0° | 0° | 0° | 0° |
| | seen from the front | | | | | | |
| Liquid crystal cell for | Mode | VA | VA | VA | VA | VA | VA |
| image display | | | | | | | |
| Fourth polarizing film | Angle of the absorption axis | 90° | 90° | 90° | 90° | 90° | 90° |
| | seen from the front | | | | | | |
| Transmission of first polarizing film (%) | | 41.8 | 41.8 | 41.8 | 41.8 | 41.8 | 41.8 |
| Transmission of third polarizing film (%) | | 41.8 | 41.8 | 41.8 | 41.8 | 41.8 | 41.8 |
| Evaluation | Front brightness of 2D (%) | A | A | A | A | A | A |
| | | 137 | 137 | 137 | 137 | 137 | 137 |
| | Brightness in the lateral | A | A | A | A | A | A |
| | direction of 2D (%) | 239 | 239 | 239 | 239 | 239 | 239 |
| | Color shift of 2D | C | B | C | B | B | A |
| | Visibility of 3D | A | A | A | A | A | A |

TABLE 56

| | | Example 192 | Example 193 | Example 194 | Example 195 | Example 196 | Example 197 |
|---|---|---|---|---|---|---|---|
| Structure | | FIG. 5 | FIG. 5 | FIG. 5 | FIG. 5 | FIG. 5 | FIG. 5 |
| First polarizing film | Angle of the absorption axis seen | 0° | 0° | 0° | 0° | 0° | 0° |
| | from the front | | | | | | |
| | Angle of the transmission | 90° | 90° | 90° | 90° | 90° | 90° |
| | axis seen from the front | | | | | | |
| First retardation film | Type | Film 38 | Film 41 | Film 38 | Film 41 | Film 38 | Film 41 |
| | Re (nm) | −6 | −6 | −6 | −6 | −6 | −6 |
| | Rth (nm) | 90 | 90 | 90 | 90 | 90 | 90 |
| | Slow axis angle | Parallel | Parallel | Parallel | Parallel | Parallel | Parallel |
| Liquid crystal cell for | Type | A | | B | | C | |
| barrier element | (Δnd (450)/ | (1.15) | | (1.08) | | (1.04) | |
| | Δnd (550)) | | | | | | |
| | Δnd (nm) | 400 | 400 | 400 | 400 | 400 | 400 |
| | Mode | TN | TN | TN | TN | TN | TN |
| | Disposition (E/O Mode) | O | O | O | O | O | O |
| Second retardation film | Type | Film 38 | Film 41 | Film 38 | Film 41 | Film 38 | Film 41 |
| | Re (nm) | −6 | −6 | −6 | −6 | −6 | −6 |
| | Rth (nm) | 90 | 90 | 90 | 90 | 90 | 90 |
| | Slow axis angle | Orthogonal | Orthogonal | Orthogonal | Orthogonal | Orthogonal | Orthogonal |
| Second polarizing film | Angle of the absorption axis | — | — | — | — | — | — |
| | seen from the front | | | | | | |
| Third polarizing film | Angle of the absorption axis | 90° | 90° | 90° | 90° | 90° | 90° |
| | seen from the front | | | | | | |
| Liquid crystal cell for | Mode | VA | VA | VA | VA | VA | VA |
| image display | | | | | | | |
| Fourth polarizing film | Angle of the absorption axis | 0° | 0° | 0° | 0° | 0° | 0° |
| | seen from the front | | | | | | |
| Transmission of first polarizing film (%) | | 41.8 | 41.8 | 41.8 | 41.8 | 41.8 | 41.8 |
| Transmission of third polarizing film (%) | | 41.8 | 41.8 | 41.8 | 41.8 | 41.8 | 41.8 |
| Evaluation | Front brightness of 2D (%) | A | A | A | A | A | A |
| | | 137 | 137 | 137 | 137 | 137 | 137 |
| | Brightness in the lateral | A | A | A | A | A | A |
| | direction of 2D (%) | 239 | 239 | 239 | 239 | 239 | 239 |
| | Color shift of 2D | C | B | C | B | B | A |
| | Visibility of 3D | A | A | A | A | A | A |

The results shown in the tables above demonstrate that a reduction in wavelength dispersion Δnd(450)/Δnd(550) of the liquid crystal cell for a barrier element decreases a change in tint of white portions in a 2D display mode, i.e., improves the visibility in the 2D display mode.

### REFERENCE SIGNS LIST

1 3D display apparatus
2 Barrier element
3 Image display device
4 Backlight
5 Liquid crystal cell for barrier element
5a 5a′ Substarate
5b 5b′ Opposing substrates
6 First polarizing film
6a Absorption axis of first polarizing film
7 8 Retardation film
7a 8a In plane slow axis of retardation film
9 Second polarizing film
9a Absorption axis of second polarizing film
10 Liquid crystal cell for image display
11 Third polarizing film
11a Absorption axis of third polarizing film
12 Fourth polarizing film
12a Absorption axis of fourth polarizing film

1. A barrier element to be disposed at the front or the rear of an image display device and capable of forming a barrier pattern including light transmitting portions and light shielding portions, the barrier element comprising:
a first polarization controlling element;
a liquid crystal cell; and
at least one retardation film disposed between the first polarization controlling element and one face of the liquid crystal cell and/or disposed in the other face of the liquid crystal cell, and the retardation film having a retardation in-plane Re(550) of −30 to 100 nm at a wavelength of 550 nm and a retardation in the thickness direction Rth(550) of −15 to 180 nm at a wavelength of 550 nm.

2. The barrier element according to claim 1, wherein the retardation film has a retardation in the thickness direction Rth(550) of 30 to 180 nm at a wavelength of 550 nm.

3. The barrier element according to claim 1, further comprising an optically anisotropic layer in the retardation film, wherein
the retardation film has a retardation in the thickness direction Rth(550) of −15 to 30 nm at a wavelength of 550 nm; and
the optically anisotropic layer composed of a composition containing a liquid crystalline compound and has a retardation in-plane Re(550) of 20 nm or more.

4. The barrier element according to claim 1, wherein
the first polarization controlling element is an absorptive polarizer, and
the absorption axis of the absorptive polarizer is orthogonal or parallel to the in-plane slow axis of the retardation film.

5. The barrier element according to claim 4, wherein
the absorptive polarizer has the absorption axis in the direction of 0° or 90° when the horizontal direction of the display face is defined as 0°.

6. The barrier element according to claim 1, wherein the first polarization controlling element is a reflective polarizer or an anisotropic scattering polarizer.

7. The barrier element according to claim 1, further comprising a second polarization controlling element disposed such that the liquid crystal cell is disposed between the first and second polarization controlling elements, wherein
the combination of the first and the second polarization controlling elements is a combination of two absorptive polarizers, a combination of one absorptive polarizer and one reflective polarizer, or a combination of two anisotropic scattering polarizers.

8. The barrier element according to claim 1, wherein
the retardation films each are disposed between the polarization controlling element and one face of the liquid crystal cell and disposed in the other face of the liquid crystal cell.

9. The barrier element according to claim 7, wherein the slow axes of the retardation films are orthogonal to each other.

10. The barrier element according to claim 1, further comprising an optically anisotropic layer composed of a composition containing a liquid crystalline compound in the retardation film.

11. The barrier element according to claim 1, wherein the optically anisotropic layer disposed in the retardation film has a major axis tilting in the thickness direction.

12. The barrier element according to of claim 3, wherein the optically anisotropic layer satisfies a relationship: 3≦R[+40°]/R[−40°] at a wavelength of 550 nm, wherein in the plane (incident plane) containing a normal line orthogonal to the slow axis of the retardation film, R[+40°] represents the retardation measured from a direction tilted by 40° from the normal line to the film plane direction, and R[−40°] represents the retardation measured from a direction tilted by 40° from the normal line to the reverse direction (where R[−40°]<R[+40°]).

13. The barrier element according to claim 3, wherein the optically anisotropic layer has an Re(550) satisfying a relationship: 20 nm≦Re(550)≦58 nm at a wavelength of 550 nm.

14. The barrier element according to claim 3, wherein the liquid crystalline compound is a discotic liquid crystalline compound.

15. The barrier element according to of claim 1, wherein the retardation film is a cellulose acylate film.

16. The barrier element according to claim 1, wherein the retardation film is an optically biaxial polymer film.

17. The barrier element according to claim 1, wherein the liquid crystal cell is in a TN mode.

18. A 3D display apparatus comprising a barrier element according to claim 1 and an image display device.

19. The 3D display apparatus according to claim 18, wherein the image display device at least comprises a pair of a third and fourth polarization controlling elements and a liquid crystal cell disposed therebetween.

20. The 3D display apparatus according to claim 19, wherein the first polarization controlling element of the barrier element has a higher transmittance than transmittances of the third and fourth polarization controlling elements of the image display device.

21. The 3D display apparatus according to claim 18, wherein the first polarization controlling element of the barrier element is an absorptive polarizer, and the barrier element is disposed at the front of the image display device such that the first polarization controlling element is disposed at the front side.

22. The 3D display apparatus according to claim 18, wherein the first polarization controlling element of the barrier element is an absorptive polarizer, a reflective polarizer, or an anisotropic scattering polarizer, and the barrier element is disposed at the rear of an image display device such that the first polarization controlling element is disposed in the back side.

23. The 3D display apparatus according to claim 18, wherein the liquid crystal cell included in the image display device is of a VA mode or an IPS mode.
